(19) United States
(12) Patent Application Publication
(10) Pub. No.: US 2026/0252735 A1
(43) Pub. Date: Aug. 27, 2026

(54) SYSTEM AND METHOD FOR SHARING DATA WHILE PRESERVING PRIVACY

(71) Applicant: Huawei Technologies Co., Ltd., Shenzhen (CN)

(72) Inventors: Nimal Gamini Senarath, Ottawa (CA); Remziye Irem Bor Yaliniz, Ottawa (CA); Mohamed Faraj Moftah Alzenad, Ottawa (CA); Hang Zhang, Ottawa (CA)

(21) Appl. No.: 19/650,026

(22) Filed: Apr. 16, 2026

Related U.S. Application Data
(63) Continuation of application No. PCT/CN2024/099023, filed on Jun. 13, 2024.
(60) Provisional application No. 63/591,245, filed on Oct. 18, 2023.

(51) Int. Cl. G06F 21/62; H04L 9/40

(52) U.S. Cl. CPC G06F 21/6254; H04L 63/061

(57) ABSTRACT

Disclosed is a method, a system, and a network for sharing data associated with a user via a digital representative of the user. In an example method, a communication path is established between a User Equipment (UE) of the user and the digital representative. User data from the UE is stored in a data storage of the digital representative, the user data comprising data subsets, at least one data subset of the data subsets being associated with a Privacy Preservation Level (PPL). The data subsets are processed according to the PPL into privacy-preserved data. An access location stores the privacy-preserved data and is provided to internal nodes of the network or external nodes of the network, to allow the internal nodes or the external nodes to access the privacy-preserved data.

### CROSS-REFERENCE TO RELATED APPLICATIONS

This application is a continuation of International Patent Application No. PCT/CN2024/099023, filed on Jun. 13, 2024, which claims the benefits of U.S. Provisional Application No. 63/591,245, filed on Oct. 18, 2023, the disclosures of which are hereby incorporated by reference in their entireties.

### TECHNICAL FIELD

The present disclosure pertains to the field of data communications and in particular to a system, a method and a memory that allows users to share user data with external service or content providers while ensuring privacy and confidentiality of the user data.

### BACKGROUND

Public land mobile networks (PLMNs) are designed to provide connectivity services to users or other types of entities and their User Equipment (UEs). The concept of user centric networks (UCNs) improves user network experience by dynamically adapting a network structure to individual user contexts.

Future networks may become more and more ‘user-centric’ as users or other types of entities require or demand more ownership and control over their services and their privacy, i.e., these future networks are expected to provide increased user empowerment. UCNs may be designed in a way for entities to have more control over services provided by a network or more control over the network providing these services to these entities.

Future networks must also be able to support new network infrastructure capabilities, suitable for cloud computing applications that are being deployed on a large scale. Future networks should be able to support the use of large-scale artificial intelligence (AI) models, data anonymization, blockchain technologies, etc., which have made significant progress in the last years.

In addition, future networks, including enhanced-5G and 6G networks, should also be designed to support new applications and services, including AI and data sensing services, which are widely used not only in industrial applications, but also by individuals. These applications enable more global and open collaboration between different entities, and future networks should be designed to provide or improve data confidentiality and reliability, standardization, and rapid application deployment.

As the real world is controlled more and more with the help of the digital realm, and as a more precise control over real-world systems is needed, digital twins have been created to provide digital representations of real-world entities. Those digital twins can represent any type of entity, including objects, such as engines, cars, robots; infrastructures, such as cities and factories, but also users themselves. Replicating users in the virtual world presents additional challenges compared to objects or infrastructures, as the confidentiality and integrity of user data is paramount.

All these factors are driving research of future network architecture, including, for example, 6G networks. Therefore, improvements in communication networks are desirable.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure provides a method, a system, a platform and a computer-readable memory that enables users of a network to share data associated with them, including personal data, queries, and application operation data from various equipment and devices used by the user, with third parties, securely and with a level of privacy over which they have control.

In the present application, a Digital Entity, also referred to as DE, D-XX, DE module or D-XX module, corresponds to a representation of any entity, including for example assets, processes, systems, digital worlds, organizations, or users. A Digital Entity may be a virtual representation or replica of a real-world object, person or process that can be used to simulate their behaviors in order to better understand and predict their operation in real life. Digital Entities may be linked to real data sources, collected from sensors, and other information sources from their environment. The Digital Entities may be updated in real time to reflect the original, real-world versions. The Digital Entities may be interconnected and may communicate and influence one another, such that entire systems may be replicated.

A digital entity replicating a physical entity or a collection of physical entities may be referred to as a Digital Representative (D-Rep or D-Rep module). A Digital Entity replicating a more complex system, such as an organization or a plant, and comprising several D-Reps, may be referred to as a Digital Infrastructure (D-Inf). A digital entity replicating a user, including for example animals and humans, can be referred to as D-Users or D-User modules.

A Hosting Network (HN) can provide a data sharing service to users via digital representative of the users (D-Users). A D-User is a digital representative, or replica, of a user instantiated and maintained inside the HN. A digital representative, or replica, of a user comprises both hardware and software components. Since one or more D-Users are stored and maintained inside the HN, on nodes of the HN, a D-User can closely interact with the HN and/or other digital entities maintained in the network, in order to provide the “real” user with more control over services obtained from the HN.

Network operators are provided with different options to instantiate and configure the HOP, including configuring the HOP for a single entity, for example a single D-Rep platform, or for multiple entities, for example as multi-D-Rep platform. When the digital entity is a replica of a user, the HOP can thus be configured for a single D-User or for multiple D-Users, as a multi-D-User platform. The HOP can be instantiated and maintained as an isolated function module within the hosting network.

A function can be referred to as a functional block of code executable by one or more processors, within a network architecture, with pre-defined external interfaces and behavior, to receive, process and transmit data packets.

Hosting Network Functions (HNFs) comprise functions that are controlled and managed by processing devices of the Hosting Network (HN) to provide services to end users, including end user devices or equipment (UE) and/or end user applications, via D-Reps.

In possible embodiments, each of the DEs comprises DE Functions, and wherein the HPFs and/or the DE Functions are accessible to the real entities without awareness of the HN. The DE functions can comprise DE Network Functions, including DE Management Plane Functions, DE Control Plane Functions and DE Data Plane Functions. DE Data Plane Functions corresponds to functions which process data received according to certain processing specifications and forward the data to a specified destination. DE Data Plane Functions may also forward input traffic to a given destination according to the destination information included in the data packets.

A data sharing service can be implemented by the HN by creating and configuring the specific functions available to the D-User. A function can be referred to a functional block of code executable by processors, within a network architecture, with pre-defined external interfaces and behavior, to process and transmit data packets.

The Hosting Network (HN) can determine different privacy requirements needed by the user for the different types of data the user is willing to share, based on indications from the user. The sharable user data can be provided by the user, via one or more User Equipment, in different ways, including having the user actively determine the data which he/she is willing to share, or by having AI modules analyse the user data to be shared.

The data sharing service can be established by instantiating functions inside the D-User module, the hosting platform or/and the hosting network and configuring them accordingly.

According to an aspect, a method is provided for sharing data associated with a user via a digital representative thereof hosted in a network. The digital representative may be referred to as a D-User module. The method comprises the steps of establishing a communication path between one or more User Equipment of the user and the D-User module; storing user data from the User Equipment in a data storage of the D-User module, the user data comprising data subsets, at least one data subset being associated with a Privacy Preservation Level (PPL); processing the data subsets according to the PPL thereof into privacy-preserved data; and providing an access location storing the privacy-preserved data to internal nodes of the network, or external nodes, to allow the nodes to access the privacy-preserved data.

In possible embodiments, the D-User module is instantiated in a hosting platform (HOP) of the network, the network being referred to as a Hosting Network (HN).

In possible embodiments, the Hosting Network (HN) is an untrusted network, and access to the data storage or network functions inside the D-User module by the untrusted network is controlled by an access control function in the HOP.

In possible embodiments, the Hosting Network (HN) is an untrusted network, and wherein access to the data storage or network functions inside the D-User module by the untrusted network is controlled by an access control function inside the D-User module.

In possible embodiments, providing the access location to internal or external nodes is controlled by a Network Function of the network.

In possible embodiments, establishing the communication path between the UE of the user and the D-User module includes providing secure keys to authenticate the UE and the D-User module with one another, enabling secure communications between the UE and the D-User module, preventing visibility of the communications between the UE and the D-User module by the network.

In possible embodiments, the user continuously updates the user data, via the UE, with the D-User module, the D-User module comprising a Data Synchronization Function to keep track of a validity of the user data and of an age of the user data and to update metadata associated with the user data in the data storage of the D-User module.

In possible embodiments, the Data Synchronization Function informs the UE when user data is shared or discarded from the D-User module.

In possible embodiments, the method comprises pre-filtering the user data using a UE Function of the UE, prior to sending new user data in the data storage of the D-User module.

In possible embodiments, the D-User module is instantiated in an isolated container.

In possible embodiments, the isolated container is a Trusted Execution Environment (TEE) and the communications between the D-User module and the UE are not visible to the HN.

In possible embodiments, the hosting network comprises a Privacy Preserving Portal (PPP) and wherein communications between the D-User module and the external nodes are performed via the PPP.

In possible embodiments, wherein the HOP comprises a Privacy Preserving Portal (PPP) and wherein communications between the D-User module and the external nodes are performed via the PPP.

In possible embodiments, the PPP is configured to de-privatize communications between the D-User module and the external nodes.

In possible embodiments, the PPP is configured to anonymize the communications between the D-User module and the external nodes.

In possible embodiments, anonymization of user data is performed by changing, by the PPP, a User Identifier (User ID), User Equipment Identifier (UE-ID) or D-User identifier (D-User_ID) to a temporary identifier (Temp_ID) and/or by changing a location of a source address of the communications with external nodes to a temporary location, thereby preventing leaking of privacy information to the external nodes.

In possible embodiments, the User ID, the UE-ID or the D-User_ID correspond to a location address, such as an IP Address.

In possible embodiments, the PPP applies an encryption process to the data subsets associated with a PPL requiring data-encryption, to further decorrelate the user data from the user.

In possible embodiments, each PPL is associated with a Privacy Preservation technique to be applied by a Data Processing Function (DPF) of the D-User module, for the processing of the data subsets.

In possible embodiments, the PPP comprises a Policy Engine in which the PPL are stored, maintained, and associated with respective Privacy Preservation techniques, according to privacy policies established in conjunction with the UE.

In possible embodiments, the privacy-preserved data is stored in a Shared Data Portal (SDP) of the HN, the SDP storing the privacy-preserved data of the user and of additional users.

In possible embodiments, the communications between the D-User module and the SDP are performed using the temporary identifier of the D-User, the SDP being unaware of the User ID or of the UE_ID associated with D-User module when the D-User module communicates with the SDP.

In possible embodiments, messages exchanges between the D-User module and the SDP transit via a Privacy Preserved Portal (PPP), the PPP being configured to map the messages from SDP tagged with the temporary identifier to the User ID or UE-ID before forwarding the message to the D-User module.

In possible embodiments, the access location is an address of the SDP.

In possible embodiments, anonymization of user data is performed by changing, by the PPP, a User Identifier (User ID), User Equipment Identifier (UE-ID) or D-User identifier (D-User_ID) to a temporary identifier (Temp_ID) and/or by changing a location of a source address of the communications with external nodes to a temporary location, thereby preventing leaking of privacy information to the external nodes.

In possible embodiments, the User ID, the UE-ID or the D-User_ID correspond to a location address, such as an IP Address.

In possible embodiments, each PPL is associated with a Privacy Preservation technique to be applied by a Data Processing Function (DPF) of the D-User module, for the processing of the data subsets.

In possible embodiments, the PPP comprises a Policy Engine in which the PPL are stored, maintained, and associated with respective Privacy Preservation techniques, according to privacy policies established in conjunction with the UE.

In possible embodiments, the privacy-preserved data is stored in a Shared Data Portal (SDP) of the HN, the SDP storing the privacy-preserved data of the user and of additional users.

In possible embodiments, the communications between the D-User module and the SDP are performed using the temporary identifier of the D-User, the SDP being unaware of the User ID or of the UE_ID associated with D-User module when the D-User module communicates with the SDP.

In possible embodiments, messages exchanges between the D-User module and the SDP transit via a Privacy Preserved Portal (PPP), the PPP being configured to map the messages from SDP tagged with the temporary identifier to the User ID or UE-ID before forwarding the message to the D-User module.

In possible embodiments, the access location is an address of the SDP.

In possible embodiments, the privacy-preserved data stored in the SDP is categorized so that the privacy-preserved data is searchable by the internal and external nodes.

In possible embodiments, the external nodes comprises one or more of: 3^{rd} party Data Consumers nodes; 3^{rd} party data analytics entity nodes and joint Artificial Intelligence (AI) analyzers nodes.

In possible embodiments, the external nodes comprises Hosting Network Functions when the network is an untrusted network.

In possible embodiments, the internal nodes comprises one or more of: internal Data Consumer nodes, data analytics nodes and/or AI engine nodes.

In possible embodiments, the user data comprises one or more of: user personal information, user personal interests, user content interests, user queries, user data requiring analysis and data models.

In possible embodiments, the PPP comprises a payment function to secure payments from the external or internal nodes for accessing the privacy-preserved data from the user.

According to an aspect, a tangible, non-transitory memory having recorded thereon instructions to be carried out by one or more processors to carry out the method as defined above is provided.

According to an aspect, a network node is provided. The network node is part of the Host Network, and the network node comprises a processor; and a tangible, non-transitory memory as defined above.

According to an aspect, a Hosting Network (HN) is provided. The HN comprises an isolated Hosting Platform (HOP) comprising: a Digital Representative of a user requiring privacy, referred to as a D-User module; a Privacy Preserving Portal (PPP) for ensuring privacy of communications between one or more of the D-User module hosted in the HOP and external nodes; and a Shared Data Portal (SDP) for storing privacy-preserved data collected on a User Equipment of the user, the external nodes having access to the privacy-preserved data collected on User Equipments of the users without accessing the D-User modules nor the User Equipments.

According to an embodiment, the HN comprises one or more Hosting Network Functions (HNFs) configured to: determine privacy requirements of a user and to select a type of HOP based on the privacy requirements of the user; creating the selected type of HOP in the isolated container of the HN; creating the D-User module in the HOP; providing the D-User module with a Data Sharing Service. The Data Sharing Service may be configured to: store user data from the User Equipment in a data storage of the D-User module, the user data comprising data subsets, each data subset being associated with a Privacy Preservation Level (PPL); process the data subsets according to the PPL thereof into privacy-preserved data; and provide an access location in the SDP storing the privacy-preserved data.

In possible embodiments, collection of the data from the User Equipment to the D-User module; processing of the collected data into privacy-preserved data; and sharing privacy-preserved data on the SDP with internal or external servers is performed as a continuous process.

In possible embodiments, an apparatus is provided wherein the apparatus comprises a function or unit to perform the method as defined above.

In possible embodiments, a communications system is provided, comprising a transmitting apparatus and a receiving apparatus, the transmitting apparatus being configured to perform the method as defined above.

In possible embodiments, a computer readable storage medium is provided, comprising one or more instructions, wherein when the one or more instructions are run on a computer, the computer adapted to perform the method as defined above.

In possible embodiments, a device is provided, configured to perform the method as defined above.

In possible embodiments, a processor is provided, configured to execute instructions to cause a device to perform the method as defined above.

In possible embodiments, an integrated circuit is provided, configured to perform the method as defined above.

A node can be any physical and/or software device with processing and storage capabilities. An internal node is a node that is part of the hosting network, while an external node is external to the network. Examples of external nodes include nodes of social media networks, of OTTs, of data consumers, of AI service providers, etc.

In possible embodiments, in order to maintain anonymity of the user, a response location for the Sharable Data Portal (SDP) to communicate with the D-User module. The response location, such as an IP address, can be a location inside the PPP. When a message is received from the SDP in relation to a shared data unit, the PPP as access to the response location address and can provide the response location address to the D-User module.

In possible embodiments, D-user policies related to negotiation of payments and privacy related issues can be determined based on user policies obtained from the user, based on the available PPL techniques and based on the SDP categorization classes which have been established beforehand.

In possible embodiments, D-user policies related to payment negotiation and privacy related issues can be decided based on user policies determined by the user. For example, the PPP can proceed with user-ID changes or swap, using an ID management module, and may use encryption to preserve privacy of exchanges relating to contents of interest and/or payments for the contents.

In possible embodiments, the transfer of data from the User Equipment to the D-User module, the processing of the collected data into privacy-preserved data, and the sharing privacy-preserved data on the SDP with internal or external servers can performed as a continuous process. Payments functions can be provided by the network to allow the user to receive payments from external servers, such as data consumers.

### BRIEF DESCRIPTION OF THE DRAWINGS

FIG. 1 shows a block diagram of a UE, 3GPP network elements and a data network interconnected through VUE interfaces, in accordance with embodiments of the present disclosure.

FIG. 2 shows a possible architecture of a network for a digital world, in accordance with embodiments of the present disclosure.

FIG. 3 shows a schematic illustration of a communication system, in accordance with possible embodiments of the present disclosure.

FIG. 4 shows a schematic illustration of a communication system, in accordance with other possible embodiments of the present disclosure.

FIG. 5 shows a schematic illustration of an electronic device and of a base station, in accordance with possible embodiments of the disclosure.

FIG. 6 shows a schematic illustration of modules of an electronic device, in accordance with possible embodiments of the disclosure.

FIG. 7 shows a block diagram of a network system, in accordance with possible embodiments of the present disclosure.

FIG. 8 shows an exemplary functional diagram of a data sharing system, in accordance with possible embodiments of the present disclosure.

FIG. 9 shows an exemplary functional diagram of a data sharing system with a shared database, in accordance with possible embodiments of the present disclosure.

FIG. 10 shows an exemplary functional diagram illustrating data exchange types for privacy-preserving data sharing, in accordance with possible embodiments of the present disclosure.

FIG. 11a shows an exemplary flow chart illustrating the life cycle of a D-User, in accordance with possible embodiments of the present disclosure.

FIG. 11b shows an exemplary functional diagram illustrating the operational states of a D-User, in accordance with possible embodiments of the present disclosure.

FIG. 12 shows an exemplary model for data sharing preserving privacy

FIG. 13 shows an exemplary Hosting Platform (HOP) functional architecture showing D-User creation functions, in accordance with possible embodiments of the present disclosure.

FIG. 14 shows an exemplary flow chart for a network aware UCM service establishment, in accordance with possible embodiments of the present disclosure.

FIG. 15 shows an exemplary flow chart for UCM service establishment, in accordance with possible embodiments of the present disclosure.

FIG. 16 shows an exemplary flow chart of a process to obtain a payment for shared data from a data consumer entity, while preserving privacy.

### DETAILED DESCRIPTION OF ILLUSTRATIVE EMBODIMENTS

### 6.1. Disclaimers and Term Interpretation

In the following description and figures, same reference numbers refer to similar elements of the application. Furthermore, to not unduly clutter the figures, it is possible that a figure may not contain all the reference numbers of the elements found in the figure. It is also possible that some elements or components may be referenced in only one figure. The element thereby referenced can easily be inferred in the other figures shown. The embodiments, geometrical configurations, materials and/or dimensions shown in the figures or described in the present disclosure are only indicative, and show possible embodiments, presented as examples, et should not be interpreted as limitative of the application.

One or more systems described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, server, a personal computer, a cloud-based program or system, a laptop, a personal data assistance, a smartphone, a wearable device, or a tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is of course chosen according to the desired use, whether it should retain instructions, or temporarily store, retain or update data. Steps of the proposed method are implemented as software instructions and algorithms, stored in computer memory and executed by processors.

The terms “a”, “an” and “one” are defined herein to mean “at least one”, that is, these terms do not exclude a plural number of items, unless stated otherwise. In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

### 6.2. User Equipment (UE) and Virtual User Equipment (VUE)

In the context of the present disclosure, the term ‘UE’ may represent a combination of a network access device (NAD) and a user personal device (UPD). Also, in the context of the present disclosure, a VUE is a digital entity located in the network and represents both the NAD and the UPD. UCM services may be provided by deploying the VUE by at least one network node of the network. The user applications and user data can be considered as higher layer components of the UE. These higher layer components may be considered to be the UPD. The UE can use its applications in the NAD to facilitate UCM services. A VUE may have different functionalities depending on the UCM service types it provides. In the context of the present disclosure, the term VUE type is a VUE having functionalities that can provide specific types of UCM services. The VUE may be deployed at different segments of the network (e.g., RAN, CN, mobile edge computing node (MEC), etc.) in a hierarchical manner to support various UCM services for UEs. The VUE may represent a particular UE and facilitate certain actions on behalf of the UE to support applications and services engaged throughout the network. There may be different types of VUEs providing different types of UCM services. Not all UEs may require user empowerment and therefore, a VUE or a UCM service may be provided as an add-on feature to the UE. A UE, requiring a particular UCM service, may have to subscribe to a particular VUE type or a UCM service (a VUE type may be configured to provide multiple UCM services). Subscription may be done by the UE contacting the mobile network operator's (MNO's) service desk or through an application provided in the UE, in which case the UE may send a special request to the network. The network may request a VUE creation function (VUCF) in the network to instantiate the VUE. Instantiation of the VUE may include the instantiation of at least one NF belonging to the VUE and its required interfaces. In one embodiment, the instantiation of the VUE may include the instantiation of a VUE-M (VUE manager) which has the capability of instantiating other NFs and interfaces belong to the VUE. There may be multiple VUEs located in different parts of the network (e.g., in different parts of a 3GPP network) and in data networks (DNs). In some embodiments the VUE creation request may be made by another, already existing, VUE. In some embodiments, instantiating the VUE may include instantiating NFs and respective interfaces associated with a VUE type.

When a VUE is created (generated) it may be created with a VUE-Manager (VUE-M), other network functions (i.e., UPFs and CPFs) and a database. Creation of the VUE may include engagement of a virtualized infrastructure and a VUE-M. The VUE-M may use the virtualized infrastructure to instantiate the other network functions and the interfaces, necessary for the requested VUE type. The infrastructure may be part of the hosting network, or it may be a hardware platform provided by a third party vendor, as a trusted executive environment. In some embodiments, instantiating the VUE may include instantiating NFs and respective interfaces associated with a VUE type.

The VUE instantiation may include instantiation of functions together with interfaces required for the requested UCM features in the network, which may be a wireless network. With the required interfaces in place, the VUE may interact with the network on behalf of the UE to engage the requested UCM features without direct interaction between the UE and the functions in the access network, for example, over an air interface when the UE is a wireless device.

### 6.3. X-centric Network Architecture

Many new trends trigger considerations and design of 6G or other future wireless networks, including: new network infrastructure capability, e.g., cloud natured/friendly infrastructures that are broadly deployed; new relatively matured techniques, e.g., AI large scale models, data de-privacy, block chain, etc. that have made significant progress and significantly impact on the entire society and human life; new apps and services, e.g., AI services, Data (sensing) services, digital world services, etc. that are broadly applied in industry/business and used by individual customers; more global, open and collaborative operation trends, i.e., a more open and more collaborative operation mode is becoming common practice in many fields. New expectations and stricter requirements on future networks also drive rethinking and development of new generations of wireless networks. These requirements may include: increased privacy and trustworthiness, simplified standardization of data and exchanges, rapid deployment of digital environments.

The proposed network architecture described herein, which may apply to future networks, is an X-centric architecture, which means that is it centered on objects and users, and is therefore a cloud-native, Service Based Architecture (SBA), to support the delivery of services for different types of entities, where any object or entity may be provided as a service.

Consequently, the proposed network architecture, which may be adapted to future networks, may support new services which can be developed or deployed by 3rd parties. The proposed network architecture can be adapted to allow communications and exchanges with technical capable 3rd parties, and may be adapted to enable trustworthiness management.

### 6.4. D-User as Digital Representative of a User

In the context of the present disclosure, a Virtual User, also referred to as a D-User or D-User module, is a digital representative of a user instantiated and maintained inside a network, which becomes a “hosting network”. A D-User is a special case of a Digital Entity (DE or D-XX). Since one or more D-Users may be stored and maintained inside the hosting network, a D-User can closely interact with the hosting network and/or other digital entities maintained in the hosting network, in order to provide the “real” user with more control over services obtained from the hosting network, i.e., the D-User may allow for improved user empowerment. The network services may be provided by the hosting network as added services and may be referred to as User Controlled and Managed (UCM) services. In possible embodiments, a D-User module may be a standalone code section or segment that includes different functions and routines, or that provide different services, according to a predetermined structure.

There may be different levels of control and management given to a user, i.e., empowerment levels. An empowerment level refers to the degree of authority, autonomy, and control granted to a user. The present disclosure provides different empowerment levels, including, for example:
User-defined service capability, i.e., user may define the services the user needs;
User may manage/control behaviors or features of the services provided by the hosting network;
The hosting network may be designed such that each user is served with a specific part of the network (e.g., exclusive logical slice) and have a certain control on it;
Services may be provided considering the user's context (e.g., user in the loop, user context is used for dynamic network functionality/operation modifications);
User device(s)/networks may become part of the network, e.g., UE as BSs/relays, drone BSs/relays, application servers;
User becomes a producer/provider of services to the network, e.g., AI service, neighbour information, video services, BS service provided by a user device or drone BS;
A D-User inside the network can interact with the hosting network to provide or facilitate these services. For this purpose, the D-User may include control plane functions, user plane functions, data storage, and required internal and external interfaces.

### 6.5 User Equipment, 3GPP Network and Data Network

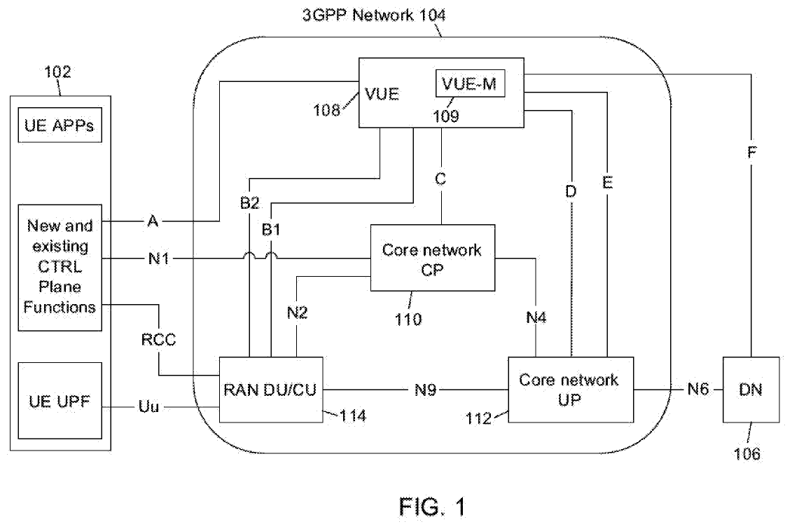

FIG. 1 illustrates an example of interfaces of a D-User.

FIG. 1 shows a block diagram of a UE 102, communication network (e.g. a 3^{rd} Generation Partnership Project (3GPP) network) 104 and a data network (DN) 106 interconnected to each other through VUE interfaces (also referred to as reference points), in accordance with embodiments of the present disclosure. The network 104 may include a VUE 108, a VUE-M 109, a core network (CN) control plane (CP) 110, a core network user plane (UP) 112 and a RAN distributed unit (DU)/central unit (CU) 114. In the embodiment of FIG. 1, VUE operations may require several control plane and data plane interfaces between the UE 102 and elements of the network 104, and between elements of the 3GPP network 104 and the DN 106. The required interfaces may depend on the type of UCM services, facilitated by the VUE. A given interface may be used only by some UCM services. In addition to the interfaces that are defined in, for example, 5G standards, additional interfaces or additional messaging over the existing interfaces may be required for VUE deployment and operation. Several interfaces may be required for operation of the VUE 108. In the context of the present disclosure, an interface may be referred to as a reference point and vis-versa.

VUE-UE control plane reference point (A)—Interface A shown in FIG. 1 is mainly for UE to VUE control plane messaging, transparent to the network. The interface A may be configured to synchronize, between the UE 102 and the VUE 108, the UE data (e.g., UE context, location), to provide authentication, authorization, and information in relation to the connections between the VUE and UE, data packet formats and any new UCM protocol data unit (PDU) session initialization. Depending on the UCM service, synchronization of a high-volume data flow may require a logical data plane connection between the UE 102 and the VUE 108. The data plane connection may be established by the network, for example, via a Uu interface and a B2 interface, in response to a request from the VUE 108 or the UE 102. For this purpose, the UE 102 may send control plane messages to the VUE 108 through the VUE-UE control plane reference point A interface. NFs in the network (or at least one NF in the network) may be configured to interact with the UE to obtain a user context.

VUE-RAN control plane interface (B1)—Interface B1 used is for certain UCM services such as, for example, when the VUE 108 requires specific radio access network (RAN) technologies or features. The VUE 108 may use this reference point to make such requests. In addition, this logical link (interface B1) may be used for direct UE functionality authentication, which is similar to an access and mobility-management function (AMF) functionality.

VUE-RAN data plane interfaces (B2)—For some UCM applications, interface B2 may be used to direct UE traffic to and from the VUE 108, transparent to the hosting network (Core Network or RAN). The N9 and N4 reference points may be used for the same purpose.

VUE-CN control plane reference point I—The CN CP 110 may have a single entry reference point (interface C) to a VUE control plane engaged to set up connections, authentication, authorization and accounting (AAA), policy update handling and lifecycle management of network functions at the VUE 108.

VUE CPF—CN UPF reference point (D) interface—Interface D is used by certain types of UCM services that enable VUE CPFs to control CN UPFs for routing and data processing purposes if the network operator allows certain level of control on certain UPFs. The D reference point interface may also be used for monitoring UE traffic related information (e.g., resource usage, quality of experience (QoE), different flows routing to different processing functions, UPFs or DNs). NFs in the network (or at least one NF in the network) may be configured to obtain the user traffic/data for internal processing.

VUE-CN data plane reference point I interface—Interface E is for UCM services when there is a requirement for certain data processing at the VUE 108 or when certain data has to be terminated or started at the VUE 108. In this case user traffic originated by the UE 102 or the DN 106 is diverted to the VUE 108 using this interface. NFs in the network (or at least one NF in the network) may be configured to obtain the user traffic/data for internal processing.

VUE-DN data plane reference point (F) interface—Interface F is to send and receive data directly between the VUE 108 and DN 106. The interface is required only for certain UCM services.

There are numerous options for defining reference points for interactions between different VUE control plane functions (CPFs) and different CN CPFs. For example, a standard may define a number of reference points for the interactions between a specific VUE CPF to a specific CN CPF. It is also possible that a single reference point may be defined for all control plane communications between the VUE 108 and each network domain (e.g., VUE or CN).

In addition to already described reference points, a number of 5G network reference points (e.g., in 23.501, 3GPP), for example, N1 and N2, may have to be modified to include UCM functionality and support required messaging for the VUE 108 and for UCM services.

N1 reference point between the UE 102 and an access and mobility management function (AMF). In addition to the relevant functions defined in the 3GPP TS 23.501 standard for this reference point, to support a VUE or a UCM service, the N1 reference point may be used to convey the VUE policy and parameters (including VUE service authorization) from the CN (e.g., AMF) to the UE 102, and convey the VUE 108 and UCM interaction capabilities to the CN CPF (e.g., AMF). Furthermore, establishment of a sync channel and an initial authentication procedure between the VUE 108 and the UE 102 may be done via the N1 reference point. The sync channel establishment and authentication may be done by the AMF following a request from a session mobility function (SMF).

N2 reference point defines a link between a RAN and the CN (e.g., the AMF). In addition to the relevant functions defined in 3GPP TS 23.501, the N2 reference point, configured to support VUE and UCM services, may convey VUE policies and parameters (including a VUE service authorization) from the AMF to the RAN (or a next-generation radio access network (NG-RAN)).

Uu reference point between the UE 102 and the RAN, is configured to support UCM functionality and may provide additional quality of service (QoS) bearers for specific UCM services and sync channels.

### 6.6. Trusted Execution Environment (TEE) of Processor for Hosting D-Users

A TEE is a secure area of a main processor which provides code and data integrity for the applications running inside the TEE. Examples of processors which provide such capabilities include the Intel SGX™ or AMD SEV™ processors. In the TEE, applications can securely store and process data which cannot even be detected by the operating system of a processing device or UE. For example, some systems, such as Intel SGX, may work by creating a secure area of memory, called an enclave, where an application can run. This enclave may be protected by a set of cryptographic keys that are unique to the application and the system it is running on. An enclave may also be considered as a virtual machine (VM) as it may be operated on a separate CPU. When an application is executed thereon, the application is sealed inside the enclave, where it can run securely without fear of interference from other processes or from the operating system.

Additionally, TEEs may include a feature called “remote attestation”, which allows a remote party to verify the integrity and security of an enclave, thus providing a way to trust the enclave. Remote attestation may work by allowing a remote party to send a request to the enclave, asking the enclave to provide proof of its identity and integrity. Integrity may refer to the quality of data, functions and/or applications being accurate, consistent, and unaltered. The enclave may then respond by providing a cryptographic signature that may be based on the enclave's unique identity and a set of measurements of the enclave's code and data. The remote party may then verify the signature using a public key provided by the enclave. If the signature is valid, the enclave is authentic and has not been tampered with, allowing the remote party to trust the enclave and its data. The container may thus be protected by a cryptographic key, isolating the container from the Operating System (OS) managing the TEE, the cryptographic key being required to access the DE hosted in the HOP in the container. In possible embodiments, the container may receive an attestation request by a remote device and provide the cryptographic key to the remote device based on a unique identifier of the content or the functionality of the container, to attest authenticity of the container. A remote device may be any processing device that this outside the HOP or the hosting network, and that may need to access contents of a Digital Entity hosted in the HOP. For example, a remote device can be a User Equipment that may need to access an application executed by the digital representative of the user, i.e. the D-User.

In possible embodiments, the proposed method and system may provide for the creation and maintenance of Digital Entities, such as D-Users or D-Reps, inside a TEE, such that even the hosting network may not be able to access the Digital Entity data, including user data or codes (i.e. applications) used by the Digital Entity. In possible embodiments, the entire platform hosting the digital entities, the HOP, may be instantiated in a TEE, such that the HOP and the Digital Entities managed in the platform are isolated by their hosting network. A TEE may correspond to a Confidential Computing Environment (CEE) located inside the HN. In possible embodiments, a user or a customer using the HOP functions or the Digital Entity functions (such as D-User or D-Rep functions) may need to verify that the program codes (software) inside the HOP and the program codes (software) representing each Digital Entity consists of standard or expected codes which do not allow either the HN functions or any external entity to access or tamper with these codes. For this purpose, a remote attestation of the program codes, software or applications executed in the HOP may be provided.

According to possible embodiments, since the HN may be installing the HOP and the initial functions required to create the Digital Entities, such as D-Reps, users requesting the creation of the Digital Entities and/interacting with the Digital Entities may require a guarantee that the Digital Entities, the HOP or the hosting network cannot present a breach in privacy.

Therefore, a method may be provided for allowing users and/or customers to verify the program codes and applications used by the Hosting Network and/or HOP, according to a standard process. According to a possible embodiment, users may be provided with means to upload the program codes of the functions to the Digital Entity and/or instantiate those functions inside the Digital Entity. However, users may not be able to develop such program codes on their own and may need to obtain the program codes from a vendor. In order for the user to verify the legitimacy and credentials of a given functionality, program codes may be standardized and standard testing methods may be provided. Test methods may be standardized as well. Independent organizations testing the program codes may have the authority to certify program codes as certified or approved. Users may thus have access to certified program codes when they need the program codes to be executed in the Digital World provided by the Hosting Network.

In other embodiments, the certification may be done by the user or customer directly, using a testing program, which can perform remote attestation of program codes running in the HOP and/or Digital Entities. A program code or software to be executed by a Digital Entity may be provided with a cryptographic signature, such as a hash of the program code. The user may be able, via a testing program or software, to verify the hash of the program code.

A possible issue may be that, even if a user has installed a certified version of an application or of a function inside a Digital Entity (such as a D-Rep or a D-User), the application or function already created inside the Digital Entity by the HOP or by the Hosting Network may not be credible or certified. In this case, functions such as the Digital Entity Manager (D-Rep-M) and HOP functions (HPFs) may need to be tested for credibility/authenticity.

According to a possible embodiment, certified TEE vendors may be trusted to use certified program codes for the instantiation or creation of the HOP and Digital Entities hosted therein. According to another embodiment, a TEE vendor may be required to install only certified versions of those program codes so that when a user undergoes remote attestation of the program code inside the container, the signature of the container and/or program codes may be obtained and verified by a trusted authority, such as an approved 3^{rd} party organization certified to validate the certified signatures. The User Equipment (UE) may verify authenticity of the container by providing a cryptographic key to a 3^{rd} party device. In return, the 3^{rd} party device can provide at least one of: the container; contents inside the container; and functionalities of the container to confirm the authenticity of the container. A 3^{rd} party can act as an authentication entity, which may verify the authenticity of the contents of the HOP. A 3^{rd} party device can be a server controlled and managed by the authentication entity.

Consequently, two types of standardized functions may be required, a first certified function for the HOP, and a second certified version for the Digital Entities, such as D-Reps, which may be verifiable using standard tests.

In possible embodiments, and in the context of the present application, a TEE can be preconfigured or preinstalled with specific program codes which may enable the TEE to perform some of the following functions:
Automatically create (or self-create) certified versions of Digital Entities inside the TEE according to blueprints provided beforehand when requested to create a Digital Entity by a Hosting Network Function (HNF). The creation of the Digital Entities may include providing a secure key and a physical entity address (such as a MAC or IP address) to establish secure communications between the Digital Entities (such as D-Reps) and the physical entity. A “certified version” of a Digital Entity may be a Digital Entity blueprint, corresponding to a standard description kept inside the TEE. The blueprint may correspond to an approved version certified by a standard organization;
Provide functions inside the HOP, such as HOP management functions (HMF), to control access from outside HOP to internal functions of the HOP;
Allow a limited number of operations to be performed when requested by an HNF. These limited number of operations can comprise the creation or deletion of Digital Entities, resource assignment for the Digital Entities, establishment of links with physical entities.

Once a secure communication link is established between a Digital Entity and the physical entity, the physical entity may be able to attest the HOP and Digital Entity program codes as credible or certified ones, that is, untampered or unaltered by the HN or by any other entity. In order to ensure integrity of the HOP, the physical entity may obtain a state of the current program code of the HOP, and may verify the HOP program code with the TEE provider to ensure the authenticity and/or credibility of the HOP program code. A remote attestation service may be provided by the TEEs, comprising for example a hash of the code used by the HOP and the D-Rep).

After remote attestation, the physical entity may request the network services needed and the HOP can facilitate providing the network service requirements when requested by the Digital Entities.

When the HN is not a trusted network with regard to the physical entity, the use of a TEE to create the HOP and the Digital Entities hosted therein may allow for the provision of a secure area inside the Hosting Network. The Hosting Network (HN), or network provider, may be able to guarantee the user and related physical devices that the area is closed and inaccessible to the network provider. When the HN receives a TEE by a TEE provider, the TEE may be provided with an access key, such as a cryptographic key, to access the TEE. The access key can be handed over to the end user (or UE) while providing an anchor function through which messages to and from the Digital Entity can be sent. Data and applications inside the TEE should not be tampered with by the HN. This preservation of privacy can be achieved by only allowing specific operations to be carried out by the HN, such as controlling code and functions already inserted inside the TEE by the TEE provider, which cannot be tampered with.

In possible embodiments, the proposed method and system provides for the creation and maintenance of a D-User inside a TEE, such that even the hosting network may not be able to access user data or codes (i.e. applications) used by the D-User.

### 6.7. NET4DW Service Module

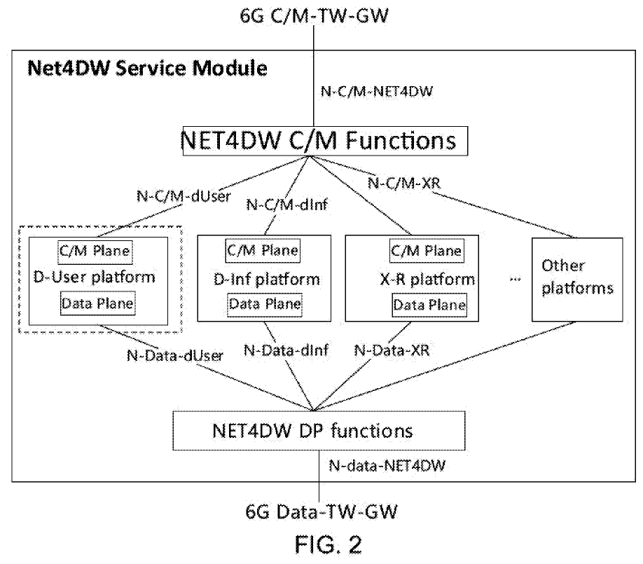

Referring to FIG. 2, in possible embodiments, a digital world network service module is schematically illustrated, which can provide Digital World (DW) services and which may include a capability to construct, control and manage objects and entities in a digital or virtual world. The digital world network service module may also be referred to herein as a “NET4DW” service module. A digital world can be defined as a digital realization or implementation of a physical world, including for example people, processes, animals, objects, such as robots, cars, lights, and infrastructures, such as roads, organizations, buildings and factories. For this application, the terms digital entities, DE, D-XX, DE module or D-XX module may be used to represent any of the above items. The NET4DW service module may provide different services to allow applications to run or be executed in the DW. In particular, the NET4DW service module may include D-Users, which correspond to digital representations of physical users (P-Users). Currently, some form of digital representation of a user is available in certain metaverses or servers such as Facebook™, Amazon™, Google™, etc. The required representation can vary from application to application and can vary from using user data to controlling personal items and actions on behalf of the user. A D-User can comprise a set of parameters and data corresponding to characteristics of a real, physical person or animal, including not only nominative data, such as a name, age, address, but also other characteristics, such as real-time location, heartbeat, medical conditions, preferences, physiological data, the user context, environmental context, mobility, past activities which can be gathered from sensors or not. A D-User may also comprise one or more software applications or modules that can simulate, predict or replicate the behavior or condition of the real, physical person associated with the D-User. Operational data defines operations performed by functions of the one or more D-Reps or D-Users. Operational data may comprise one or more of: processing of input data, modifying input data, forwarding input data or processed data to a specified destination, deleting input data, creation of other functions and life cycle management of other functions, resource assignment for other functions, modifying other functions.

FIG. 2 provides an exemplary high-level architecture of an NET4DW service module.

As shown in FIG. 2, NET4DW may include different types of Hosting Platform (HOP) for hosting Digital Entities, such as D-User platforms, D-Inf platforms and any other DW platforms such as Virtual Reality (X-R) platforms. These platforms may host one or more digital entities, which are commonly termed DE, DE module, D-XX or D-XX modules in the present disclosure. A D-Inf platform may contain digital representatives (D-Reps or D-Rep modules) of different physical objects, such buildings, roads or lights, and D-Inf can replicate an infrastructure such as a city, as an example only.

In the diagram C/M refers to control and management plane and DP refers to data plane. Net4DW C/M functions are the control and management functions of the NET4DW to manage and coordinate the platform interactions required for different DW applications. It may also include the Control and Management Gateway (C/M G/W) function though which the NET4DW C/M functions interact with the external C/M functions. Similarly, DP functions are the data plane functions such as routing and data processing functions. Each platform has its own C/M and DP functions and they may connect to Net4DW functions through G/W functions. A HOP platform may be a single Digital Entity platform or a multiple Digital Entity Platform (multiple DE-HOP). For example, a single D-User HOP may be used for hosting a single D-User (replica of a physical user) or multiple D-User platform may be used for hosting multiple D-Users, for example, a group of friends or a family.

Details of NET4DW functions, which may need to be instantiated when the NET4DW platform is created, may be needed for its proper creation and operation.

In addition, the digital entities (D-XX) used in the NET4DW and the NET4DW operations may require privacy preservation. In particular, the DW operations may need to be isolated from the hosting networks. Therefore, the hosting platforms discussed in this application may be used for providing in-network DWs as well.

In possible implementations, the present application provides for the creation of an isolated hosting platform (HOP) for digital entities (D-XX) inside the hosting network which may instantiate the entities when needed. The functions in the hosting network to create the hosting platform (referred to as Hosting Network Function—HNFs) and the functions inside the hosting platform (referred to as HOP Network Functions—HPFs) which may enable the creation digital entities (D-XX), including D-Users, are also included.

This application also provides different options that the network operator may use to create the hosting platforms (HOPs). Platforms can take various forms, such as a single-entity platform like a D-User platform, or a multi-entity platform like a multi-D-User platform, a NET4DW platform, or an isolated function module within the hosting network. Creation procedures are outlined separately for each case, along with descriptions of the functional architecture of the platform, including its main functions and interfaces.

The hosting network (NH) can be a trusted network or an untrusted network. In the untrusted case, this application may further provide methods to prevent the hosting network from accessing the digital entity data when a user requires processing to process data inside the HOP or when a user shares data with external devices outside the hosting network, such as 3^{rd} parties.

In addition, in the untrusted case, this application may provide methods to create the hosting platform (HOP) to prevent the hosting network (HN) from accessing information about the external servers the digital entities (such as D-User) access.

In addition, in the untrusted case, this application describes how the HOP may be created to anonymously access external servers (or 3^{rd} party servers) and also prevent the hosting network to access this information.

### 6.8. Communication Network System

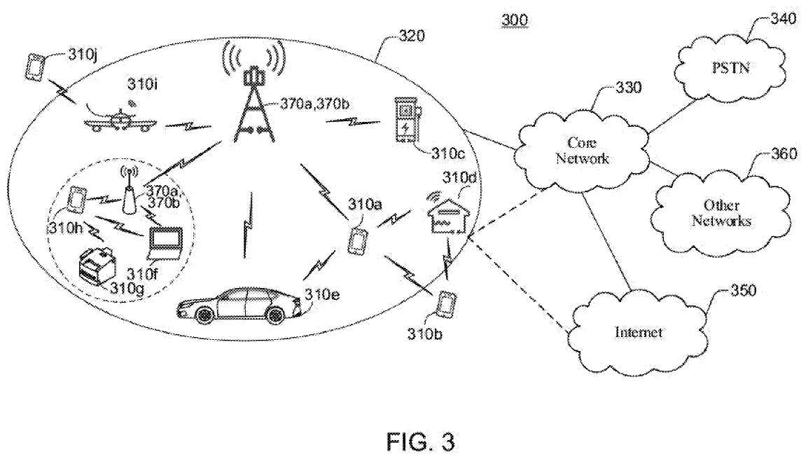

Referring to FIG. 3, as an illustrative example without limitation, a simplified schematic illustration of a communication network system is provided. The communication system 300 comprises a radio access network (RAN) 320. The radio access network 320 may be a next generation (e.g. sixth generation (6G) or later) radio access network, or a legacy (e.g. 5G, 4G, 3G or 2G) radio access network. One or more communication electronic devices (ED), including for example User Equipment (UE), 310a, 310b, 310c, 310d, 310e, 310f, 310g, 310h, 310i, 310j (generically referred to as 310) may be interconnected to one another or connected to one or more network nodes (370a, 370b, generically referred to as 370) in the radio access network 320. A core network 330 may be a part of the communication system and may be dependent or independent of the radio access technology used in the communication system 300. Also, the communication system 300 comprises a public switched telephone network (PSTN) 340, the internet 350, and other networks 360.

### 6.9. Communication System with Wired and Wireless Elements

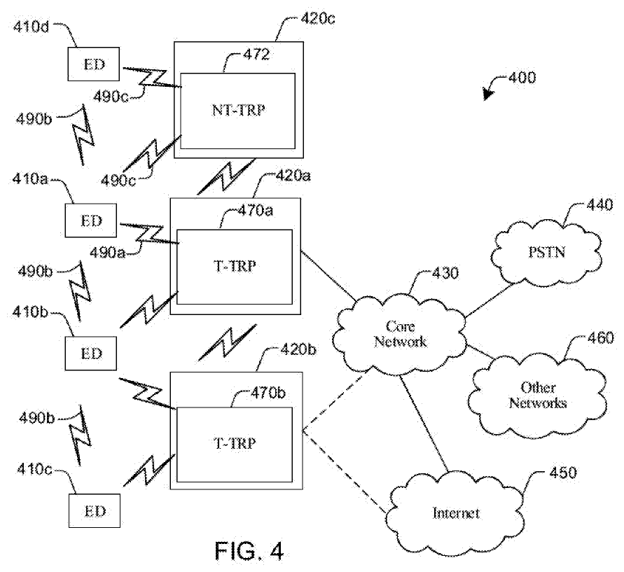

FIG. 4 illustrates an example communication system 400. In general, the communication system 400 enables multiple wireless or wired elements to communicate data and other content. The purpose of the communication system 400 may be to provide content, such as voice, data, video, and/or text, via broadcast, multicast, groupcast, unicast, etc. The communication system 400 may operate by sharing resources, such as carrier spectrum bandwidth, between its constituent elements. The communication system 400 may include a terrestrial communication system and/or a non-terrestrial communication system. The communication system 400 may provide a wide range of communication services and applications (such as earth monitoring, remote sensing, passive sensing and positioning, navigation and tracking, autonomous delivery and mobility, etc.). The communication system 400 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 4, the communication system 400 includes electronic devices (ED) 410a, 410b, 410c, 410d (generically referred to as ED 410, which may include User Equipment (UE)), radio access networks (RANs) 420a, 420b, a non-terrestrial communication network 420c, a core network 430, a public switched telephone network (PSTN) 440, the Internet 450, and other networks 460. The RANs 420a, 420b include respective base stations (BSs) 470a, 470b, which may be generically referred to as terrestrial transmit and receive points (T-TRPs) 470a, 470b. The non-terrestrial communication network 420c includes an access node 472, which may be generically referred to as a non-terrestrial transmit and receive point (NT-TRP) 472.

Any ED 410 may be alternatively or additionally configured to interface, access, or communicate with any T-TRP 470a,470b and NT-TRP 472, the Internet 450, the core network 430, the PSTN 440, the other networks 460, or any combination of the preceding. In some examples, ED 410a may communicate an uplink and/or downlink transmission over a terrestrial air interface 490a with T-TRP 470a. In some examples, the EDs 410a, 410b, 410c, and 410d may also communicate directly with one another via one or more sidelink air interfaces 190b. In some examples, ED 410d may communicate an uplink and/or downlink transmission over a non-terrestrial air interface 190c with NT-TRP 472.

The air interfaces 490a and 490b may use similar communication technology, such as any suitable radio access technology. For example, the communication system 400 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 490a and 490b. The air interfaces 490a and 490b may utilize other higher dimension signal spaces, which may involve a combination of orthogonal and/or non-orthogonal dimensions.

The non-terrestrial air interface 490c can enable communication between the ED 410d and one or multiple NT-TRPs 472 via a wireless link or simply a link. For some examples, the link is a dedicated connection for unicast transmission, a connection for broadcast transmission, or a connection between a group of EDs 410 and one or multiple NT-TRPs 472 for multicast transmission.

The RANs 420a and 420b are in communication with the core network 430 to provide the EDs 410a, 410b, and 410c with various services such as voice, data, and other services. The RANs 420a and 420b and/or the core network 430 may be in direct or indirect communication with one or more other RANs (not shown), which may or may not be directly served by core network 430, and may or may not employ the same radio access technology as RAN 120a, RAN 420b or both. The core network 430 may also serve as a gateway access between (i) the RANs 420a and 420b or EDs 410a 110b, and 410c or both, and (ii) other networks (such as the PSTN 440, the Internet 450, and the other networks 460). In addition, some or all of the EDs 410a, 410b, and 410c may include functionality for communicating with different wireless networks over different wireless links using different wireless technologies and/or protocols. Instead of wireless communication (or in addition thereto), the EDs 410a, 410b, and 410c may communicate via wired communication channels to a service provider or switch (not shown), and to the Internet 450. PSTN 440 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 410a, 410b, and 410c may be multimode devices capable of operation according to multiple radio access technologies, and incorporate multiple transceivers necessary to support such.

### 6.10. Electronic Device (ED) and T-TRP/NT-TRP

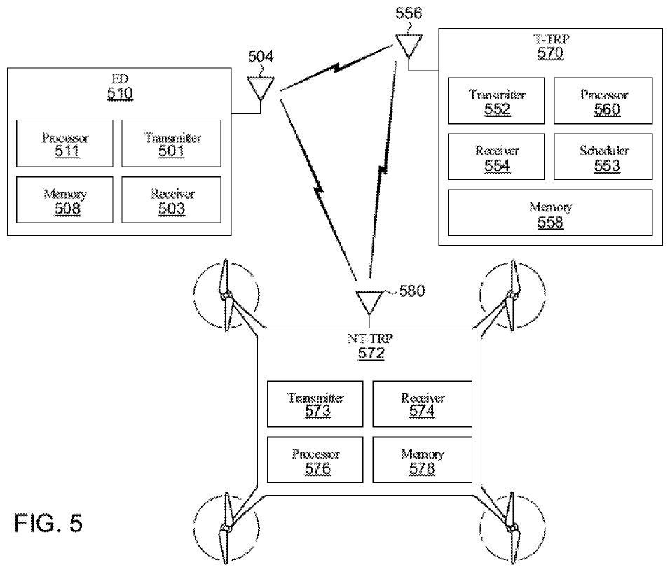

FIG. 5 illustrates another example of an ED 510 and a base station 570a, 570b 5 and/or 570c. The ED 510 is used to connect persons, objects, machines, etc. The ED 510 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 510 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 510 may be referred to using other terms. The base station 570a and 570b is a T-TRP and will hereafter be referred to as T-TRP 570. Also shown in FIG. 5, a NT-TRP will hereafter be referred to as NT-TRP 572. Each ED 110 connected to T-TRP 570 and/or NT-TRP 572 can be dynamically or semi-statically turned-on (i.e., established, activated, or enabled), turned-off (i.e., released, deactivated, or disabled) and/or configured in response to one of more of: connection availability and connection necessity.

The ED 510 includes a transmitter 501 and a receiver 503 coupled to one or more antennas 504. Only one antenna 504 is illustrated to avoid congestion in the drawing. One, some, or all of the antennas 504 may alternatively be panels. The transmitter 501 and the receiver 503 may be integrated, e.g. as a transceiver. The transceiver is configured to modulate data or other content for transmission by at least one antenna 504 or network interface controller (NIC). The transceiver is also configured to demodulate data or other content received by the at least one antenna 504. Each transceiver includes any suitable structure for generating signals for wireless or wired transmission and/or processing signals received wirelessly or by wire. Each antenna 504 includes any suitable structure for transmitting and/or receiving wireless or wired signals.

The ED 510 includes at least one memory 508. The memory 508 stores instructions and data used, generated, or collected by the ED 110. For example, the memory 508 could store software instructions or modules configured to implement some or all of the functionality and/or embodiments described herein and that are executed by one or more processing unit(s) (e.g., a processor 510). Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 510 may further include one or more input/output devices (not shown) or interfaces (such as a wired interface to the Internet 350 in FIG. 3). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 510 includes the processor 511 for performing operations including those operations related to preparing a transmission for uplink transmission to the NT-TRP 572 and/or the T-TRP 570; those operations related to processing downlink transmissions received from the NT-TRP 572 and/or the T-TRP 570; and those operations related to processing sidelink transmission to and from another ED 510. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 503, possibly using receive beamforming, and the processor 511 may extract signaling from the downlink transmission (e.g. by detecting and/or decoding the signaling). An example of signaling may be a reference signal transmitted by the NT-TRP 572 and/or by the T-TRP 570. In some embodiments, the processor 511 implements the transmit beamforming and/or the receive beamforming based on the indication of beam direction, e.g. beam angle information (BAI), received from the T-TRP 570. In some embodiments, the processor 511 may perform operations relating to network access (e.g. initial access) and/or downlink synchronization, such as operations relating to detecting a synchronization sequence, decoding and obtaining the system information, etc. In some embodiments, the processor 511 may perform channel estimation, e.g. using a reference signal received from the NT-TRP 570 and/or from the T-TRP 570.

Although not illustrated, the processor 511 may form part of the transmitter 501 and/or part of the receiver 503. Although not illustrated, the memory 508 may form part of the processor 511.

The processor 511, the processing components of the transmitter 501, and the processing components of the receiver 503 may each be implemented by the same or different one or more processors that are configured to execute instructions stored in a memory (e.g. in the memory 508). Alternatively, some or all of the processor 511, the processing components of the transmitter 501, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 570 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 570 may refer to the forgoing devices or refer to apparatus (e.g. a communication module, a modem, or a chip) in the forgoing devices.

In some embodiments, the parts of the T-TRP 570 may be distributed. For example, some of the modules of the T-TRP 570 may be located remote from the equipment that houses the antennas 256 for the T-TRP 570, and may be coupled to the equipment that houses the antennas 556 over a communication link (not shown) sometimes known as front haul, such as common public radio interface (CPRI). Therefore, in some embodiments, the term T-TRP 570 may also refer to modules on the network side that perform processing operations, such as determining the location of the ED 510, resource allocation (scheduling), message generation, and encoding/decoding, and that are not necessarily part of the equipment that houses the antennas 556 of the T-TRP 570. The modules may also be coupled to other T-TRPs. In some embodiments, the T-TRP 570 may actually be a plurality of T-TRPs that are operating together to serve the ED 510, e.g. through the use of coordinated multipoint transmissions.

The T-TRP 570 includes at least one transmitter 552 and at least one receiver 554 coupled to one or more antennas 556. Only one antenna 256 is illustrated to avoid congestion in the drawing. One, some, or all of the antennas 256 may alternatively be panels. The transmitter 552 and the receiver 554 may be integrated as a transceiver. The T-TRP 570 further includes a processor 560 for performing operations including those related to: preparing a transmission for downlink transmission to the ED 510, processing an uplink transmission received from the ED 510, preparing a transmission for backhaul transmission to the NT-TRP 572, and processing a transmission received over backhaul from the NT-TRP 572. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 511 may also perform operations relating to network access (e.g. initial access) and/or downlink synchronization, such as generating the content of synchronization signal blocks (SSBs), generating the system information, etc. In some embodiments, the processor 560 also generates an indication of beam direction, e.g. BAI, which may be scheduled for transmission by a scheduler 553. The processor 260 performs other network-side processing operations described herein, such as determining the location of the ED 510, determining where to deploy the NT-TRP 572, etc. In some embodiments, the processor 560 may generate signaling, e.g. to configure one or more parameters of the ED 510 and/or one or more parameters of the NT-TRP 572. Any signaling generated by the processor 560 is sent by the transmitter 552. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control—Control Element (MAC-CE) signaling.

The scheduler 553 may be coupled to the processor 560. The scheduler 553 may be included within or operated separately from the T-TRP 170. The scheduler 553 may schedule uplink, downlink, sidelink, and/or backhaul transmissions, including issuing scheduling grants and/or configuring scheduling-free (e.g., “configured grant”) resources. The T-TRP 170 further includes a memory 558 for storing information and data. The memory 258 stores instructions and data used, generated, or collected by the T-TRP 170. For example, the memory 558 could store software instructions or modules configured to implement some or all of the functionality and/or embodiments described herein and that are executed by the processor 560.

Although not illustrated, the processor 560 may form part of the transmitter 552 and/or part of the receiver 554. Also, although not illustrated, the processor 560 may implement the scheduler 553. Although not illustrated, the memory 558 may form part of the processor 560.

The processor 560, the scheduler 553, the processing components of the transmitter 252, and the processing components of the receiver 554 may each be implemented by the same or different one or more processors that are configured to execute instructions stored in a memory, e.g. in the memory 558. Alternatively, some or all of the processor 560, the scheduler 553, the processing components of the transmitter 552, and the processing components of the receiver 554 may be implemented using dedicated circuitry, such as a programmed FPGA, a hardware accelerator (e.g., a GPU or AI accelerator), or an ASIC.

Although the NT-TRP 572 is illustrated as a drone only as an example, the NT-TRP 572 may be implemented in any suitable non-terrestrial form, such as satellites and high altitude platforms, including international mobile telecommunication base stations and unmanned aerial vehicles, for example. Also, the NT-TRP 572 may be known by other names in some implementations, such as a non-terrestrial node, a non-terrestrial network device, or a non-terrestrial base station. The NT-TRP 572 includes a transmitter 572 and a receiver 574 coupled to one or more antennas 580. Only one antenna 580 is illustrated to avoid congestion in the drawing. One, some, or all of the antennas may alternatively be panels. The transmitter 572 and the receiver 574 may be integrated as a transceiver. The NT-TRP 572 further includes a processor 576 for performing operations including those related to: preparing a transmission for downlink transmission to the ED 510, processing an uplink transmission received from the ED 510, preparing a transmission for backhaul transmission to T-TRP 570, and processing a transmission received over backhaul from the T-TRP 570. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 570. In some embodiments, the processor 576 may generate signaling, e.g. to configure one or more parameters of the ED 510. In some embodiments, the NT-TRP 572 implements physical layer processing, but does not implement higher layer functions such as functions at the medium access control (MAC) or radio link control (RLC) layer. As this is only an example, more generally, the NT-TRP 572 may implement higher layer functions in addition to physical layer processing.

The NT-TRP 572 further includes a memory 578 for storing information and data. Although not illustrated, the processor 576 may form part of the transmitter 572 and/or part of the receiver 574. Although not illustrated, the memory 578 may form part of the processor 576.

The processor 576, the processing components of the transmitter 572, and the processing components of the receiver 574 may each be implemented by the same or different one or more processors that are configured to execute instructions stored in a memory, e.g. in the memory 578. Alternatively, some or all of the processor 576, the processing components of the transmitter 572, and the processing components of the receiver 574 may be implemented using dedicated circuitry, such as a programmed FPGA, a hardware accelerator (e.g., a GPU or AI accelerator), or an ASIC. In some embodiments, the NT-TRP 572 may actually be a plurality of NT-TRPs that are operating together to serve the ED 510, e.g. through coordinated multipoint transmissions.

The T-TRP 570, the NT-TRP 572, and/or the ED 510 may include other components, but these have been omitted for the sake of clarity.

### 6.11. Electronic Device Modules

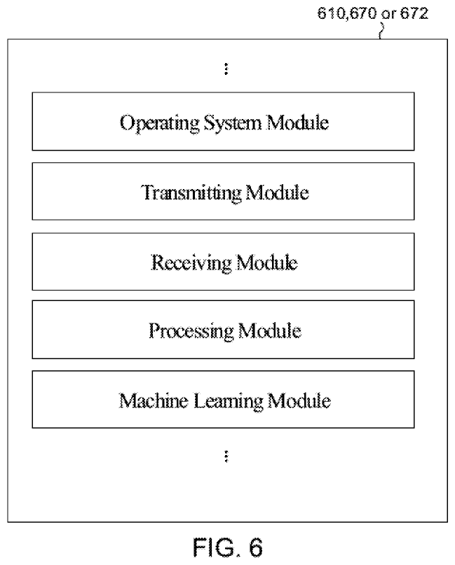

One or more steps of the embodiment methods provided herein may be performed by corresponding units or modules, according to FIG. 6. FIG. 6 illustrates units or modules in a device, such as in the ED 610, in the T-TRP 670, or in the NT-TRP 672. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It may be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 610, the T-TRP 670, and the NT-TRP 672 are known to those of skill in the art. As such, these details are omitted here.

The solution described in the application is applicable to a next generation (e.g. sixth generation (6G) or later) network, or a legacy (e.g. 5G, 4G, 3G or 2G) network.

In possible embodiments, the proposed System architecture is defined to support XaaS services by using techniques such as Network Function Virtualization and Network Slicing. The System architecture utilizes service-based interactions between services.

### 6.12. Service-Based Architecture

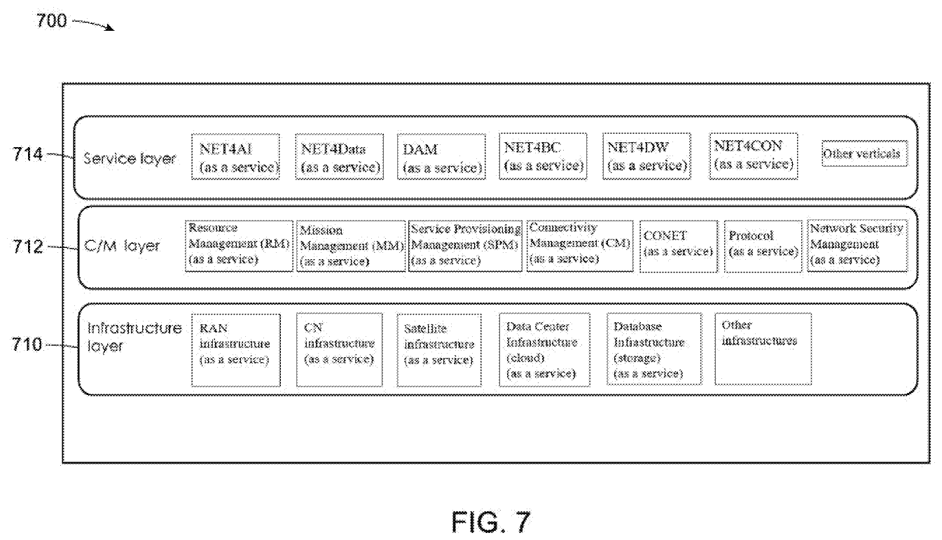

In possible embodiments, the network system 700, which can be a network system (such as a 6G network system), leverages service-based architecture and XaaS concept. XaaS services in the system are categorized into three layers 710, 712, 714. A possible embodiment of a system conceptual structure is shown in FIG. 7.

In possible embodiments, Infrastructure Layer 710 may include infrastructures supporting network services (such as 6G services). Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures may have its control and management functions, denoted as C/M functions, for infrastructure management. Each of these infrastructures can be one type of Infrastructure as a Service.

In possible embodiments, Control and Management (C/M) layer 712 may include control and management services of the System. They are developed and deployed by using slicing techniques and utilizing resource provided by infrastructure layer. Services in Control and Management (C/M) layer 712 may include:
A Resource Management module comprising Resource Management (RM) as a Service functions, which may provide a capability of life-cycle management of a variety of slices and over-the-air resource assignment to wireless devices;
A mission module defined as a service provided to customers by the System. A mission can be a set of services which is provided by a single XaaS service or a type of services that requires contributions from multiple XaaS services;
A Mission Management module comprising Mission Management (MM) as a Service functions, which may provide a capability to program provisioning of XaaS services at Service Layer to provide mission services;
A CONET module comprising Confederation Network (CONET) as a Service functions, which may provide a capability to enable multiple partners to jointly provide services. This capability is provided by confederation formation, mutual authentication, mutual authorization among partners and negotiation of agreement on recording and retracing of selected actions performed by partners, in order to assure a trustworthy environment of System operations
A Service Provisioning Management module functions, which comprises Service Provisioning Management (SPM) as a Service, to provide a capability of control and management of service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world;
A Connectivity Management module, which comprises Connectivity Management (CM) as a Service functions, to leverage connectivity management functions of older networks such as 5G, but with extension to include digital world;
A Protocol as a Service module, which comprises Protocol as a Service functions to provide a capability to design service customized protocol stacks for identified interfaces. The protocol stacks can be pre-defined for on-demand selection, or can be on-demand designed;
A Network Security as a Service module, which comprises Network Security as a Service functions to provide a capability for owners of infrastructures to detect potential security risks of their infrastructures;
A XaaS module, comprising XaaS services in the C/M Layer support control and management 712 of the System itself and also provide support to verticals if requested. One example is that RM service can serve RAN for over-the-air resource management and can also provide service to a vertical for the vertical's over-the-air resource allocation to its end-customers. The XaaS in C/M layer can be deployed by using slicing technique.

Service Layer 714 may include services which provide services to customers. In the System structure 700, the following modules may be included:
An AI service module, denoted as NET4AI as a Service. Artificial Intelligence service functions provide AI capability to support a variety of AI applications;
A Data Analytics Management (DAM) module comprising Service of data collection, data sanitization, data analysis and data delivery functions, denoted as DAM as a Service, this service provides a capability of lifecycle management of statistic data, including acquisition, de-privatization, analysis and delivery of data which are information statistic data from any types of sensors, devices, network functions etc.;
A NET4Data module, comprising Service of storage and sharing of data, denoted as NET4Data as a Service. This service module provides a capability to trustworthily storage and share data under the control of owners of data and following recognized authorities' regulations on control of identified data;
A NET4DW module, comprising Service to provide digital world, denoted as NET4DW as a Service. The Digital World module (or system) provide a capability to construct, control and manage digital world. Digital world is defined as digital realization of physical world;
A block chain module, comprising block chain service is denoted as NET4BC as a Service. A connectivity service is denoted as NET4Con as a Service. This service provides a capability to support block chain services;
A NET4CON module, comprising Enhanced connectivity service, e.g., network for connectivity (NET4CON) as a service. This service provides a capability to support exchange of messages and data among new services.

All XaaS services at this Layer may be developed and deployed by using resources provided in the infrastructure and utilizing Network Function Virtualization and Slicing techniques. The capability of each of the services is provided by its control and management (C/M) functions and service specific data process functions.

In addition to support XaaS services at Service Layer 714, the System 700 leverages previous networks, such as 5G Systems, for provisioning of vertical services. The difference between XaaS services and other verticals are that a vertical is a pure customer which may require other XaaS services to enable its operation, while each of XaaS services provide their capabilities to customers.

Any pair of XaaS services of the System may also be mutual customer and provider of each other. Some examples are that an infrastructure owner providing its resource to XaaS services in the Service Layer 714 and C/M Layer 712; RM services may need the capabilities provided by NET4AI, DAM and NET4DW for its resource management for vertical slicing; CONET service and NET4Data service may need the capability provided by NET4BC for their operation.

The structure and associated modules/platform of the proposed System may provide the following functionalities and advantages:
Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.
Allow joint operation of the System by multiple partners;
Define Data Plane of the System which includes processing functions of data plane of XaaS services. Programing the interconnection of these functions, by mission management service, enables to support a variety of customized customer services;
Simplify System architecture by categorizing basic control services and management services and combining them as basic XaaS services in Control and Management (C/M) Layer;
Define C/M Plane of the System which includes C/M functions in XaaS services and may include CP (e.g., AMF) depending on implementation options;
Define Basic Architecture Structure (BAS) which is a unified basic structure with minimized number of interfaces and is independent of types of infrastructures.

Simplify standardization, development and deployment of the System using the BAS concept, while supporting a variety of infrastructure deployment scenarios;
Adapt to a variety of deployment scenarios by applying the BAS or a subset of it to infrastructures based on capability, capacity and requirement of the infrastructure networks;
Leverage SBI interface concept and apply SBI interaction in both C/M plane and data plane;
Simplify SBI interfaces by introducing trustworthy GWs in Data Plane and C/M Plane of the System;
Improve trustworthiness from perspectives of operation of the System by introducing CONET capability, NET4BC capability and anonymous service provisioning provided by the trustworthy GWs in the C/M plane and data plane of the System;
Improve trustworthiness from perspective of end customer privacy protection by unified mutual authentication, IDM, data sanitization and etc. provided by SPM service, DAM service and Block Chain service;
Simplify roaming management of wireless devices, in physical world and digital world, by unified authentication including all participated partners and customers.

Support multiple development paths from known systems, such as 5G Systems to future systems, such as 6G Systems, by defining multiple architecture options without incurring much efforts due to the introduction of the BAS concept;
Support backward compatibility by utilizing benefits of SBA and its add-on feature. For, example, 5G users can use the 6G System to access 5G services;
Support future extension by adding new XaaS services with minimized impact on standardization and deployment, due to the introduced anonymous service provisioning concept implemented in trustworthy GWs in C/M plane and in data plane.

### 6.13. Network Operator to Share User Data with External Devices while Preserving Privacy

This application provides a system, a method, an architecture and a computer-readable memory that allows a network operator and/or a digital representative (D-Rep or D-User), or replica, of a real, physical user to share user data with external devices of third parties, while preserving user privacy. By “third party” “3^{rd} party” or “3^{rd} party external device”, it is meant a device, server or network that is not part of the network in which the D-Rep or D-User is hosted. An “external device” or “external node” can be any device, entity or function outside the D-User module, including for example 3rd party devices or Hosting Network functions.

User data refers to data that may be personal, including name, address, gender, age, interests, or sensor data collected from the user (heartbeat, blood pressure, temperature, location) or from user equipment (laptop, cell phone, home appliances, vehicles) which may benefit data consumers, and which may provide direct or indirect benefits to the user or the network. By “data consumer”, it is meant an application, system or network that uses data collected by other applications, systems, or networks. Data consumers may analyze the data it accesses and may provide services or information based on the consumed data.

Direct benefits provided by data consumers may include payments or retributions for the consumed data or user service improvement such as health or fitness advice, etc.;
Indirect benefits may include global weather information, road obstacle/traffic information etc.

For this purpose, the network uses a digital representative (D-User) which is a function module created within an isolated container (a hosting platform) inside the network. The isolated platform may be exclusively used by a single D-User, shared by multiple D-Users (Multi-D-User Platform) or shared by digital representatives of other entities (D-Rep, D-Inf) etc. similar to a NET4DW platform.

In possible embodiments, the hosting network may use a 3rd party accessible Shared Data Portal (SDP) for this purpose where data is kept after a de-privatization and anonymization process.

The hosting network may also use a privacy preserving portal (PPP) to carry out this de-privatization and anonymization process. The following paragraphs describe possible components or aspects of the proposed innovation.

User data may be shared with the D-User and may be regularly or constantly updated and synchronized. If necessary, user data may be pre-filtered at the User or User Equipment level. User data may be tagged, for example using metadata, with an indication of the Privacy Preserving Level (PPL) required for this data. User data comprises a plurality of user data subsets, units or blocks, that may each be associated with different PPL. For example, vacation photos may be associated with one level of privacy, the user's position may be associated with another privacy level, all the data linked to a given App running on the user's device may be associated with another privacy level.

User data may be prepared prior to being sent to the PPP using a Data Processing Function (DPF) executed within the D-User module, according to a category assigned to the User Data. For example, the DPF may change the Privacy Preserving Level (PPL) for de-privacy treatment of the User Data at the PPP.

Depending on the PPL and the data sharing policies established with the D-User, the PPP may process the User data and send the User data to a network operated Shared Data portal (SDP). The Shared Data portal (SDP) may be accessed by the 3rd party data consumers (or servers thereof). User data of multiple users may be kept in the SDP.

The PPP may change the user ID when sharing data with the SDP and the data may be filtered by processes such as a Fully Homomorphic Encryption (FHE) process to further de-correlate the data, so as to remove or encrypt user specific elements, related to the users (based on PPL).

Data in the SDP may be categorized and data consumers may access this categorized data. The SDP may be provided with access control functions, data categorization functions, charging and negotiation functions.

Negotiation with data consumers may be performed by the SDP according to the data usage by the Data Consumers.

3rd party Data Consumers may use data for their own purposes or for analysis thereof as indicated by the user.

Payment or analysis results may be provided to the D-user, and vice versa, anonymously

The hosting network may be a trusted network for a user or an untrusted network. In the case of an untrusted network, the present disclosure may further provide methods to avoid the hosting network from accessing the user's data when the user wants to process data inside the network or when the user shares data with 3^{rd} parties.

In addition, in the case of an untrusted network, the present disclosure may provide methods to create the hosting platform, to prevent the hosting network from obtaining or accessing information about external servers the D-User accesses. A brief description of the proposed method is provided below.

In some embodiments, a method to obtain user data while preserving privacy is provided. In some embodiments, a payment system to pay for the data is provided. In some other embodiments, a negotiation method for pricing agreements is provided.

The proposed method may allow third parties to provide a service to the user based on his/her needs while the third parties (or service providers) remains unaware of the user's identity, such that privacy is preserved when serving the user.

The proposed method also may allow user AI engines to coordinate with 3^{rd} party AI engines the sharing of user analytical and raw data.

In some embodiments, a system to share user data while preserving privacy is provided. The system may comprise at least one of a User Controlled Function (UCF) instantiated in the network, a Privacy Preserving Portal (PPP) and a Shared Data Portal (SDP) inside the network.

The method that allows sharing user data while preserving privacy may comprise one or more of the following steps:
Receive sharable user data that can be shared with external entities with a privacy preserving level (PPL) indication;
Categorize data according to Privacy Preserving Levels with historical information thereof;
Obtain from the privacy preserving portal (PPP) information to assess the different privacy preserving techniques needed to apply to the different types of data;
Send data to the PPP for de-privatization and then forwarding the user data to a network controlled multi-user data portal (SDP) to be shared with external data consumers,

The shared user data may comprise one or more of:

User personal information/interests (habits, needs, locations, communication groups, etc.)

User's content interests (user interests to obtain content from content providers, prefetching, communication needs).

User data that user needs to be analyzed by a 3rd party AI machine (e.g., AI4Net)

User data (may include raw data) or data models that may need to be exchanged for joint AI analysis with a 3rd party.

In possible embodiments, the present disclosure provides a method and system to share a physical user's personal data with 3^{rd} parties preserving privacy. User privacy may be important for a user, as currently users share their personal data with many organizations including Over the Top providers (OTTs) such as Google™, Amazon™, YouTube™, Netflix™, etc. and other service providers such as shops, equipment providers etc. Therefore, a unified data protection scheme is needed to preserve privacy while users can still share their data. Such data may include:
user queries (e.g. web sites, search),
user personal information (information of habits, family, friends, health, employment, finance etc.),
sensor information related to user (information from home alarms, body sensors, weather, location, user activities, equipment maintenance, etc.),
data which needs to be analyzed using AI engines, and
data needs to be exchanged with joint optimizations with external (e.g. network) AI engines

### 6.14. D-User and User Controlled and Managed (UCM) Services

In some embodiments, a method and a system to share a physical user's personal data with 3^{rd} parties preserving privacy using a Digital Representative of the user (D-User) in the network, a Privacy Preserving Portal (PPP) and a Shared Data Portal (SDP) is provided. A D-User can be placed inside any type of network (hosting network) such as a WIFI network, mobile network (RAN or CN) or any data network (DN).

Since any information provided from a user access device (UAD), or a user application can be regarded as personal data, the term ‘user’ is used to represent one or more of physical user (P-User), user equipment (UE), User access device (UAD) or user applications.

A Physical User (P-User) correspond to a real, physical entity using a network service, and can therefore correspond to a human, an animal or a machine such as a robot.

A user equipment (UE) can correspond to the equipment used by the P-User to interact with the network. The UE may consist of two parts, user personal device (UPD) where all user applications and other information is kept and User Access Device (UAD) which is the device used to access the network. UAD may be a public device which may be used by multiple users. The various sensors connected to the device may be considered as part of UPD as they carry user information. Therefore, UE may also correspond to a user access device (UAD), user applications and sensors.

The term ‘Digital User’ (D-User) refers to a digital representation of a user and may be described as a digital representation of one or more of:
real or physical user (P-User) such as a human, animal, or a robot,
P-User access device (UAD),
User equipment (UE),
UE sensors, and
user application.

The term ‘D-Rep’ refers to a Digital Representation and corresponds to a type of Digital Entity (D-XX). A D-Rep is the digital representation of any real physical objects or set of objects. The D-Reps can correspond to replicas or digital representatives of physical devices, including vehicles such as cars and robots, provided with connectivity to the network and sensors. Other types of digital entities include digital infrastructures (D-Inf) or digital networks (D-Net). A D-User is also another type of digital entity. The D-Users can be digital representatives of real or physical users (P-Users); P-User access device (UAD); User Equipment (UE); UE sensors; physical devices, and user applications.

Any type of Digital Entity (DE/D-XX), such as D-Users or a D-Reps, may be placed, that is, instantiated, stored, maintained and controlled, inside a Hosting Platform (HOP) of any type of network (hosting network) such as a WiFi network, a mobile network (RAN or CN) or any data network (DN), including 6G networks. When a network provides the resources to create and maintain HOPs, the network can be referred to as a Hosting Network (HN).

In possible embodiments, an in-network digital entity, such as D-User (i.e., a D-User hosted in a HOP) may act on behalf of the user and provide D-User services which can be termed as User-Controlled and Managed (UCM) services. For example, these can include: analyzing and processing user data, providing a computing platform to run user applications, providing AI services to the user, home control of the user, financial and health control, handling data sharing with the 3^{rd} parties, processing user data, acting on behalf of the user, obtaining content from 3rd party content providers, interacting with the network to obtain better communication services, interacting with the network to obtain network data, facilitating the interactions with 3^{rd} party servers, such as user accessing application servers and making payment and receiving payments.

Some of these actions are very personal to the entity, such as a user, and, therefore, exposure of the D-User data and operations may be limited or prevented from the hosting network. Such protection may not be needed if the hosting network is a trusted network. However, the trustworthiness may depend on the type of the services or actions the D-User is performing. The services the D-User provides (i.e., UCM services) may be categorized into three types:
D-User acting on behalf of the physical user by carrying out in-network processing, such as processing data, computing tasks such as running its own applications, analysis and AI, controlling user devices and health.
D-User facilitating interactions with 3^{rd} party entities (e.g. by providing privacy, sharing data, obtaining content from the content providers, financial transactions and establishing agreements and negotiations)
D-User interacting with the hosting network to enhance services obtained from the hosting network or 3^{rd} parties (improve the QoS of the communication services, obtain network data and state such as loading and topology)

A hosting network operator (HNO) such as a Mobile Network Operator (MNO) may decide the type of D-User that needs to be created in the D-User platform of the Digital World, based on the services the network needs to provide to the user.

### 6.15 A Data Sharing Model Allowing D-Users to Share Data by Applying Privacy Preserving Techniques

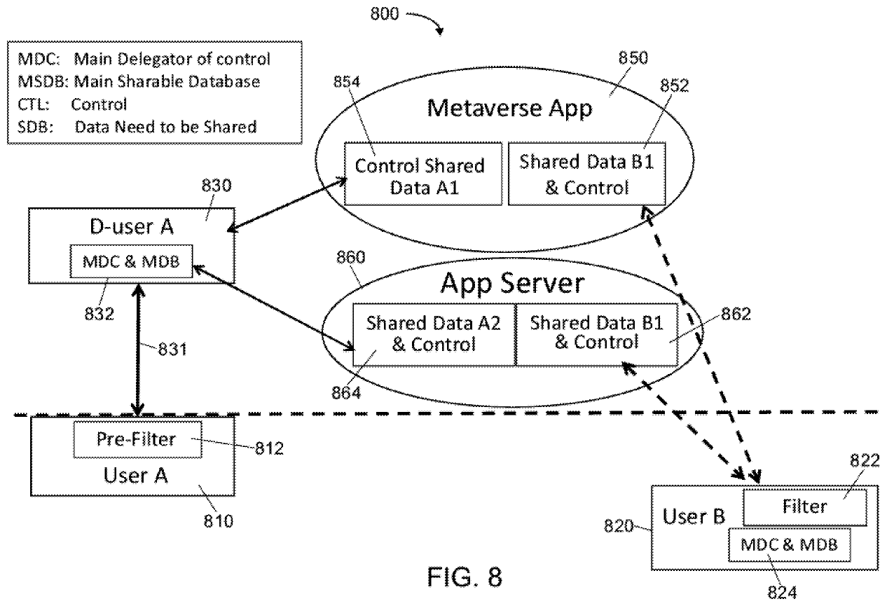

Referring to FIG. 8, according to a possible embodiment, a data sharing model 800, or system, is provided where a digital representative of a user (D-User) 830 instantiated inside a hosting network may obtain sharable data and may apply privacy preserving techniques.

FIG. 8 illustrates how User B 820 may share its data with various OTT applications such as 3^{rd} party metaverses 850 and application servers 860. The User B 820, which may be represented by a user application or the UE of user B, has to selectively share data, since the user identification and data may be exposed to the application server 860. In addition, the data itself may expose the user's privacy. In some cases, real or raw data may not be necessary. The data may be filtered or obfuscated by the user application or equipment 820, using a filter 822 but there is no way to avoid exposing the user identification, because the user ID and the IP address are disclosed.

Certain VPN sites may help anonymizing the user, through a user application or a User Equipment, although in that case the destination of the user communication site is exposed to the VPN with the user ID and the user IP address.

In a possible embodiment, the proposed data sharing model avoids or mitigate these issues by having a D-User 830 (or D-User module) hosted in the network change the user, application or User Equipment identification. The D-User 830 may also control the data sent to or received by the OTT application. By “controlling the data”, it is meant that the D-User controls the data that is shared, controls with which entity the data is shared, and controls the type of encryption or obfuscation scheme to be used etc.

In addition, the D-User 830 may be provided with the capability of controlling user devices and applications. In some embodiments, the D-User may be placed inside an entity in a wireless access network (WAN), e.g. a radio access network (RAN), a core network (CN) or a mobile edge network (MEC). Since all the mobile data goes through the WAN, a user may have access to a trustable data sharing model. If the WAN is trusted, the creation of such a D-User is possible. However, if the WAN is not trusted, as indicated later, the D-User may be placed in an isolated hardware-based container, such as in a Trusted Execution Environment (TEE) of a processing device or node, which is isolated from the network to preserve user privacy. In possible embodiments, the D-User 830 may also be placed inside a data network. However, keeping the Hosting Platform (HOP), which is the network entity or module hosting the D-User 830, inside a mobile network (MN) has many advantages compared to keeping it in a data network because:

Keeping the D-User closer to the real user (via his/her User Equipment) may reduce the delay between user and the D-User.

All communications of a mobile phone or device go though the wireless network and therefore a wireless network may be a better option to provide D-User services. In contrast, a user has many options to choose a host in a data network and the communications with other data networks may not go through the selected host and the selected host cannot provide all the services that a wireless network could provide.

When the host is located in a data network, the user may not have much visibility on the methods used by the hosting network for preserving privacy because a host in the cloud may not be as trustworthy as a network provider providing the mobile access to the user.

In possible embodiments, the D-User 830 may also be hosted inside a data network in the cloud. However, in this case, the user associated with the D-User may not have much visibility of the methods used by the hosting network for preserving privacy.

In some embodiments, the network operator provides a Sharable Data Portal (SDP) where user data may be categorized and stored so that the 3^{rd} party data consumers may obtain this data by first obtaining access permission from the network operator. Access may be provided via a negotiation process between the operator and the consumers, which may be based on benefits or advantages the operator obtains by sharing data and based on the value of the data. For example, consumers may pay to obtain data and part of the benefit the operator may obtain may be given to the user(s) providing the data.

Still referring to FIG. 8, User B 820 (or his/her User Equipment) which does not have a corresponding D-User (i.e. virtual representative or replica), is provided with filtering functions 822 and a Main Delegator of Control (MDC) and Main Data Base (MDB) 824. Thus, in the current data sharing model used by User B 820, User B's main delegator of control (MDC) is located at the physical Entity (or User Equipment) and shares parts of the data and control to different Metaverse or OTT applications (Apps) 850. Part of User's B data and control thereof exists in different applications and metaverses in the cloud.

In contrast, the proposed new data sharing model used by User A 810 may provide the Main Controller of Data (MDC) and a Main Sharable Database 832 in the Network, inside the D-User 830, and may have a privacy-preserving connection, single path 831 open to the external world via D-User 830 for most of the user (or user device) interactions. The User A 810 (or User Equipment) may solely be provided with Filtering Functions 812, also referred to as prefiltering. Although important communications and data go through the D-User (or D-User module), the user equipment may perform some pre-filtering, for example not to send important personal information and to encrypt parts of data which can reveal the user identification (e.g. using FHE), so that UE may take an extra step to prevent even the D-User module from having access to such information. In addition, pre-filtering at the User Equipment may block redundant data, invalid data or aged data/obsolete data from going to the D-User module. Thus, instead of having the User Equipment 810 communicate directly with external servers or network of third parties, as in the case of User B, User A may communicate with external servers of Metaverse applications 850 or Application Servers 860 via the D-User 830, which may control privacy of the data provided to these third parties. The D-user 830 may be located in the cloud or in the Mobile Network Operator (MNO) domain such as Core Network (CN) or Radio Access Network (RAN). The MNO has more opportunities to serve the user since all user traffic goes through the MNO as the first point of contact.

In summary, with reference to FIG. 8, a User B 820 (or his/her User Equipment) that does not use or have access to a digital representative or replica, may have data filtering function, or a filter 822, that can offer minimal filtering of the data incoming or outgoing toward external application servers 860 and metaverses applications 850. The delegation of control (main delegator of control) and main database 824 is provided at the User Equipment. This means that the data relating to the user is received directly by the external entities 850, 860 from the User Equipment, and that all privacy settings may be configured on the User Equipment. In addition, metaverse applications 850 and external application servers 860 have access and can store the data shared by User B and have control thereon, as per modules 852 and 862.

In the case where a User A 810 has access to its digital representative or replica, D-User A 830, control and privacy preservation of the personal data of User A may be performed via the D-User A. Control and privacy preservation may comprise performing control delegation and database management 832 inside the D-User A 830. This ensures that control and privacy-preservation techniques may be guaranteed and standardized according to the hosting network policies. This may also provide a single communication path 831 between the User Equipment 810 and external servers, where communications go through and may be controlled by the D-User module D-User A. External application servers 860 and metaverse applications 850 may have control on the shared data 854 of User A 854 only on selected data that has been provided thereto. That too may be de-privatized data. If User A has agreed to provide both data and control over his/her data to an external server, that this server may store and maintain this set of data and have control thereon, as in module 864.

In one embodiment, the user, via a User Equipment, may have a direct logical link with the D-User module so that the user may communicate with external entities via the D-User module. The logical link between the D-User and the User Equipment may be established as follows. The user or the D-User module may first request a connection from a Hosting Network Function (HNF) and after authentication of the requesting entity, the HNF may interact with both the D-User module and the UE to establish a connection between them, and support them to establish a secure communication link (e.g. by establishing a common key). Supporting may include having the HNF first providing IDs or location addresses such as IP addresses and security keys to authenticate each other in the first time, and these two entities may create their own security keys using, for example, public/private key generation techniques. Then, the D-User module and User Equipment may communicate with their public keys and decrypt messages using their private keys. The D-User and UE may have access to a certification authority (CA) for this purpose. In another embodiment of the method, the HNF may ask the D-User module and the UE to generate their public/private key pairs and then share the public key with the HNF and the HNF then shares the address and the public keys of the D-User module and User Equipment so that they can communicate with each other without visibility by the hosting network. After establishment of the secure communication link, the Control Plane and Data Plane communications may go through this secure link which is also used for data synchronization. Control plane messages from user to the D-User may go through a HN function in some implementations.

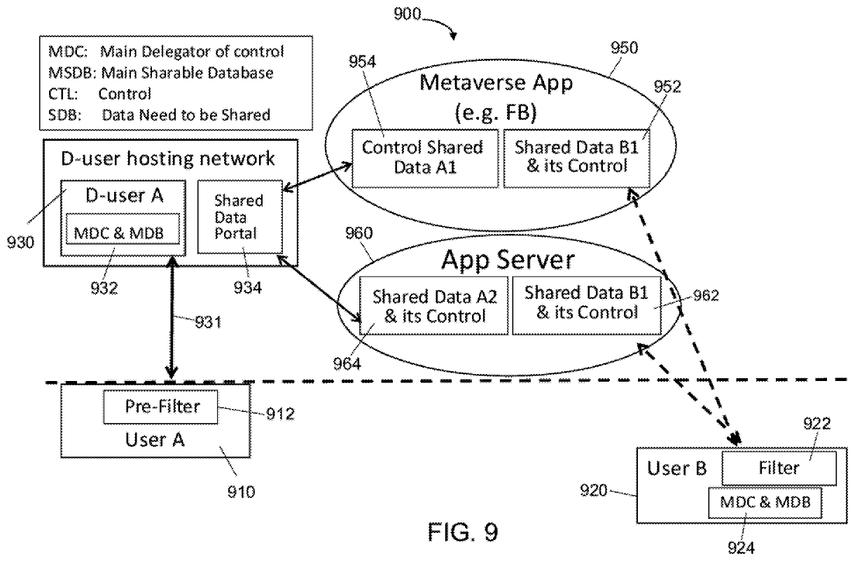

Referring to FIG. 9, another possible embodiment of a data sharing system or model 900 shows how external consumers, such as metaverses 950 and Application Servers 960, may obtain data from a Shared Data Portal (SDP) 934. In possible embodiments, User Data may be moved to the SDP 934 by the D-User module without the user ID, using a Temp-ID. However, SDP may still provide the benefits of data sharing such as any payment received from the data consumers to the actual (real) user as the SDP can send the benefit information using the TEMP-ID to the D-User. A Temp_ID may be provided by a PPP which may be a common module for multiple D-Users. The Temp_ID may be changed each time a data unit is shared with the SDP so that the SDP is unaware and cannot deduct whether multiple data units belong to a particular user. Data may also be de-privatized so that the user information cannot be obtained by correlating the data. Data may include network data which is obtained through network performance or network sensors but without disclosing sensitive information of the network.

For user data, this application provides a method such that the data consumers as well as the network operator may not be aware of the user (i.e. user identity) who provided the data. In another embodiment, the network may be aware of the user providing the data but the 3^{rd} party data consumers are not aware of the user identity.

In some embodiments, the isolation of the D-User container 930 may be provided by creating the D-user inside an enclave, such as a TEE. Since raw data is opened (i.e. accessed or retrieved) inside the network, i.e. data packets may be de-encapsulated, the D-User module hosting network may be able to access the user's data if the D-User is not fully isolated from the network.

In possible embodiments, privacy requirements of the user for different data types may be different. For example, the location information may not be very important for a given user, but a user may want to protect web sites, or the servers accessed by the user. Such details also can be considered as user personal data.

The remaining aspects of FIG. 9 are similar to those presented in relation to FIG. 8, i.e., User B Device or Equipment 920 performs filtering 922, control delegation and database management 924 in the Equipment. Metaverse applications 950 and external application servers 960 have both control and access to the data of User B, via modules 952 and 962.

User A 910 has access to its digital representative or replica, D-User A 930, where control and privacy preservation of the personal data of User A can be performed via the D-User A. Control and privacy preservation may comprise performing control delegation and database management 932 inside the D-User A 830. This may ensure that control and privacy-preservation techniques are guaranteed and standardized according to the hosting network policies. The User Data may transit to a Shared Data Portal 934 when communications occurs between the D-User A 930 and external servers and applications 950, 960. User Identification can be controlled or removed from the data transiting through the Portal 934. A single communication path 931 between the User Equipment 910 and external servers is provided, where communications go through and are controlled by D-User A 930. External application servers 860 and metaverse applications 850 may have control on the shared data 954 of User A 854 only on selected data that has been provided thereto, via the Shared Data Portal 934. If User A has agreed to provide both data and control over his/her data to an external server, that this server may store and maintain this set of data and have control thereon, as in module 964.

### 6.16. Examples of User Data Exchange Requirements with Privacy Issues

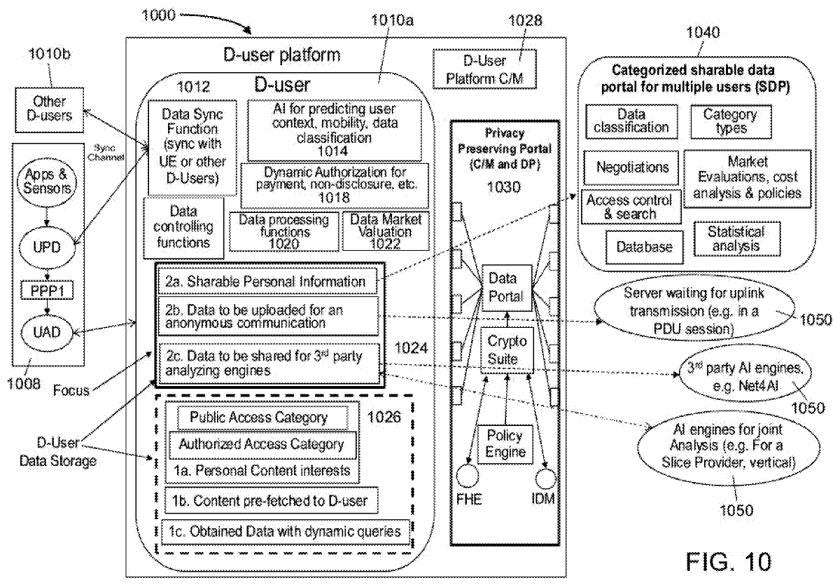

FIG. 10 provides different exemplary types of data exchange a user, via a User Equipment, may have with external entities, with more details on the data sharing embodiment in this application. A Privacy Preserving Portal (PPP) 1030 may be used to anonymize data and also to de-privatize data whenever applicable. The D-User C/M functions 1028 may be the platform management functions which include the creation and Life Cycle Management (LCM) of the D-User functions, the coordination and access control for the functions, resource management functions which will be discussed later in this document with a description of the D-User creation.

FIG. 10 shows possible situations of different types of data exchanges, including uploading data and downloading data scenarios, with a focus on the data uploading or data sharing scenarios.

FIG. 10 is a schematic illustration of a D-User platform and shows the interactions and exchanges the D-User may have via its different modules and via the PPP 1030, to access external contents.

The D-User platform 1000 allows creating and maintaining one or more D-Users 1010a. The D-User platform may comprise several modules and functions to provide services to the D-User 1010a. The D-User platform 1000 may comprise for example a D-User platform C/M 1028 and a Privacy Preserving Portal (PPP) 1030. The PPP 1030 can include C/M and Data Planes (not shown), and may comprise sub modules including a Data Portal, a Crypto Suite module and a Policy Engine module. Data exchanges may occur between External Services 1050 and the Sharable Data Portal (SDP 1040), which may be a portal in which the data from different users is categorized and shared with external data consumers.

The D-User 1010a may include a Data Synchronization Function or module 1012, which synchronizes D-User data with the user data in the User Equipment (UE) 1008 or other data in the SDP D-Users 1040. The synchronization means that when new data is available in either side (e.g. User Equipment or D-User), that data may be shared or deleted from both sides when the data item is no more of use. The D-User 1010a may also comprise an AI unit or module 1014, for prediction user context, mobility or location and for data classification. The D-User 1010a may also comprises Data Processing Functions 1020 and a Data Market Valuation module 1022. The D-User 1010a may also comprises D-User data storage, which may be divided in different segments or sections depending on the access level of the data, including for example: Sharable Personal Information, Data for Anonymous Communications, and Data to be shared for 3^{rd} Party Analysis Engines. The data requested by the D-User can be downloaded according to different cases or scenarios, including: Public Access, Authorized Access, Personal Content Interests, Content Pre-fetch and Content obtained via a direct access.

In a possible embodiment, a first step may consist in collecting user data in the D-User 1010a. A user, via his/her User Equipment 1008, may provide on purpose a subset of data of the User Equipment 1008 to the D-User 1010a, using for example a data synchronization function, identified as Data Sync Function 1012 in FIG. 10. The user data may be uploaded to the D-User 1010a (or D-User module), after performing filtering operations at the User Equipment, for example to prevent a specific type of personal/private data from being transferred in the D-User, or to flag the specific private/personal data with a high privacy-preserving level so that the D-User can take appropriate action for this type specific type of data. For this purpose, a data synchronization channel may be established between the User Equipment 1008 and the D-User 1010a, allowing a user to update data to his/her D-User on a regular basis, via this synchronization channel.

The D-user 1010a may also be configured to monitor user traffic, via a Traffic Monitoring Function, and gather user information, such as the traffic type and the traffic destination. A D-User may also be configured to open or de-encapsulate user data packets going through the D-User, for example via a Data Processing Function 1020, and may obtain a specific type of data, if the user allows it, i.e., if Privacy Policies have been configured accordingly. In addition, the D-User may be configured to monitor and control home equipment, for example via a Data Controlling Function, and the related data may be collected by the D-User. Data associated with home equipment may comprise home appliance usage, health information on the user, etc. In order for the D-User to have access to specific types of data transiting therethrough, a user may need to configure or provide the D-User with privacy policies indicating different privacy preserving levels for the different types of data which are needed by the D-User to take an action when sharing data.

The following paragraphs comprise a brief description of data exchange scenarios and associated data types.

6.16.1. Scenario 1: Contents of interest to be shared for pre-fetching content or content downloading

The following paragraphs describe how a D-User may facilitate updates of content interest list, based on time, priority, situation, probability, the best location to push data, etc., with the Content Providers so that Content Providers can pre-push data to a predefined location or to a D-User cache location. There can be different types or categories of content interests to be considered when a user is sharing his/her interests with 3^{rd} parties, via their User Equipment:

There may be at least three types of content which are downloaded from 3^{rd} parties that may need to be stored in the D-User storage.

### 6.16.1.1. Scenario 1a

1a. First, content interests may be gathered, classified and stored before being shared. Example classifications may include:

Authorized access category: Content providers need user agreement/authorization for payment, non-disclosure, etc. (e.g. payment after delivery to D-User or delivery to the end user/device).

Public Access Category: Content providers do not need such authorization. Contents with the providers can be accessed to public freely (e.g., search information)

Restricted content interests: Content interests that can be shared only with certain content providers who has a Prior Agreement with the user. D-User has a personal content interest lists which could be accessed by a limited number of data providers with some access codes.

### 6.16.1.2. Scenario 1b

1b. Secondly, content may be downloaded and stored inside the D-User or elsewhere, until the content is sent to the user or fetched by the user.

### 6.16.1.3. Scenario 1c

1c. Thirdly, content may be directly obtained with a query to be used by the user in a later time and that may be stored in the D-User.

6.16.2. Scenario 2: Data to be shared with 3^{rd} parties or uploaded to 3^{rd} parties

### Scenario 2a:

A D-User may be configured to selectively share personal data anonymously, including for example user data, user device data, home information, to 3rd party data consumers for the 3^{rd} party usage. For example, this data may include home or environmental sensor information, such as energy consumption, temperature, humidity, which may be useful or benefit a Data Consumer. Direct (e.g. payments) or indirect benefits (e.g., global weather information, road obstacles, etc.) may be provided in return to the user. The following is a brief description of the procedure, according to a possible embodiment.

Referring to FIG. 10, as a first possible step, a user, via a User Equipment 1008, may send data to a D-User 1010a, or D-User module, associated therewith. The data may be prefiltered at the User Equipment, based on the type of data. For example, data associated with specific applications may not be sent, or a specific type of data, such as photos or video files.

Then, the D-user may provide or transfer the data to a Privacy Preserving Portal (PPP) 1030. The D-User may also provide Privacy Policies associated with the D-User or with the data, so that corresponding data processing may be applied prior to sending the data to Data Consumers. Data Consumers may correspond to entities and their networks/servers that collect and use data from other systems and/or end users and that store, maintain and analyze the data, for example to establish trends, to monetize the data, for marketing campaigns, etc. Data Consumers may include Network Operators and/or External third (3^{rd}) parties, including for example entities providing services through their infrastructure, such as Social Networking applications, Streaming applications, Over the Top (OTT) applications.

Based on indications in the Privacy Policies, the PPP may change the ID associated with the data, including replacing any user identifier, such as IP addresses and the likes, and may then send the data to the Data Consumer or the SDP. If necessary, the data may be sent through a Full Homomorphic Encryption (FHE) module to encrypt communications.

In possible embodiments, an analytical unit or module may analyze the data inside the HN and use the data for the HN objectives such as user mobility information for service improvement.

### Scenario 2b

In possible embodiments, the data may be stored on the User Equipment, for example when the User Equipment is offline/not connected to the network. The data may be uploaded when specific conditions are met, such as when a high-speed link is available.

### Scenario 2c

In possible embodiments, the D-User 1010a may obtain data analytic services from 3rd parties, including from the wireless network preserving privacy and external service providers. The D-User may perform joint analytics with 3^{rd} party analytical services, including with the Hosting Network (HN), also referred to as Host Network. This may also include other direct interaction services with 3^{rd} parties, such as accessing servers and web sites. However, user data may be passed in this process and methods to preserve privacy may be needed.

### 6.17 Creation of the D-User and Steps Carried to Establish the Data Sharing Service

In order to provide such data sharing services as indicated in above Scenarios 2a, 2b and 2c, a network operator may carry out the following steps. Some of the following steps may be omitted or performed in a different order:

Determine, by a function of the Hosting Network, privacy requirements needed for the user, for example from a preset list of requirements, for different applications and different data types. A specific function of the Hosting Network may make this determination.

Selecting, by a function of the Hosting Network, a type of D-User platform and create/install the D-User platform, for example in an isolated container based on the privacy requirements determined by the Hosting Network.

Creating, by a function of the Hosting Network, the D-User by instantiating the required functions inside the D-User platform, referred to as a Hosting Platform, or HOP. In possible embodiments, a generic D-user may be selected, comprising additional functions to provide D-User services other than the data sharing service discussed in the present application. In general, the additional D-User services are called User Controlled and Managed (UCM) services because the D-User can be used to manage and control any service a user has obtained from the Hosting Network (HN) or from 3^{rd} party servers using the network. (Data sharing can be considered as one of the UCM services).

For example, the UCM services may include, analyzing and processing user data, providing a computing platform to run user applications, providing AI services to the user, home control, financial and health control, handling data sharing with the 3^{rd} parties, processing user data, acting on behalf of the user, obtaining content from the 3rd party content providers, interacting with the network to obtain a better communication service, interacting with the network to obtain network data, facilitating the interactions with 3^{rd} party servers such as user accessing application servers and making payment and receiving payments.

Establishing, by a function of the Hosting Network, the Data Sharing Service by instantiating associated Data Sharing Service functions inside the D-User platform or/and the Hosting Network and configuring them accordingly.

In possible embodiments, Data Sharing from the User (or User Equipment) and the D-User is continuously or regularly performed, i.e. the process can run as a continuing process. In other words, data may be provided to the D-User and updated regularly. The D-User may also transfer the data to the Shared Data Portal (SDP) after having processed/treated the data for 3rd party use, based on Privacy Policies. A brief description is provided below of the functions involved in this process. A more detailed description is provided later in this document.

### 6.18 Functions Involved in Providing the Data Sharing Service

Still referring to FIG. 10, once a Data Sharing Service is established, the Data Synchronization Function 1012 may receive data from the User Equipment 1008 on a regular basis and may update the data. The data sent by the User Equipment 1008 may be filtered through a local Privacy Preservation Portal, e.g. PPP1. The local Privacy Preservation Portal (PPP1) may filter the data such that a subset of the data on the User Equipment, such as restricted data, may not be transferred out of the User Equipment 1008, if indicated or tagged with a local Privacy Preservation Level (local PPL). The data that is transferred from the User Equipment 1008 and received at the D-User 1010a may be processed by the D-user using Data Processing Function to check the quality of the data compared to the available data, in terms of the timeliness and accuracy, as examples only. In the update process, the usability and the quality of the data may be verified. For example, some factors such as timeliness, accuracy, consistency (e.g. data format), redundancy/duplication, safety and security, navigation possibility, completeness, validity may be checked and the data may be cleaned, if necessary.

The data may be classified according to an importance thereof, and according to privacy requirements provided by the user, for each classified data. In some embodiments, classification classes may be provided to the user during data synchronization. The personal data can generally be classified as public, private, confidential and restricted. However, when the user ID is not disclosed, data may be classified differently since the user can only be identified indirectly by analysing data. Therefore, the data classification step done may be performed by an AI function or model, which may classify the data in relation to privacy preservation (PP) technique and indicate the type of PP technique which may need to be applied. The PP technique may be identified by or associated with a Privacy Preserving level (PPL). In possible embodiments, data units, or blocks of data, may be attributed a value during data processing based on the quality and the inputs taken from a market analysis, using a Data Market Valuation function 1022.

Finally, a Data Controlling Function may determine which data is to be sent to the PPP 1030 for sharing. The Data Controlling Function may also provide the PPL value associated with the data, or data block, to indicate the PP technique to be used. The Data Controlling Function may also provide the data valuation and a quality indicia as explained above. For example, data, or a data block being associated with a PPL value of 0 can be publicly shared without any PP action and can be made available even with the user ID. A PPL of 1 may indicate that the user ID (i.e. any information that can be used to identify the user, such as names, logins, IP addresses, etc.) may be changed to hide the user identity from 3^{rd} parties is sufficient (Hosting Network may know the ID). A PPL of 2 may indicate that the ID may be changed so as to hide the user identity even from the Hosting Network. A PPL value of 3 may indicate that a data hiding technique, such as FHE, is to be used.

Thus, in possible embodiments, the header of the data packet can indicate:

At least one of: a Data Classification, a Data valuation or value indication, a quality indication, a PPL, a list of authorised consumers (if restricted usage), additional policy indications, response location and information related to receiving applicable payment.

A response location for the Sharable Data Portal (SDP) 1040 to communicate with the data owner (e.g. D-User). The response location, such as an IP address, may be a location inside the PPP. When a message is received from the SDP in relation to a shared data unit, the PPP may have access to the response location address and may provide the response location address to the D-User.

D-user policies related to negotiation of payments and privacy related issues may be determined based on user policies obtained from the user, based on the available PPL techniques and based on the SDP categorization classes which have been established beforehand.

Information or indications to the PPP to perform an ID change using an ID management function. Encryption may be applied by the PPP using FHE and the PPP can send the encrypted data to the SDP.

External servers 1050, including for example servers waiting for uplink transmission, i.e. in a Packet Data Unit (PDU) session, 3^{rd} party AI engines, and AI engines for joint analysis, i.e. for a slice provider, may access the data after checking/verifying the SDP data categories and whether payment needs to be made to the Hosting Network operator. Network Operator may in turn make an appropriate payment to the user.

The Sharable Data Portal may need to implement a data classification, which may be done according to standard classification categories, so that the Data Consumers can quickly search and find the available data in each category. Categories, or category types, can be kept in a data repository to maintain category types. The category types may be updated from time to time, based on the value of each category, or when fine tuning is needed based on market valuations, cost analysis, and policies. A Negotiation Function can be provided to negotiate with the Data Consumers as well as the Data Providers (i.e. D-Users). Although actual users are hidden from The Hosting Network, the SDP can interact with the users, via the D-User, using a temporary ID or the response location provided by the PPP, so that the PPP can provide those messages to the appropriate D-User.

A high-level description of the above is provided in the following subsections.

### 6.19 Functional Description of Main Components

Once a D-User module is instantiated, in order to establish content prefetching UCM service, the following functions may be performed.

### 6.19.1 Privacy Preserving Portals (PPP) and Access Control:

Since a D-User may be deployed inside the hosting network, the privacy of the associated UE can be leaked to the hosting network, and similarly the hosting network information may be leaked to the UE. Therefore, it is proposed that several PPP functions may be used, each having different objectives as indicated below.

Preserving UE privacy without exposing to the host or to DN:

One of the PPP functions may be to preserve the UE data, such as contents of interest being exposed to a non-trusted host. This function may be provided inside the D-User module or in a secured protected location outside HOP such that all the user queries, interests and other data may be shared only through this PPP. This PPP may include the following 3 core modules:

Data Portal: to provide the data processing including: Data Collecting, Data Distribution, Policy Application

Crypto Suite (Crypto Suite module): to provide fundamental privacy and security functionalities, including
FHE (Full Homomorphic Encryption) module which helps to achieve the privacy preserving query and other operations, and to encrypt payment-related communications;
IDM (Identity Management) which may generate and manage the Pseudo-ID which represents the D-User information, for payment-related communications.

Policy Engine: to provide the updated access policy from the User and interacts with the Crypto Suite module and Data Portal to reflect the dynamics of the User. The Policy Engine provides updated access policies from User Equipment and control communications of the Cryptocurrency Suite module and of the Data Portal according to the updated access policies.

Location of PPP: The PPP may reside inside the D-User or the multi-D-User platform where the D-User is located. The PPP may also reside inside the hosting network as a common PPP for all the UEs, in which case the PPP may reside inside another TEE secure platform for any D-User to use.

Limiting access of the hosting network function access to the D-User functions: The Hosting Network may access the D-User via a control plane controlled by an access control function inside D-User module.

Preventing the hosting network from accessing information of D-User/UE activities during communication establishment may be performed by:

Configuring the UE and D-User link and the D-User and DN link such that they are encrypted end-to-end.

Establishing Quality of Service (QoS) for communications without leaking the application information. For example, various QoS levels and performance monitoring etc. may be established with a D-User assigned for each channel. The D-User may then request only the QoS levels of various streams rather than the application requirements.

The PPP may be configured to prevent leaking unnecessary network information to the D-User and the associated UE: For some UCM services, the hosting network may expose the network information to the D-User. Consequently, access to network information may be controlled by another PPP instantiated in the hosting network in the control plane. For example, the network topology may be indicated in an abstracted form. It is also possible that the function inside D-User which obtained information may be prevented from providing that information to other the UE by interface control.

### 6.19.2 Authentication Related Functions

A Sync Function may be provided for the D-User to authenticate the associated UE and vice versa, for allowing communications between the D-User and the UE to be transparent to the hosting network. This Sync function may be created by the D-User manager or in some cases by the hosting network. The secure communication may be facilitated by a core network control plane function first by establishing a connection (e.g. sync channel) between the UE's authentication function and D-User-M, and secondly, keys to may be established with the facilitation of the core network function since core network has the UE identification methods (e.g. a secure key associated to a user ID).

These functions are summarized below.

AI related functionality may include:

Coordination with the UE to analyze user interest profile, e.g., immediate user interests, user interests predicted in different times user interests in user's or network context, priority of interests.

Determination of which content interests may be shared and what will be restricted to a selected, providers, what may be obtained anonymously.

Prediction of user mobility and the situation/context to prioritize the content interest list

Analysis of the best location for the content to be pre-fetched/pre-pushed which is based on network information and user context.

Determination of how to share user data (e.g. user, network, environmental) with 3rd or external parties.

Coordination with 3rd party AI engines on-behalf of the user. A D-User may be provided with functionalities for representing a UE to carry out UE operations when using the network. The functionalities may include:
A functionality to coordinate with the UE to obtain selected content interests considering user information as well as the D-User information (e.g. on mobility)—only the required data for the D-User from the UE and keep updating it continuously
A functionality to assess UE⇔D-User link quality as well as D-User to current data network server link quality or the potential server quality
A functionality to assess network information received from the network, which contains one or more of network congestion or service cost;
A functionality to handle user authorization for obtaining services from 3^{rd} parties (e.g. servers)
A functionality to learn user environment and user context
A functionality to keep historical analysis of user mobility, user interests, etc.

Functionalities for historical learning through monitoring user behaviours, e.g. monitoring queries, user activities etc.

### 6.20. Privacy Issues Solved Using D-User and a Hosting Platform (HOP)

Digital Entities, such as D-User modules, may be isolated from the hosting network depending on the trust level the hosting operator would like to offer. For example, there may be a need to prevent the hosting network from accessing the digital entity data. In addition, a DE, such as a D-User, may need to be isolated from external networks accessed by the user. Furthermore, the user may need protection from malicious attacks to prevent the hosting network from accessing private user data.

Depending on isolation requirements, different solutions may be implemented. The complexity and/or cost of providing privacy to a D-User may depend on the level of trust the host is willing to provide. For example, a hosting network may offer trust levels such as those described below.

The hosting network can provide services as a trustworthy party to the user or as an untrustworthy party. Table 1 provides examples of privacy preserving levels a user may require for different types of UCM services. In order to meet those requirements, a D-User may need to be instantiated inside a separate network module which can be referred to as a ‘Hosting Platform’ (HOP).

The HOP is preferably isolated from the hosting network and the required level of isolation depends on both the trustworthiness of the hosting network and the type of UCM services the D-User is providing to the P-User. In addition, the HOP may help the user preserve privacy when accessing external servers. These cases are summarized in Table 1.

In Table 1, a trusted network (T) means that a user needs to trust the network which provides the particular service/capability to the user. On the other hand, an untrusted network (U) means the user can obtain services from the network while preserving privacy, without leaking user information to the network providing the service. Preserving privacy of the real entity by the network may be performed by 1) preventing visibility of real entity and/or DE data, 2) preventing visibility of processing of the real entity data and/or DE data or by preventing visibility of execution of specific functions of the real entity from any other entity using the Hosting Network or from any other external networks.

TABLE 1
Example levels of privacy that can be provided by the network for UCM services

| | | | | | Exposure to | | | | |
|---|---|---|---|---|---|---|---|---|---|
| | Exposure to hosting | | | | External data | | | | |
| | network & | | | | Network (e.g. | | | | |
| | Trustworthiness (T/U) | | | | Server) & | | | | |
| | | | C/M | | Trustworthiness | | | | |
| Use | | Data + | Operation/ | Destination | | | User | D-User capability/ | Requirement/ |
| case | T/U | Processing | Action | Address | T/U | Data | ID | UCM service | Solution |
| 0 | U | No, | Yes | Yes | T | Yes | Yes | Network provides | Current system. |
| | | Encrypted | | | | | | transport service. | No privacy |
| | | | | | | | | | solution other |
| | | | | | | | | | than UE |
| | | | | | | | | | filtering. |
| 1 | T | No, | Yes | Yes | U | Yes | No | Can access 3^{rd} | ID change by the |
| | | Encrypted | | | | | | party servers | host. |
| | | | | | | | | anonymously. | |
| 2 | T | Yes | Yes | Yes | U | FHE | No | User data can be | ID change and |
| | | (DPF) | | | | | | processed inside | data de- |
| | | | | | | | | the network (data | privatized by |
| | | | | | | | | accessible to host) | host. |
| | | | | | | | | as needed by the | Data processing |
| | | | | | | | | user. | done by host. |
| | | | | | | | | USER ID change | |
| | | | | | | | | and data de- | |
| | | | | | | | | privatized by host. | |
| 3 | U | No | Yes | Yes | U | FHE | No | D-User can process | User data is not |
| | | | | | | | | data. Host does not | accessible to |
| | | | | | | | | have access to user | host. |
| | | | | | | | | data. | |
| 4 | U | No | Yes | No | U | FHE | No | Can access 3^{rd} | HOP to have a |
| | | | | | | | | party servers | minimum |
| | | | | | | | | anonymously and | number of D- |
| | | | | | | | | without the host | Users (multi-D- |
| | | | | | | | | knowing which | User platform). |
| | | | | | | | | user accessed the | HOP changes |
| | | | | | | | | 3^{rd} party server. | the USER-ID. |
| 5 | U | No | No | No | U | FHE | No | Same as above. | The operations |
| | | | | | | | | Host does not | inside the HOP |
| | | | | | | | | know the | are controlled by |
| | | | | | | | | operations a user is | the user and the |
| | | | | | | | | taking inside D- | hosing network |
| | | | | | | | | User. | is unaware of |
| | | | | | | | | | them. |

As shown in the above table, the following one or more following techniques may be used to preserve privacy: (1) keeping the HOP in an enclave; (2) having the HOP configured to carry out ID changes; (3) creating the HOP in an enclave and instantiating a minimum number of D-Users in the HOP, to perform ID changes anonymously relative to the hosting network; (4) having the HOP configured to perform data de-privatization, e.g., using FHE.

This application provides methods to share data with 3^{rd} parties (such as external servers), while preserving privacy of the end users. The solution is provided for both trustworthy networks and untrustworthy networks.

### 6.21. HOP Requirements and Solutions/Use Cases

The HOP requirements and solutions for the cases indicated in Table 1 are described below.

6.21.1. Current Model (No D-User, No Privacy from 3rd Parties)

Current mobile networks act like transport systems for the user to access the external data networks/servers. Data may be encrypted end-to-end so only the user device and the application server have access to data and control of data. A user can filter the data they share with the 3^{rd} parties but, depending on the service they obtain, they might have to provide, for example, information about their identities and other valuable information. In addition, in current mobile networks, a user may not have any control or management over the services the user obtains from the network (i.e., no UCM service can be operated).

### 6.21.2. Use Case 1: Provide Anonymous Access to 3^{rd} Party Servers (Service Providing Network May Need to be Trusted)

In a possible embodiment, the mobile network may hide the entity identity (ID change) so that users may access external servers anonymously. The network is trusted to keep access sites/server descriptions, other than for police tracking events. In this case, the HN is trustable by the entity associated with the corresponding DE.

Requirement: An external server should not be aware of which digital entity has accessed it.

Solution: The hosting network may perform an ID management function (IDMF) to change the source ID and the return address of the digital entity hosted in a HOP. However, the hosting network may know what server the digital entity has accessed (privacy leaks to the hosting network). The hosting network may include a Hosting Network Function (HNF) which facilitates access of the one or more DEs to access external servers anonymously by executing a IDentification Management Functions (IDMF), which change source identifiers (or source ID)s and/or response addresses associated with the one or more DEs. For example, the source ID and response addresses may correspond to IP addresses that could be used to trace back the identity of the Digital Entity, such as D-Users.

HOP requirement: The HOP may be an isolated network function module created using the infrastructure of the hosting network.

6.21.3. Use Case 2: Network Aware in-Network Processing (D-User Exposed to the Trusted Network)

In a possible embodiment, processing data inside the hosting network may enable many services for an entity, such as AI services or service optimization solutions. The hosting network may provide the services but there is a risk of data and processing details being exposed to the hosting network.

Requirement: The Hosting Network may provide a data processing function (DPF) for the entity.

Solution: The host may provide a DPF for the entity. For example, one HNF of the hosting network may process the DE data (i.e. D-XX data, such as D-User data) inside the HOP by performing Data Processing Functions (DPF) inside the HOP. In this case, DE data (payload) is exposed to the hosting network but protected from external entities. The hosting network can additionally provide entity ID change similar to case 1, to protect the entity identity from 3^{rd} parties, but the hosting network may be aware of both the external server address and the payload.

HOP requirement: The HOP may be an isolated network function module created using the infrastructure of the hosting network.

6.21.4. Use Case 3: Network Unaware in-Network Data Processing (D-User Isolated from the Untrustworthy Hosting Network)

Unlike in case 2, DE data can be processed inside the hosting network without exposing DE data to the hosting network. Anonymous access to external/3rd party servers can be provided additionally as in case 1. However, the hosting network may be aware of the external server address).

Requirement: The Hosting Network may need to provide an isolated data processing function (DPF) inside the hosting network to the entity and ID change function to access external servers anonymously.

Solution: The Hosting Network may provide a DPF or a Digital Entity, such as a D-User, inside an isolated enclave.

HOP requirement: The HOP may be an isolated enclave in a confidential computing environment (CEE). A HPF of the Hosting Network (HN) may prevent the HN from accessing the DE data by having the container in which the HOP is instantiated provided in a Trusted Executive Environment (TEE), corresponding to a confidential computing environment (CEE) located inside the HN. The container may thus be isolated from the operating systems (OS) of the HN. The HPF may thus prevent the HN from accessing the data of the digital entity (DE data) when the DE (or D-XX) processes data inside the HOP or when the DE (or D-XX) shares DE data (or D-XX data) with other entities external to the HN.

6.21.5. Use Case 4: Access to 3^{rd} Parties Anonymously (Network Unaware)—D-User Isolated from Untrustworthy Hosting Network)

Anonymous access to external/3rd party servers without exposing external server address to the hosting network. In addition, host-unaware in-network data processing can be done similar to case 3.

Requirement: The Hosting Network may need to provide an isolated IDMF (not accessible to the hosting network) inside the hosting network to the entity.

Solution: The Hosting Network may provide an IDMF inside an isolated enclave. However, in order to carry out ID changes without knowledge of the hosting network, a minimum number of digital entities should be hosted in the isolated enclave, e.g. Multi-D-User platform. In addition, the hosting network can do in-network processing inside the enclave as in Case 3.

HOP requirement: The HOP may be an isolated enclave in a confidential computing environment (CEE) which can create at least K number of Digital Entities as the K-anonymous requirement described in L. Sweeney. “k-anonymity: a model for protecting privacy”. International Journal on Uncertainty, Fuzziness and Knowledge-based Systems, 10 (5), 2002; 557-570 which is hereby incorporated by reference in its entirety. In such embodiments, the HOP may have a minimum number of DE. For example, the K-anonymity model requirements proposed can be used to anonymize user communications to/from DNs (i.e., hosting network cannot know which user inside the HOP communicated with the DN). The K-Anonymity requirement can be summarised as “for every combination of identifying attributes in a dataset, there are at least “K minus 1” other people with the same attributes”. Therefore, the source ID may be changed with a randomized ID and also the return address may be randomized with a randomized location.

### 6.21.6. Use Case 5: Network Unaware Operations by the D-User

This case is similar to use case 4, but additionally, the hosting network is not aware of the type of operations the digital entity performs for its services (i.e. the services obtained by the entity are hidden to the hosting network).

Requirement: The Hosting Network may need to provide an isolated data processing function (DPF), an isolated IDMF and entire user service functions inside the HOP.

Solution: In addition to above case 4, Digital Entity (such as D-User) related functions are completely placed inside a multi-DE platform, e.g. a separate slice of the network is provided for the multi-entity hosting platform. A slice may refer to a logical network segment that is dynamically created to cater to specific service requirements, traffic types, or user groups within the broader physical network infrastructure. Once the HOP is created, the HOP may be given the capability of independent operation. For this purpose, when the HOP is created, a HOP manager function (HOP-M) may be created inside the HOP which can do the LCM DE (e.g. creation, modification and termination of Digital Entities) and common functions needed for the interaction of the DE functions with entities outside the DE (e.g. other platforms inside the HOP, hosting network functions, P-User and P-User devices, 3^{rd} party servers), privacy preserving functions when a D-User communicating with external entities.

HOP requirement: The HOP may be provided as an isolated enclave in a confidential computing environment.

### 6.22. Summary of Use Cases 1 to 5

In above use case 1 and use case 2, the hosting network can provide the UCM services described but the entity privacy is leaked to the hosting network. For example, an exposed D-User, e.g., using an infrastructure managed and controlled by the hosting network, can be used for these services.

In use cases 3, 4, and 5, different UCM services may be provided by using a DE installed inside the hosting network without entity functions or entity data being exposed to the network according to the privacy requirements for those cases.

Therefore, there may be at least two options for a network operator to provide services to digital entities.

### 6.22.1. Hosting Network Provides D-User Services as a Trustworthy Entity (Cases 1 and 2):

In this case, only the entities (such as users) who can trust the hosting network would be interested in obtaining a service which limits the hosting network's ability to serve the general public. The hosting network may not need to provide strict isolation from the hosting network although it may have to provide full protection to the DE data (such as D-User data) and DE operations (such as D-User operations) from exposing them to external entities (e.g. data consumers, servers, etc.) who interact with the DE or entity. In addition, Digital Entities, such as D-User/D-User module, need to be isolated from each other to protect their privacy. Furthermore, access to functions inside the HOP may be access-controlled using a GW in the C/M plane and a GW in the DP plane. The hosting network may use its own infrastructure to create an isolated software container (a HOP) for the DE and the hosting network may not need to provide a TEE like hardware isolation since hosting network is trustworthy. A container may consist of a standard unit of software that packages up code and all its dependencies.

6.22.2. Host Provides D-User Services as an Untrustworthy Network where Users do not have to Trust the Hosting Network (Cases 3, 4, and 5):

In this case, the hosting network may have to perform additional actions to isolate the DE from hosting network in which the HOP is provided. Therefore, the HOP may need to be created inside a confidential computing environment created inside the hosting network such as a TEE, and be preconfigured to be able to create the necessary functions inside the HOP and interact with the entities requiring DE services. In this case, hardware portion of the HOP may be created with a platform manager inside the HOP which may be able to create the other functions and the required interfaces for those functions.

In both cases, the D-User modules should be isolated from each other and also privacy preserving techniques need to be established when accessing the external servers. Isolation from the hosting network may be required for the cases 3, 4 and 5.

### 6.23. D-User Types and UCM Service (UCMS) Types

As mentioned before, there may be numerous UCM service types a D-User can use. Depending on the UCM services a D-User may be supporting, the composition (or elements) of a D-User can be different from other D-Users. Thus, it may be desirable that D-Users be classified according to the types of UCMS services they can support. Note that a UCM service is a service a user receives to control or manage its services or the network entities providing the service. A D-User module may comprise one or more functions that may be needed for UCM service provisioning.

D-Users (i.e. D-User modules) needing a UCM feature may subscribe to the associated D-User type or to a UCM service. Not all users need user empowerment and therefore, a D-User may be provided as an add-on feature to a user, as needed. When a user requires a feature, the user may make a request to the hosting network which is forwarded to a D-User creation function of the hosting network.

The type of D-Users or types of UCM services may be standardized for the UE to request the required service. An MNO may provide the D-User facilities based on its view on creating these functions and associated privacy preserving methods, costs and available facilities.

The UCMS services may be grouped such that they can be supported by a common set of functions or common network topology.

Table 2 indicates an example categorization of D-User types and associated UCM services based on the basic functions that is needed for a D-User.

TABLE 2
Example D-User type categorization based on common functional requirements

| | | UCMS services | |
|---|---|---|---|
| | | that can be | |
| D | Basic UCM services | provided with | |
| User_TypeID | (UCMS) supported | minor additions | Comments |
| Type 0 | User can create any | Any UCMS service | |
| (Basic D-User) | UCMS services by | | |
| | adding functionality | | |
| Type 1 | UCMS 2: authentication | UCM S3: Making or | Need key exchange |
| | of user for service | receiving payments | with core network |
| | access, authorization for | to/from 3^{rd} party | functions and CA. |
| | using personal data, | preserving privacy | Need UE home |
| | payments. | | equipment controlling |
| | UCMS 1: Home | | functions and storage? |
| | network, equipment, | | |
| | health and alarm | | |
| | control | | |
| Type 2 | UCMS 4: Capability to | UCMS 6: controlling | D-User need access to |
| | dynamically obtain | UE traffic routing | RAN and request |
| | special network features | within the network | resources/features |
| | for its dynamic needs | UPFs. | (dynamic CPF |
| | (e.g. low power | UCM 7: obtaining | interaction with 3GPP |
| | channels, diversity). | service quality maps | at L2/L1). No UPF. |
| | USMS 5: Capability to | | Need resource control |
| | define special services | | for UCMS3. |
| | (e.g. QoS guarantee over | | |
| | a specific route, multiple | | |
| | channels) | | |
| Type 3 | UCMS 8: Ad/Spam | UCMS 9: TCSP | Application-level |
| | Blocking | acceleration with a | protocol stack at D- |
| | UCMS 11: Source | proxy | User. |
| | address, ID change for | UCMS 10: local data | Need CPFs and UPFs |
| | privacy | cashing and pre- | and data processing. |
| | UCMS 12: sharing | fetching | |
| | content interests. | UCMS 15: Sharing | |
| | UCMS 14: processing | data | |
| | specific user traffic | | |
| | UCMS 16: support for | | |
| | UE's Net4AI | | |
| | applications | | |
| Type 4 | UCMS 17: Obtain own | | Need RAN capability |
| | network | | info and resource |
| | resources/services | | control |
| | (slices, tunnels, multiple | | |
| | AP RBS/frequencies) | | |
| Type 5 | UCMS 18: D-User AI | | Joint network |
| | interaction with UE and | | optimization |
| | network AI to optimize | | capability |
| | network and UE | | |
| | services | | |
| Type 6 | UCMS 19: obtain service | USCM 20: | Interacting with |
| | from neighbour UEs | supporting network | neighbouring UEs |
| | and vice versa (e.g. | for XaaS services | infrastructures, |
| | relaying, D2D) | | providing services. |

As per the example shown in Table 1, certain UCMS types may not need UPFs inside the D-User for special processing and the type D-User is simple, that is, it contains only basis functions. In this case too, there is no exposure of raw data (e.g. D-User Types 2, 3, 4, 7). In addition, there are certain UCMS services which do not need network exposure information which also reduces the complexity (e.g., D-User types 1, 4). Another D-User categorization may be that certain UCMS types do not need the exposure of user information to the network which relax the privacy requirements (Type 1).

The following is a further description of this example D-User categorization.

6.23.1. D-User Type 0: Basic/Default D-User which is Able to Establish New UCM Services

In some embodiments an HNO may decide to establish a basic or default D-User module which may later be extended to provide any UCM services or any D-User type that a user requires. Creation of a basic or default D-User may enable the network or user to create UCM service on demand basis. Therefore, any other D-User type may be considered as a basic D-User modified by adding functions to support specific UCMS services. For this purpose, a basic D-User may have a logical control link established between the UE and the D-User. The D-User may have one or more functions to create additional functions required for a UCM service when requested by the user or a network function. The one or more functions may include functions to trigger the creation of a D-User from a network function orchestration function or an equivalent management function.

### 6.23.2. D-User Type 1: D-User Having Only CPFs and Storage, and No Need for Network Exposure

This may be the simplest D-User which may only have control plane functions and no user plane functions. It may need a storage to keep information related to the user, e.g. use context. It may have one or more control plane functions. The one or more control plane functions may include a function to communicate with the user, for example to obtain user requirements. It may also include function to communicate with the control plane functions of the hosting network. Additionally, it may have a function to control the UPF functions which depends on the type of the UCM service the D-User intended to provide. The following are some of the UCM services this type of a D-User may provide.

D-User taking decisions for home equipment, personal health and trigger alarms to Personal User Device (PUD) or external home/health control systems, including:

Authenticating and authorizing on behalf of user when interacting with 3rd party entities

Making payments or receiving payments to/from 3^{rd} party entities without providing identification to them and without allowing the financial institute the receiver or provider of the payment.

### 6.23.3. D-User Type 2: D-User Having Only CPFs and Storage and Use Network Exposed Features/Facilities (Type 2):

This D-User type, in addition to having CPFs, may be provided with capabilities to obtain certain type of network information, such as specific facilities provided to UEs, e.g. specific processing or traffic routing control, priority control or apply special technical features of the MNO (RAN/CN), topology or traffic monitoring such as loading situations and costs in dynamic costing situations. This D-User may perform the following:
Request special network features dynamically by the UE for its dynamic needs (e.g. low power channels);
Define special services/flows for efficient communications
Specific QoS for multipath diversity combining for UL/DL
Rate QoS guarantee for a UE moving path
A specific service consists of a combination of flows with specific QoS requirement
Controlling its own traffic routing inside MNO; and
Obtain geographical areas with good service quality (map)—knowing UE can move to move good locations/routes.

### 6.23.4. D-User Type 3: D-User Having UPFs for User Traffic Handling and Controlling User Data

This D-User type may allow a user to process its traffic according to its own processing functions. It may also allow the user to do data processing without the network being aware, or carry out network communications with DNs, without visibility by the hosting network. The following are some example UCM services. This D-User may perform the following:
Work as a middle entity to block ads (also reduce the air interface bandwidth);
Work as a proxy to do app/TCSP acceleration. The capability to provide user dependent QoS requirements for a given application by adjusting the user QoS and monitoring the service quality experienced by the user;
Local data caching and pre-fetching;
Privacy preservation when querying or accessing 3rd party services with a different user ID;
Sharing contents interest for pre-fetching;
D-User receive data (e.g. voice recording) when user is offline;
Processing specific types of traffic (transparent to the network);
Sharing user data with 3^{rd} parties and network; and
Analyzing user data (e.g. Net4AI) and running user applications.
   6.23.5. D-User Type 4: D-User has its Own Resources Obtained from the Network which can be Controlled or Managed by D-User:

The resources, such as certain network segments (RAN or CN parts), network slices, transport bearers, AP resource blocks, APs, reflective intelligent surfaces (RISs) etc. may be obtained exclusively for a user and use it for its own traffic.

6.23.6. D-User Type 5: D-User Capable of Joint Network Optimization by Communication with MNO

Under this type of D-User, a user may support the network services and vice versa by, for example helping joint optimizations or supporting network services as indicated below:
D-User AI interaction for joint design providing predicted user information (e.g. mobility prediction for resources and tracking area, per UE based UE idling time, use switch off or turned volume down)

### 6.23.7. D-User Type 6: D-User Capable of Supporting Network Services

Under this type of D-User, a user may support the network services and vice versa by, for example helping joint optimizations or supporting services as indicated below:
D-User may ask UE to facilitate network traffic to UEs neighbours or vice versa (knowing neighbours from the network);
D-User may support network to deliver non-connectivity XaaS services, (AI services. Video/weather sensing data from D-User).

### 6.24. HOP Placement

In possible embodiments, the hosting platform (HOP) can be placed inside a mobile network (MN), e.g. Radio Access Network (RAN), Multi-Access Edge Computing (MEC) network, or Core Network (CN), or it may be placed in any type of data network.

Keeping the HOP inside the mobile network (MN) may have many advantages compared to keeping it in a data network because:
Keeping the HOP closer to the user reduces the delay between the entities and their digital twin/digital entity;
All communications of a mobile go through the wireless network and therefore the wireless network is in a better position to provide services to digital entities. In contrast, a user has many options to choose a host in the data network and the communications with other data networks would not go through the selected host and selected host cannot provide all the services that a wireless network could provide;
When the host is located in a data network, the user might not have much visibility of the methods used by the hosting network for preserving privacy because a host in the cloud may not be trustworthy as a network provider providing the mobile access to the user.

The general approach to the creation of a hosting platform and generic hosting platform architecture is described below.

### 6.25. Generic HOP High Level Architecture

A high-level architecture of a generic hosting platform is provided. Some of the HOP Network Functions (HPFs) may include:
C/M plane functions which may be split into the following functionalities:
C/M gateway which may control access to (Access control, security and isolation) all the incoming and outgoing messages of internal C/M functions
C/M plane privacy preserving portal (PPP) which may be included in C/M GW
HOP manager function (HMF)
HOP's internal function orchestrator (HFO)
Common C/M network functions (NFs) supporting D-User module operations.

DP functions may be also split into a common database, PPP and other DP NFs to support D-User module operations.

More details of these functions are provided in this document.

In addition to D-Users, the HOP can also have functional modules (i.e. D-XX) for other digital representations of real objects such as infrastructure (D-Inf) or organizations. The HOP C/M functions such as platform manager and function orchestrator are for the coordination of the D-Users and other modules. Similarly, there could be common DP processing functions and data storages. Each D-XX functional module may have its own specific functions for internal control, management and data processing which are isolated from the hosting platform via specific gateways (i.e., C/M GW or DP GW).

### 6.26. Hosting Platform Creation: Overview of D-User Creation and UCM Service Establishment

As mentioned above, in order to provide UCM services, Digital Entities that are for digitally replicating users, i.e., D-Users, may be created inside a hosting network with the required functionalities. D-User functionalities may be isolated based on the type of UCM services being used by the user. Therefore, a D-user may be created inside a container, as an isolated software module, inside a hosting network. A container is a standard unit of software that packages up code and the code dependencies so that applications may run quickly and reliably in the hosting platform (HOP).

Containers may run on the same OS as the OS used for the hosting network servers, which results in weak isolation from one container to the other, and also from relative to the hosting network. In this document the term ‘software container’ is used for such a container. There are additional protection methods to secure some of the functions of given digital entity from the other containers in the same hosting platform, but a software container may not be fully isolated from the hosting network.

An enclave may be a container which provides hardware isolation in terms of having a protected memory region that provides confidentiality for data and code execution. An enclave may be an instance of a Trusted Execution Environment (TEE) which is secured by hardware. Therefore, it is referred to as a hardware container in this document. An enclave can also be run on its own CPU separate from the CPUs used by the hosting network. An enclave can also be considered as a virtual machine (VM).

Therefore, a hosting platform (HOP) for a Digital Entity, for example a D-User, may be created using a software container or a hardware container (an enclave) based on the privacy level required by the entity.

A hosting platform (HOP) can be an exclusive platform for a single D-User, a platform for multiple D-Users (Multi-D-User Platform). This configuration of the HOP is also possible for any type of digital entity, i.e., a HOP can host a single DE or multiple DEs, depending on privacy requirements for the DE.

Software container: a Hosting Network Operator (HNO) may use its own infrastructure and may create an isolated software container for the platform. In this case, the internal function creator may not be inside the platform but platform manager can manage the NFs and associated resources using proper APIs. Without hardware isolation this might not be the preferred option by the users.

Enclave: HNO may an enclave such as a trusted executive environment (TEE) which is pre-configured to be able to create the necessary functions inside the platform and interact with the users. In this case this hardware platform may be a standard platform with a platform manager which is able to create the other functions and the required interfaces.

When HNO decides to provide D-User services the HNO may first create a HOP platform with a HOP manager which is capable of instantiation of the D-User portals when requested by the HNO CPFs or HNO's D-XX service manager (DSMF). HOP platform is created inside the HNO network but isolated from the network so that hosting network cannot access user data inside this platform.

Some HNOs may not use a common HOP such as a NET4DW or Multi-D-User platform to create D-Users and may create a platform exclusively for an individual D-User. Therefore, a hosting platform (HOP) can be an exclusive platform for a single D-User, a platform for multiple D-Users (Multi-D-User Platform) or NET4DW platform which can have D-User modules, D-Rep modules or any application server such as a digital world (DW). Note that if each D-user is created inside a separate enclave, a separate D-User manager (D-user-M) as described later in this document is not required and all the D-User-M function describes in this document may then be done by the HMF.

In order to support a multi-D-User platform or NE4DW platform additional layer of remote attestation may be necessary. First the host has access to the HOP and secondly when the HOP creates the D-XX module and connect it with the D-XX operator (in the case of D-User the user is the operator), D-XX operator should be able to do remote attestation in order to get confidence of the security of the D-XX module (that the host cannot access it because its code is provided by the vendor and vendor can verify it during remote attestation). In some embodiment, each D-XX module also provide an enclave in addition to the HOP being in an enclave.

When a Host Network Operator (HNO) decides to provide D-User services the HNO may first create a HOP platform with a HOP manager which is capable of instantiation of the D-User portals when requested by an HNO network function. Some HNOs may not use a common HOP such as a NET4DW or Multi-D-User platform to create D-Users and may create individual D-User platforms as and when needed. In this case, each D-User or D-XX module may have their own enclaves.

Accordingly, the UCM service establishment may require the following procedures:

A hosting platform creation which can establish D-User modules inside it and configure the D-Users.

Establishment of a D-User module (e.g. when requested by a user or any network function, or prepare several D-Users of different types beforehand and keep to provide whenever they are needed).

Establishment of particular UCM service capability

A brief description of these procedures is provided below.

Software container: The hosting network (HNO) may use its own infrastructure and may create an isolated software container for the platform (HOP). In this case, the internal function creator may not be inside the platform but the platform manager can manage the NFs and associated resources using proper APIs. Without hardware isolation, this may not be the preferred option by end users.

Enclave: the HNO may use an enclave such as a trusted executive environment (TEE) which is pre-configured to be able to create the necessary functions inside the platform (HOP) and interact with the users. In this case this hardware platform may be a standard platform with a platform manager which is able to create the other functions and the required interfaces.

When the HNO decides to provide D-User services, the HNO may first create a HOP platform with a HOP manager which is capable of instantiation of the D-User portals when requested by the HNO CPFs or HNO's D-XX service manager (DSMF). HOP platform is created inside the HNO network but isolated from the network so that hosting network cannot access user data inside this platform.

Some HNOs may not use a common HOP, such as a NET4DW or Multi-D-User platform, to create D-Users and may create a platform exclusively for an individual D-User. Therefore, a hosting platform (HOP) may be an exclusive platform for a single D-User, a platform for multiple D-Users (Multi-D-User Platform) or NET4DW platform which can have D-User modules, D-Rep modules or any application server such as a digital world (DW). Note that if each D-user is created inside a separate enclave, a separate D-User manager (D-user-M) as described later in this document may not be required and all the D-User-M function describes in this document may then be done by the HMF.

In order to support a multi-D-User platform or NE4DW platform, an additional layer of remote attestation may be necessary. First, the hosting network may have access to the HOP and secondly, when the HOP creates the D-XX module and connects it with the D-XX operator (in the case of D-User the user is the operator), the D-XX operator may be able to perform remote attestation in order to be confident in the security of the D-XX module (that the host cannot access it because its code is provided by the vendor and the vendor can verify it during remote attestation). In some embodiment, each D-XX module may also provide an enclave in addition to the HOP being in an enclave.

When a Host Network Operator (HNO) decides to provide D-User services, the HNO may first create a HOP platform with a HOP manager which is capable of instantiation of the D-User portals when requested by an HNO network function. Some HNOs may not use a common HOP such as a NET4DW or Multi-D-User platform to create D-Users and may create individual D-User platforms as and when needed. In this case, each D-User or D-XX module may have their own enclaves.

Accordingly, the UCM service establishment may require the following procedures:

A hosting platform creation which can establish D-User modules inside it and configure the D-Users.

Establishment of a D-User module (e.g. when requested by a user or any network function, or prepare several D-Users of different types beforehand and keep to provide whenever they are needed).

Establishment of particular UCM service capability

A brief description of these procedures is provided below.

### 6.27. The Hosting Platform Creation

When HNO decides to provide services to digital entities, such as D-User services to D-Users, the HNO may first create a HOP platform 800 provided with a HOP manager 834, which is capable instantiating DEs (D-XX), including for example D-User portals when requested by the HNO CPFs or the HNO's D-XX service manager (DSMF). HOP platform is created inside the HNO network but isolated from the network so that the hosting network cannot access the digital entity data inside this platform. It may be created in at least two ways.

One possibility is that an HNO uses its own infrastructure and creates an isolated software container for the hosting platform (HOP). In this case, the internal function creator may not be inside the hosting platform (HOP). The Platform Manager 834 can manage the HOP NFs and associated resources using APIs. Without hardware isolation, this option may not be the preferred option by operators or end-users of the digital entities.

Another possibility is that an HNO may use an enclave, such as a trusted executive environment (TEE), which is preconfigured to be able to create the necessary functions inside the hosting platform (HOP) and interact with the DE operators or end-users. In this case, this hardware hosting platform may be a standard platform with a Platform Manager 834 which is able to create the other functions and the required interfaces.

### 6.28. Creation of a D-User

Establishment of a D-User inside a HOP may be initiated either by a user, a network entity, a 3^{rd} party service provider, a 3^{rd} party D-Rep inside the HOP or another D-User of the same user.

Different HNO's may offer D-User and UCM services to users in different ways. In addition, a network entity may create a D-User in special occasions (e.g. handover). Furthermore, the external services such as DW services or D-Raps may request the creation of a D-User for which the user authorization had already been obtained.

The following are some of the example implementations an HNO may consider to offer the users to create a D-User and obtain UCM services.

### 6.28.1. D-User Creation with Subscription

An HNO may require a user to first subscribe for a service with a service management layer function (DSMF). After the subscription the DSMF may take action to create the D-User. The subscription may be for one or more of a basic D-User, Specific D-User type(S) which can provide certain UCM services, specific UCM service type(s).

Subscription for different D-User types may incur different charging systems for the service.

Subscription for a UCM service without having a D-User may be interpreted as a subscription for both a D-User and the specific UCM service.

Subscription for a basic D-User may not facilitate any UCM service but there may be at least two ways to obtain a UCM service after subscription for a basic D-User.

The user may have to subscribe for a specific UCM service or

The user may request to add a UCM service dynamically, making such a request to a control plane function (DUCF). In this case, the D-User can quickly orchestrate the service by instantiating and the configuring the required functionalities as basic D-User is in place.

6.28.2. Dynamic D-User Creation with a Request to Control Plane Function:

A user, 3^{rd} party service operator, a 3^{rd} party D-Rep inside the HOP, or a network entity may trigger dynamic D-User creation by making a request for a specific D-User type(s) or a UCM service type(s) from a control plane function (D-User creation function—DUCF).

Some HNO's may need prior subscription for a D-User and the HNO may design and make it ready to create a D-User at the subscription but does not create D-user until such a request is received through the DUCF.

Some HNOs may consider this request as a request for a subscription and creation. Therefore, the DUCF may take action to add the user subscription for D-User type or UCM service type and initiate the creation process. Subscription is needed to start the charging mechanism and its associated monitoring system.

6.28.3. Dynamic D-User Creation with a Request to a HOP Function:

A user or network entity may directly request a HOP function which is capable of creation of a D-User or UCM service without requiring the authority from the hosting network. However, it may have obtained prior authorization from the network for such creations. The subscription for such services may be kept inside the HOP. AN In-network DW may create individual D-Users or D-Reps in this manner.

6.28.4. D-User Creation by an External (or Third) Party Service Provider from a Service Management Layer

Usually, an external service provider may not have access to make a request to control plane function as in above (b). In such case, the external service provider may have to first make an agreement with the HNO and HNO may want to obtain user authorization for the same. External DW operator or XR operator may need such a service.

In another implementation, different types of D-Users or basic D-User may be created prior hand and when a request comes in, they are allocated to the users with some modification including function configuration which might not speed up the creation process. This may be applied to all above cases, in which case the creation step in above means assignment of an already created D-User to a particular user with certain configurations. These configurations include establishment of a secure link between the user and the D-User and specific user policy transfer from the user to the D-User and HOP managers. In addition, specific techniques for the privacy requirements of a particular user are established. The number of D-User modules to be kept in this not-connected deactivated mode depends on the arrival pattern of the new D-User requests. Multiple D-Users may be kept inside a single HOP or each D-user may be allocated a HOP.

### 6.29. Life Cycle of a D-User

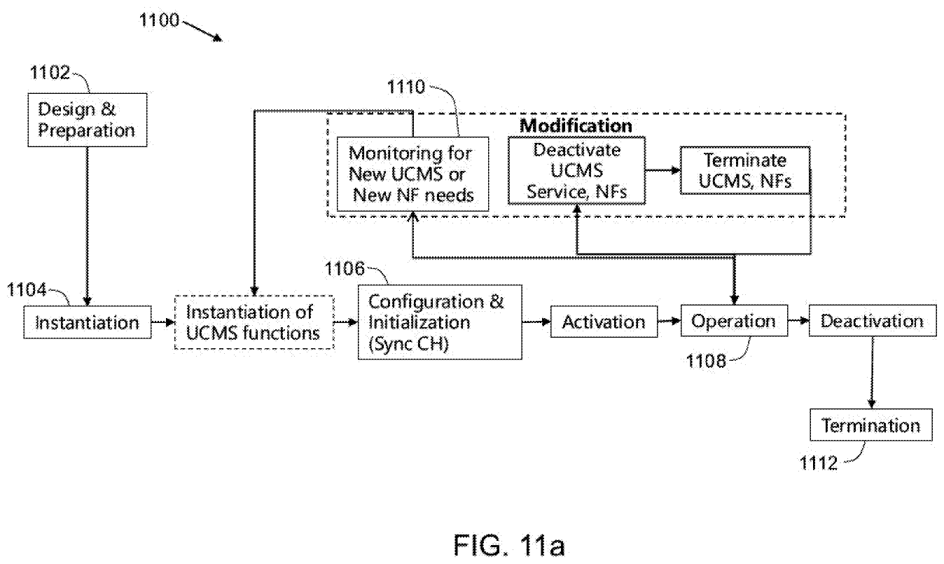

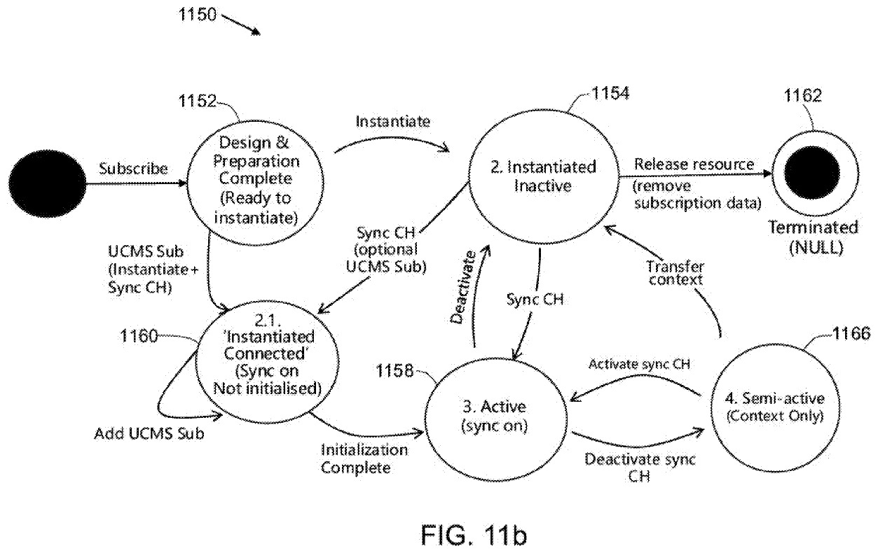

Once a user has subscribed for a D-User, several steps may be taken by a network mobile operator (MNO) to configure a D-User module in a fully operational state. In the previous section, different implementation possibilities are described. In the process, a D-User can have different states from the preparation to fully operation mode. This can happen in different ways based on the UCMS services the D-User expected to provide, in addition, different MNOs may use different steps in creation and using it for UCMS services. For example, a D-User life cycle 1100 may comprise the following phases which is shown in FIG. 11a.
a design and preparation phase (phase 1102),
instantiation phase (phase 1104),
a configuration and initialization phase (phase 1106),
operation phase (phase 1108),
a modification phase (phase 1110) and
a termination phase (phase 1112).

There may be additional optional phases, such as the instantiation of UCMS functions, after the instantiation phase. Also, prior to putting the D-User module in operation, it may need to be activated, and prior to being terminated, the D-User module may need to be deactivated. During operation of the D-User module, modifications can be made thereto. A function may monitor operations of the D-User module to detect the need for new UCM services (UCMS) or for new Network Functions (NFs) needs. Similarly, UCMS and NFs may need to be deactivated, the UCMS, NFs may need to be terminated.

Before the operation phase, the D-User may be activated and before termination the D-User may be deactivated. During the operation phase, the D-User may be modified by adding or deleting UCMS services and adding and deleting network functions as required by the UCMS service operations.

When a UE has subscribed for a D-User, without subscribing to any UCMS service, the MNO may not need to instantiate the D-User right away. The MNO may design and prepare the network for the D-User creation. D-User instantiation may happen later, whenever a UE subscribes or requests a UCMS service, and instantiation of the D-User may be performed, by configuring and initializing it with UE's policies and other required information.

For some UCMS scenarios, the D-User may need to obtain information or details from the UE before providing the UCMS services (e.g. UE interests, location, user policies, communication keys and authorization privileges etc.). In that case, a D-User may go through an Initialization phase where a UE is connected, to obtain those UE details. After this initialization phase, the D-User's UCMS services may be activated and the D-User may be in the operational (active) phase. Once activated, the D-User is ready and the PDU sessions of the subscribed UCMS services may begin. There can be scenarios where a user does not need a UCMS service for some periods. In order to save resources, the D-User may be made inactive or semi-active. In such cases, where the sync channel may also be disconnected or moved to an idle state. The D-User may be terminated if the UE does not need it anymore (e.g. during a handover from visiting network to another network, visiting network does not want to keep a D-User unless there is a chance to use it again).

The D-User may go through several states or modes during its life cycle 1150. They are illustrated by FIG. 11b and a brief description of each state and the state transition conditions are provided below.

### 6.29.1. Design and Preparation State (1152)

Note that when a D-User needs to be created, the network may create only a D-User descriptor (or a blueprint) outlining all the NFs, the interconnections and resources needed and wait for a trigger for the creation, for example, receiving a subscription for a UCMS service or D-User. For different types of D-Users, different descriptors may be available. Some HNO's may create D-Users even before a trigger is received, without allocating to any specific user, so that when a user requires it D-User can be assigned to the user quickly. For this purpose, the HNO may keep several D-Users of different types may be created and keep them in “Instantiated-Inactive” phase without assigning a user. This is useful for an MNO, when a user with a D-User is handover so that it can quickly assign a D-user to the user. Therefore, depending on the HNO or the type of subscription (subscription includes a UCMS service, basic D-user or specific D-User type) the D-User may be instantiated and transfer its state to one of the following two states:

6.29.2 Transition to ‘Instantiated-Inactive’ state

Some MNOs may instantiate the D-User and keep it inactive (‘Instantiated-Inactive state’). Even after a user is subscribed for a D-User, some HNO's may create the D-User and keep it in this state. In this case, the D-User is allocated to the user, but sync channel is not established with the user which may be done when the user requires to establish a UCM service, Some HNO's may establish the Sync channel when the user subscribe for a UCM service indicated in the state diagram as ‘UCMS Sub’. Some HNO's may even not connect the Sync channel after subscription for a UCM service and keep the D-User in this state and wait for a specific UCM session establishment request is received. This may also be done depending on the UCM service a D-User required, in particular when the initialization state is not necessary for a UCM service or initialization does not take time.

Transition to ‘Instantiated Connected’ state: Yet some MNOs may instantiate the D-User and keep it connected to the UE by establishing the connection to UE through a Sync channel so that the D-User can be initialized.

Following functions may be required for the preparation stage:

### UE Functions:

UE app for UCM/D-User service subscription/request and UCM service software download.

This is required for the case, where an HNO does not instantiate the D-User even after a subscription.

### HNO's C/M Functions:

D-User service manager (DSM) function for UCM/D-User type subscription

Providing UCM software to the UE if a user has already subscribed.

Establish policies for different UCMS types (charging, priority, mission graphs)

D-User blueprint preparation function: For each UCM service type that is expected to be provided, this function identifies the network functions, interfaces and operation policies for those UCM services and store it in a HNO's blueprint database to be sent to the HOP or/and D-User when the D-User is created. The required interfaces with the ingress and egress ports of the D-User for each NF of the D-User may be identified for this purpose.

### 6.29.3 Instantiated Inactive (Standby) State (1154)

Once a D-User is instantiated, the D-User may be kept in the standby (inactive) mode to save resources. During inactive mode user does not have any interaction with the D-User CPFs and UPFs. As explained before, there are at least two possibilities:

The D-User may not be assigned to any user at this stage and keep it standby to be assigned to a user when it is required. D-user may be configured for a specific UCM service type(s) or D-User may be a basic D-user.

The D-User may be assigned to a user but not connected to the user D-user may be configured for a specific UCM service type(s) or D-User may be a basic D-user.

Instantiation of UCMS functions: Instantiation of functions required for a specific UCM service may be done at this stage as indicated by the life cycle diagram. As mentioned before different UCM services may require different functions whether they are in hosting network, HOP or in the D-user.

### Transition to Next State:

Usually when a UE subscribes to a UCMS service (UCMS Sub) the D-User may need to be changed to Active state because a PDU session of the UCMS service could be initiated at any given time. Some UCMS services may need the D-User to be initialized with the UE information, guidelines, and policies before actually using the D-User for the UCMS service. In that case, the D-User state is moved to ‘Instantiated Connected’ state and after initialization is complete it would go to the Active state where UCMS services can use the D-User. For some UCMS cases, if the standby to Active changes (e.g. initialization process) does not need much time, the HNO may activate it whenever a UCMS service related traffic is generated and transition to Active state could happen when a UCM session of the UCMS service is started for the first time.

Active to Inactive transition: In addition, when a D-User does not expect to use a UCMS service for a long duration including the need for keep alive message or the sync channel, a D-User may be configured from Active to Inactive state by deactivating the D-User.

### 6.29.4. Instantiated Connected State (1160)

As explained, when a user moves to this state, the D-User may be connected to the user and specific functions needed for specific UCM services may have already been instantiated. The D-User is not initialized yet. The activation of the D-User (preparing the D-user to provide a specific UCM service) may begin at this stage which needs transferring UE data to the D-User, establishment of authentication keys, establishing UCM service policies, obtaining specific software from/to user for UCM operation etc. These depends on the UCMS service the UE is expected to use. A sync channel is established between the UE and the D-User for this purpose.

Configuration and Initialization: As in the life cycle diagram, this step refers to the need to create and configure the specific functions required for a supported UCM services since different UCM services may need different functions as well as different configurations. Depending on the UCM service, this may be done at the inactive state and this action may either not needed or only some minor configuration parameters may need to be changed. For example, if a UCM service is in-network processing, the user may provide the specific software for processing to the D-User and D-User install that and establish a method to identify such data from the UE and process them and transfer data as per the instructions from the user or as indicated int eh software.

Transition to active phase (e.g. Activation): Once the initialization is complete for a particular UCMS service the D-User moves to the active state.

### 6.29.5. Active State 1158

During active state a D-User is fully configured for the UCM service and could be used by the UCMS session for example PDU sessions or data processing sessions. At least one UCMS service is in operation in this state as indicated by the ‘Operation’ box in the life cycle diagram. However, it does not mean that a ‘UCMS session’ is in operation, a session can be established at any time and the network is ready for user to start a UCMS session. The logical synchronization link between the UE and the D-User is used by the UE to communicate with the D-User.

Modification of a UCMS service: During active state the D-User can be modified by deactivating a UCMS service, activating a UCMS service, terminating a UCMS service or adding a new UCMS service. Sub states of the Active mode exist based on the state of the UCMS service being subscribed. All those sub-states may be related to one or more of an active UCMS service state, a standby UCMS service state and terminated state. Active UCMS service is a USMS service in operation. Standby UCMS service is where the user has subscribed for the UCMS service but no UCMS sessions is active or in operation. Terminated UCMS service is when the user cancelled the subscription or when the subscription duration is expired and HNO removes the UCMS service. The details of these sub-states are not discussed here which will be discussed in a detailed UCMS operation document.

Transition to Semi-active state: When a UCMS service is not used for a long time the D-user may be placed in a ‘semi-active’ state, by keeping the sync channel in a deactivated state, but the D-User context is not removed.

In this state the Sync-channel information is still kept and but when communication between the D-User and the user is needed, either User or the D-user would initiate the activation of the channel by making a request to a hosting network (E.g. DUCF) or HOP function (HMF). Transition to inactive state: When all the UCMS subscriptions are cancelled or expired while in the active mode (i.e. no more existing UCMS subscriptions) the D-User can be deactivated and be moved to Inactive state and may be moved to terminated state from that state.

In some cases, the D-User may be kept at Active state even no subscribed UCMS services because UE can dynamically subscribe to a UCMS service.

### 6.29.6. Semi-Active State 1166

In this state, the sync channel is disconnected or dormant. This may be done when there is no active UCMS session for a long time or user does not need to interact with the D-User for some duration. However, the network may interact with the D-User and D-User may take actions on behalf of the UE (authorization, data processing, prefetching, data sharing, store messages from external parties etc.). The following are few example scenarios:

When a UE moves from a visiting PLMN to another PLMN (home PLMN or a visiting PLMN) the first D-User may be terminated or move to Inactive state and prior to that the D-User may need to transfer its context for which the Semi-active state can be used.

When a UE is offline, the D-User may not be connected to the UE with the Sync channel, but the D-User can take actions on behalf of the UE and continue its operation with the network or other entities for the communication requirements of the UCMS service.

A UE is online but the user or D-user is carrying out certain processing of data until they need to be communicated again, e.g. training phase in an AI process.

Transition to active state: When communication between the D-User and the user is needed, either User or the D-user would initiate the activation of the channel by making a request to a hosting network (E.g. DUCF) or HOP function (HMF).

Transition to instantiated-inactive state: The D-User may transfer all the D-User and user context in the D-User including those associated with all the UCMS services to a user or remove that as per the instruction from the user or it may be determined by the D-user itself after observing the operation of all the UCMS services. It may also take action to remove all the UCMS services before moving to instantiated-inactive state.

### 6.29.6. Terminated State 1162

Before terminating a D-User all the UCMS services should be terminated. D-User itself, hosting network or UE decides to terminate a D-User. The network would decide if the contract is over or when a D-User installation is originally triggered by a network entity (e.g. during handover). D-user would decide once the purpose of creating it is completed. A user would terminate it if user does not want it further.

Termination procedure: Request to terminate the D-User is received from a user or a network entity or D-User itself decides to terminate it as explained above. Deactivate al the UCMS services and terminate each of them. Remove the specific functions used for the service, change the configurations if needed (specially hosting network functions and HOP functions), communicate with the user to remove or configure the specific functions used for UCMS service and inform the final termination to the user and to HOP and hosting network if applicable (HOP or hosting network may not be aware of certain UCMS services D-user use). Before termination D-User context may be transferred to another D-User or UE depending on the UCMS service as indicated above. Inform UE the need to disconnect the sync channel and erase associated security keys. Inform the HOP or hosting network to remove the D-User and associated functions in the HOP and hosting network specific to the D-User. HOP or hosting network remove the D-User module and inform the user.

6.29.7 Methods to Create a D-User with Different Isolation Requirements

In order to meet the requirements for use cases such as those described above, the following steps may be implemented. Although the following paragraphs are described for a D-User, it is understood that the steps described can be applied to any type of digital entity, without being restricted to D-Users.

Each D-User may be isolated from D-Users of other users but they can share the same network functions. In this case, a D-User may use a software container providing added functions to isolate the D-User from other D-Users. When a user has access to multiple D-Users, it may not be needed for the D-Users to be isolated from each other and the D-Users may share common functions for their operation.

A HOP may be created inside an enclave isolated from the hosting network (i.e. even the hosting network may need to obtain permission to access functions or data inside the enclave). This may be useful, for example, for use cases 3, 4, and 5 described above. For these cases, an isolated confidential computing platform such as a TEE (or CEE) may be used.

A HOP platform may be used for multiple D-users in order to be able to perform ID changes to hide the identity of the end-users even from the hosting network when communicating with external devices. This may be useful, for example, for use case 4. One hosting network function (HNFs) within the Hosting Network may ensure that the Hosting Network cannot track the external servers accessed by a specific Digital Entity (D-XX) by deploying the Hosting Operations Platform (HOP) as a multiple DE-HOP. When the HOP hosts multiple Digital Entities (DEs), it may become impossible for the HOP to track which specific DE has accessed which external server.

A HOP may also keep a minimum number of DEs, such as D-Users, inside the HOP. For example, the K-anonymity model requirements may be used to anonymize user communications to/from DNs (i.e. hosting network cannot know which user inside the HOP communicated with the DN). The K-Anonymity requirement can be summarised as “for every combination of identifying attributes in a dataset, there are at least ‘K minus 1’ other people with the same attributes”. Therefore, the source ID of messages sent to the DE may be changed with a randomized ID and also the response address of messages sent by the DE to the user may be randomized, with a randomized location (such as random or encrypted IP address).

The confidentiality requirements of a D-User may also be met by having one, or a limited number of D-Users, in separate enclaves. The communications to outgoing and incoming ports of each of the separate enclaves to third parties can be configured to transit through another isolated enclave of the hosting network. This isolated enclave can be configured to perform random ID changes, thus preserving the confidentiality of D-Users with respect to third parties. In such possible embodiments, it is possible to maintain confidentiality specifications for a D-User even with a limited number of D-Users in a HOP. Once the HOP is created, the HOP may be given the capability of independent operation. This may be useful, for example, for use case 5 described above.

For this purpose, when the HOP is created, a HOP manager function 834 (HOP-M) may be created inside the HOP. The HOP-M 834 may be capable of doing the LCM for D-Users (e.g. creation, modification and termination of D-Users). The HOP-M may also be capable of doing common functions needed for the interaction of the D-User functions with entities outside the D-User (e.g. other platforms inside the HOP, hosting network functions, P-User and P-User devices, 3^{rd} party servers), privacy preserving functions when a D-User communicating with external entities.

Metaverse or digital world (DW) applications may use different types of digital entities (D-XX) and privacy preservation may be required for the Digital Entities (D-XX) as well as for the DW application operations. In particular, the DW operations may need to be protected from the hosting networks. The hosting platforms (HOP) discussed herein can be used for providing in-network DWs as well. DWs may consist of D-Users, various D-Reps such as D-Infs and various other applications, such as VR or AR applications.

### 6.30. D-User Creation Procedure

The following paragraphs explain the creation of a digital entity (DE or D-XX) in general terms, and also refer to the specific case of creating a digital entity for a user (D-User or D-User module). As explained above, in the present application, a digital entity (also referred to as an entity replica or a digital twin) represents or replicates any type of entity, whether for an organization, an object, a process, an application, a set of objects, or a user. The creation process of these different entities is similar, and similar creation functions can be used. The creation of a user entity (D-User) represents a special case of a digital entity creation.

The creation of a D-User inside a HOP may be initiated either by a user, a network entity or another D-User. In possible embodiments, a D-XX service manager (DSMF) may request the HOP to create a D-XX module or assign a D-XX module already created in the system to a particular user. These are several ways this can be performed.

As discussed before, when a request is made to create a D-User module, it may be received by a hosting network service management function DSMF or a control plane function, DUCF (D-User creation function), depending on the specific implementation an HNO provides to its customers. A request to DUCF is a request for a dynamic creation of a D-User.

The use request may be made using a subscription to customer service department (CSD) which may be sent to the DSMF to initiate the creation, or it can be made dynamically using UE control plane trigger to the control plane function, DUCF. In addition, a user app can subscribe directly to the DSMF. There may be several subscription options the HNO may provide for the user, as indicated below.

### Option 1:

Subscribe for a D-User service (i.e. the hosting network creates a D-User)
Subscribe for a UCMS service (i.e. the hosting network adds UCMS functionality to the D-User module)

### Option 2

Subscribe for a new UCMS service (the network creates a basic D-User module if there is no existing D-User module and adds a new UCMS functionality to the D-user module)

### Option 3

Subscribe for both a D-User module and a UCMS service (or specific D-User type providing the UCMS services)—the network may create a basic D-User and add UCMS functionality.

Once an end user has subscribed for a D-User module, the subscription may be included in a user subscription repository (UDR) controlled by a user subscription manager (USM). Then, when a user requires to establish or use a UCMS session, the network may check whether the user is authorized by checking the UDR. For this purpose, the D-User service provider may publicize or provide the user with all the information of the D-User services, various methods for subscription and associated policies which include charging (i.e. invoicing) policies and privacy policies.

After receiving a subscription, the hosting platform may create the required D-User module with a D-User manager (D-User-M) and access control function. The D-User-M may be provided with security credentials to establish communication with the user (address, security keys etc.), via a UE. The user may also be provided with the required information to establish the logical communication link. A secure communication link may also be established for the D-User-M to contact the HOP manager. A D-User access control function may authenticate and authorize access of the internal functions by external functions. As discussed before, a D-Use may be created inside an enclave or a software container. These are discussed below in detail.

6.31.1. Case 1 D-User is Created Inside an Enclave (e.g. Using a TEE)

In this case, the D-User-M may first be created and may establish a secure communication channel with the UE. The D-User-M may be provided the capability to instantiate the NFs required for the authorized UCMS services for that D-User module and other LCM functions with without the knowledge of the hosting HNO. The HNO may charge for the UCMS services using the information obtained from D-User-M about the services provided or resources used. Invoicing can be based on one or more of the resources used, the type of services used, types of applications run, or the amount of traffic that is sent in and out of the D-User (for each type of QoS). Afterward, the D-User-M may be created inside the TEE with the capability to provide that information to the HNO. If a user does not want to provide service information to the hosting network, invoicing may be done based on the resources used or for the D-User. In addition, the D-User-M may be carrying out the resource management for different UCMS services.

There may be at least two options to create a D-User module inside an enclave. One option is to install an enclave exclusively for a D-User module. Other option is to install an enclave for multiple D-User modules. An aspect of using an enclave is the capability of the user of the enclave to attest the credibility of the enclave functionality, i.e., user can assure that the enclave cannot be accessed by the hosting network.

If a single user may be using the enclave, remote attestation is straight-forward as the access codes are given by the vendor before the installation. The hosting network may have to provide access to the user once the D-User is created with a D-User-M and optionally with an access control function. These original functions codes may be hard-coded by the vendor and therefore, a D-User module can create a remote attestation code, which may be a hash value of the current network functions inside the enclave and provided to the user with the vendor address and authentication keys. A user may validate authenticity of the enclave by sending the code to the vendor directly to conduct the remote attestation and the vendor may attest it and send the certificate to the user. The original functions may be provided to the vendor by the network operator and the codes may be verified to not allow a 3^{rd} party to access other than using the access code provided by the vendor. The original functions may also include blueprints of the initial D-User module and various UCM services which makes the D-user self-sufficient to provide the UCM services.

If multiple D-Users are to use a single enclave, the remote attestation may need to be done very carefully as user needs to guarantee that the hosting network cannot access the functions inside the HOP and the D-User after creation. In this case, the original HOP-M may have the capability to create D-User modules for different users. In some embodiments, the D-User manager original code may provide the D-User manager the capability to create a D-User and provide a default D-User-M program and, in addition, may provide a separate executive environment and a separate memory area and an access code to access the D-User-M. A user may use remote APIs to carry out specific functionalities such as creation of the functions within the D-User module. The user may also run its own applications inside the protected area by installing new software, but any attempt to access outside the allocated memory area may be prevented by the HOP functionalities. Since HOP functionalities cannot be modified, the remote attestation may still guarantee the protection of the D-User activities from the hosting network as from other D-Users inside the enclave. Access to these areas may be controlled by the original code of the HOP, which can be remotely attested by each user. A possible issue here is that each user may have the same remote attestation code. However, since they cannot alter the original HOP program codes, this may not be a vulnerability.

In some embodiments, the remote attestation for HOPs with multiple D-User module may be done by providing separate remote attestation code for each user for its D-User functionality as well. In this case, the HOP original program code may have the ability to create a default D-user module in a separate container inside the HOP when requested by an authorized user having access code, e.g. the hosting network function. The default D-user is created according to the vendor specifications. At this point the D-User access may be provided to the user and user may obtain a remote attestation code for HOP and D-User codes separately. A user may perform remote attestation with the vendor at this point to obtain the certificate for isolation. Any modification of the functionality, interface or configurations after this point may be carried out with the authority of the D-User-M only. The D-User module may obtain instructions only from the user for this purpose. In other words, either the HOP or any network functions in the HN may be prevented to modify any of the functions or configurations inside the D-User module without the knowledge of the user and user authorized such modifications (function creation, function configuration, interface establishment etc.) are kept in a log inside the D-User and also a similar log is kept with the user. This way, a user may periodically or sporadically attest that the D-user functions have not been modified without authorization. The D-User module may therefore be fully under control of the user. When preparing the code for remote attestation, the D-User module may do it with the inclusion of all the changes or after excluding the changes and inform the user the method that is used. The user may use the same method to attest the D-User configuration.

Once D-User is established with the required functions and interfaces, the UCM service may be established, dynamically requested either by the physical/real user, via a UE, or via a network entity.

6.31.2 Case 2: D-User is Created Using the HNO Infrastructure within a Trusted Environment

Once the HNO decides to create a D-User module (e.g. after a UE subscribed for a D-User/UCMS service), an OAM function, such as a D-User network orchestrator (DUNO) in the HNO, is triggered.

DUNO may create a D-User-M function and associated NFs and required interfaces to the CN network functions. If the D-User needs to be created with the UCMS services, the functions may include the basic D-User functions as well as the functions required for the UCMS services, which can include both CPFs and UPFs. This may be similar to a subnetwork in 5G with CPFs

The interfaces may include a sync channel between the UE and the D-User module. Sync channel may include a signaling interface. In addition, depending on the D-User/UCMS requirement, one or more data channels may be set up.

The D-User-M may be provided with the UE identification and authentication methods. Setting up the sync channel may include: the HNO providing both UE and the D-User-M the security keys, UE identification (this may be different than the UE ID) and address information. After that, the UE may set up its own security keys for communication with the D-User module.

In some embodiments the D-User-M may give the authority to create CPFs and UPFs. A proxy VNFM, and a proxy VIM may be provided and an interface may be provided with the VUNO for this purpose.

The LCM of NFs may be done by the D-User-M or the DUNO.

The message flow for D-User creation and UCMS service establishment for both of above case 1 and Case 2 are explained below.

The HNO's customer service department (CSD) provides a description of the available D-User module and UCM service to the public. It may be provided by broadcasting the information to UEs or users may obtain by requesting or user access the information from other sources (e.g. from the HNO's web site). Information may include service descriptions such as privacy levels and user processing facilities, invoicing methods for different types of services.

The real or physical user, via a UE, may subscribe for one or more of D-User type or UCM service type with CSD. This may be for a basic D-User subscription as explained later.

The CSD may inform of the subscription to the DSMF.

The CSD may confirm the subscription to the real user with invoicing information.

Optionally, a user application may contact the DSM to subscribe for a D-User module or for a UCM service type.

Optionally, a network entity may request a D-User creation from the DSM.

The DSM may confirm subscription to the UE, to the UE app or to a network entity, as appropriate.

The DSM may record the subscription in the user subscription profile in UDR.

The DSM may request creation of the D-User module from the HPCCF or from the HOP C/M. depending on how the HNO creates the D-User functions.

The HPCCF or HOP C/M may create the basic D-User with essential D-User C/M functions.

A synch channel may be established, with a secure link between the UE and the D-User module.

If the initial subscription is only for a basic D-User, a user application may find the requirement for a specific UCMS service and trigger the UE. Otherwise, this may be a request to add another D-User service. Otherwise, this step is optional.

The UE may trigger the new UCM service establishment request from the DUCF, if it is not already subscribed for,

The DUCF may check the availability of the UCM service type and of the other requirements, such as resource availability, and may record the UCM service as a new subscription in the UDR.

The DUCF may request the HOP C/M or the HPCCF as applicable, the establishment of the UCM services already subscribed by the user may include new UCMS service request or the original subscription from the UE with the D-User request.

The HPCCF or the HOP-C/M may request the D-User C/M to establish the UCMS service.

The UCMS service may be established, which involve the D-User module, the HOP, the hosting network and UE function creation and configuration.

UCMS establishment may be confirmed to the UE and the user app. Any new software needed for the operation may be sent to the UE for installation.

The user, via its UE, may use the UCM service.

### 6.32. Establishment of a Generic UCMS Service

In the current application, a UCMS service is a service given to the user to share user data safely with the external entities, such as 3^{rd} parties, while preserving user privacy. A user or a hosting network function may request the establishment of a specific UCM service. Once a D-User is created, additional UCM services may be requested by the user.

This UCM service request may be performed according one or more methods indicated below:

When a D-User is already available for a user:

A user may request an additional subscription to the service management layer function, i.e. DSM. After successful authentication of the user, DSM may make a request to the DUCF to establish the UCM service in the existing hosting platform. DUCF may request the establishment of the UCM service from D-User manager (D-User-M) or D-User platform manager (HMF).

A user may make a dynamic request to a control plane function (i.e. DUCF). The DUCF may request the establishment of the UCM service either from D-User manager (D-User-M) and D-User-M may take an action to create the needed functions and configure them to serve the UCM service, i.e. data sharing service.

In some cases, the user may make a request to the D-User manager. In this case, the UCM establishment may be done by the D-User, without awareness of the hosting network. In this case, D-User manager is provided with the required capabilities and may also have authority to create and configure functions inside the D-User module and request creation or configuration of functions in the hosting network, by obtaining authorization from the network. When the D-User module is created, these capabilities may be provided to the D-User manager.

When a D-User is not available for a user:

As mentioned above, a user may request to create a UCM service before the creation of a D-User and, at that time, the network may treat the UCM service request as a request for a specific type of D-User module, together with that UCM service, and create the D-User as well as the UCM service.

In some cases, the hosting network may create one or more D-User modules with a D-User-M prior to assigning it to a user, to reduce the delay in creation. These unassigned D-User module may be assigned to specific users whenever a D-User creation request is received as explained above. Then, the D-User module may establish a sync link with a UE of the user and may synchronize user data before starting the data sharing UCM session.

Once a data sharing UCM service, i.e., content prefetching service is established, the content interest collection and synchronization with SCIP, D-User may start. This process may be continued until this UCM service is terminated. The content interests may be collected by the D-User module from UE of the user and may be updated regularly using the sync function. The content interests may be classified and categorized. Data categorization may be done according to a standard categorization scheme. Sensor data may be received in a regular basis.

In the synchronization process, the D-User module may inform the user which data to be sent and even filter data before sending, as all the data may not be required. The D-User module may inform not to send certain data based on the consumer needs or market trends. The UE can remove the duplicated or unnecessary data before hand and also can do some kind of de-privatization of data.

### 6.33. Privacy Preserving Levels (PPL) Required for Different Type of Data

The user may mark the privacy preserving levels (PPL) required for different type of data. This can be performed for example via an application executed or accessed from the User Equipment of the user. Once data is received by the D-User, the D-User may take the PPL level received and consider D-User's PP policy and the technologies available with the PPP for privacy preservation. The D-User may determine the PP processing needed for the data within the D-User and within the PPP and process data accordingly. The D-User can send the data and associated privacy preservation techniques needed to the PPP. The PPP may change the user ID in the source address to a temporary ID and include a corresponding temporary location to receive responses from the Shared Data Portal (SDP) and send data to SDP. The UE ID and the response receive locations may be changed every time data is transferred so that the network cannot correlate different data to the same user. If necessary, data may be sent through the Fully Homomorphic Encryption function (FHE) of the PPP to preserve privacy, to avoid the possibility of leaking the user information from the raw data, although the data is sent in anonymous manner and response is received to an anonymous location. If the Hosting Network is untrustworthy, the Hosting Network, although storing the user data, cannot identify which user has sent the data if there are multiple D-Users in the D-user platform.

### 6.34. Accessing Content Interests in the SDP by the 3^{rd} Party Data Consumers

3^{rd} party servers, also referred to as external servers, may access data after verifying the SDP data categories and if payment is needed, 3^{rd} party servers may proceed with payments to the Hosting Network operator. The Network operator may in turn make a corresponding payment to the user. The Shared Data Portal (SDP) may have all the functions of a database control with access control and data search engine. Data in the SDP may be categorized so that Data Consumers can search for the data types the consumers are interested in. In addition, once certain data is received, the SDP may automatically inform specific Data Consumers who have registered with the SDP for those data types, so that the Data Consumers can access data whenever they are available.

The data sent to the Data Consumers may keep the source address in the header as the SDP address, such that no information is provided about the temporary location provided by the PPP. In this case, the responses from the Data Consumers may come to the SDP and SDP has to send it back to the temporary location. In some cases, there is a need for a negotiation process between the Data Consumer and the SDP before sending data. This may involve a payment for the data.

However, another option may be to use the location provided by the PPP as the source address when sending data to the 3^{rd} party data consumer. This may be done if there is no need for the SDP to know about the response from the Data Consumer after obtaining data, e.g. no need payments for data) does not have any clue about who sent data to the SDP preserving privacy.

### 6.35. Detailed Procedure for Data Sharing

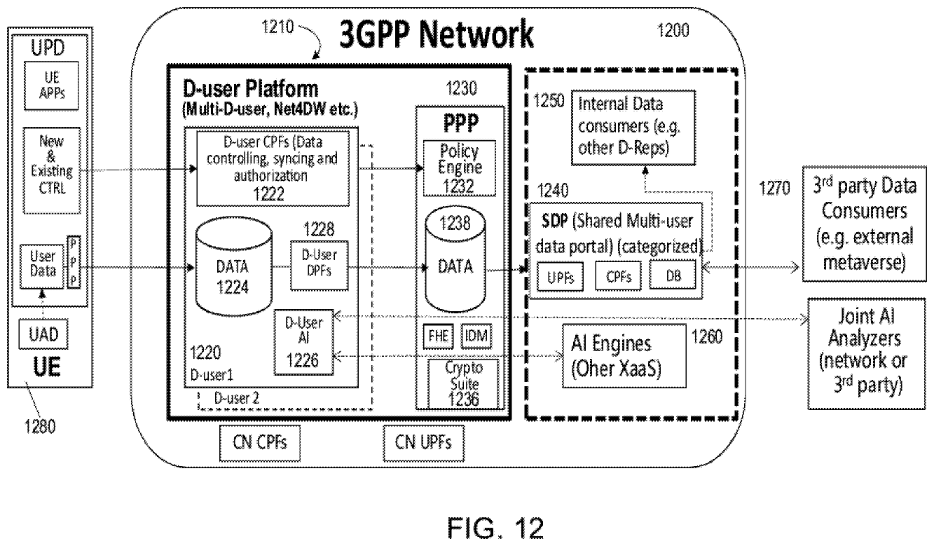

FIG. 12 shows examples of main function blocks which may be involved in the Data Sharing UCM service. The function blocks are provided as examples only and some blocks may not be required.

The User Equipment 1208 may include a User Personal Device (UDP) and a User Access Device (UAD). The UPD may include User Equipment applications, New and Existing Controls, storage for User Data, and a local Privacy Preserving Portal.

The D-User Platform 1210 may be hosting by a Hosting Network 1200. The D-User platform may be a single or multiple D-User platform. In FIG. 12, two D-Users 1220 and 1230 are illustrated. D-User 11220 may comprise D-User Control Plane Functions (CPFs) to control, synchronize and authorize incoming and outgoing communications. D-User 11220 may comprise D-User Data Plane Functions (CDFs) to control, among other data, data outgoing to the Privacy Preserving Portal. D-User 11220 may comprise data storage 1224, to store data received from the User Equipment, via the local PPP. D-User 11220 may comprise D-User AI engines, models or applications in block 1226.

The D-User platform may comprise a Privacy Preserving Portal 1230. The PPP 230 may comprise a Policy Engine 1232, a PPP data storage 1238, a fully homomorphic encryption function (FHE) module, an Identity Management (IDM) module, a Crypto Currency Suite module 1236.

In the Hosting Network 1200, there may be internal Data Consumers 1250, the Data Sharable Portal 1240 and a plurality of AI engines 1260. The SDP can comprise UPFs, CPFs and a DB of its own.

3^{rd} party Data Consumers 1270 may connect to the SDP 1240. Joint AI Analyzer from other 3^{rd} parties can be used in conjunction with the D-User AI engines 1226. The data from the SDP may be shared with other D-Users, as per 1250. The Data Sharing Functions may be provided in the HOP or outside the HOP, but inside the Hosting Network. Examples of 3^{rd} party Data Consumers may include social media applications, or external metaverses. They may communicate with the SDP 1240 via gateways.

### 6.35.1. Scenario 2a

As explained previously, a D-User may selectively share personal data (e.g. user/device/home information) anonymously to 3rd party analytical services for the 3^{rd} party usage. For example, this data may include home or environmental sensor information which benefits the data consumer and direct (e.g. payments for data, service improvement) or indirect benefits (e.g., global weather information, road obstacles etc.) may be received to the user. The privacy preserving procedure may be similar to 1(c) above and the following is a brief description this procedure.

User, via its User Equipment, sends data to the D-User.

The D-User processes data for the classification and insertion of different identifications such as PPL and provides the data to the PPP to be sent to an analytical unit (e.g. AI4Net or any 3^{rd} party)

The PPP may change the ID and send data to the analytical unit. If necessary, data is sent through the FHE to preserve privacy which otherwise could be leaked to the analytical entity.

Analytical unit may analyze the data and use it for its own purposes.

### 6.35.2 Scenario 2b

Scenario 2b is similar to Scenario 2a, although the data is already with the D-User waiting to be uploaded. The data transfer may need to be performed while preserving privacy. The first step of above (sending the data) is not needed or has been previously performed previously.

### 6.35.3. Scenario 2c

The D-User may pass dynamic queries from the UE to the providers via the PPP by changing the dynamic queries as a privacy preserving query.

Similar to scenario 2a, a query can be sent to the D-User by the UE, and the D-User passes or transfers the query to the destination via the PPP. The PPP performs an ID change/replacement and filters other personal data in the query. The PPP can specify a location to send the query results. After receiving the results, it may be passed to the D-User and D-User may send the results to the UE. Some queries may be done by the D-User for its own use without the query originated from the UE (e.g. for its analytical purposes).

User sends a query to the D-User to be forwarded to a 3^{rd} party, or the D-User determines a need for a query.

The D-User provides the query to the PPP to be sent to the 3^{rd} party. A payment option is provided, as previously explained in relation to Scenario 1.

The PPP changes the ID and includes a corresponding location to store the results and to send the data to the 3^{rd} party. If necessary, the data is sent through the FHE for data filtering to preserve privacy.

A 3^{rd} party server provides the results of the query to the specified location and, if necessary, a payment is obtained as described previously for Scenario 1.

The PPP sends data to the D-User or provides access of the data area to the D-User.

The D-User forwards the query results to the UE.

Scenario 2c may also include interactions for obtaining data analytic services from 3rd parties, including the wireless network preserving privacy, similarly to the process described above regarding a query from the user. However, in this case, a large amount of data may be sent for analysis instead of a simple query. Therefore, data filtering e.g. by FHE is required in addition to the ID change. Since some analytics may be performed after the FHE process, this process can be useful for data analysis. The following steps can be performed:

A user sends, via his/her User Equipment, user data that need to be analyzed by the D-User.

The D-User provides the user data to the Privacy Preserving Portal (PPP), to be sent to an analytical unit (e.g. from the Host Network AI4Net or any other 3^{rd} party). A payment option can be provided as in Scenario 1(b).

The PPP changes an ID which could be linked to the user, and includes a corresponding location to store the analytical results and sends the data to the analytical unit. If necessary, the data is sent through the FHE to preserve privacy which could otherwise leaked to the analytical entity.

An analytical unit analyze the data and provides the data to the specified location. Payment can be obtained as described in Scenario 1.

The PPP sends the data to the D-User or provides access to the data area to the D-User.

The D-User forwards analytical results to the UE.

Scenario 2c may also include joint analytics with 3^{rd} party analytical services (TPAS) including for example, the wireless network.

This example is similar to above analytics scenario, but regular interactions between the D-User AI engine and the external analytics engine are needed. Since this two-way communication happens through the PPP, constant change of messages from D-User to TPAS has to be performed by the PPP and new data (e.g., model parameters) from the TPAS should be sent to the D-User. There may be other messages for state change information etc., based on the type of joint AI analysis. However, the same procedure would follow.

### 6.36. System Architecture for Data Sharing

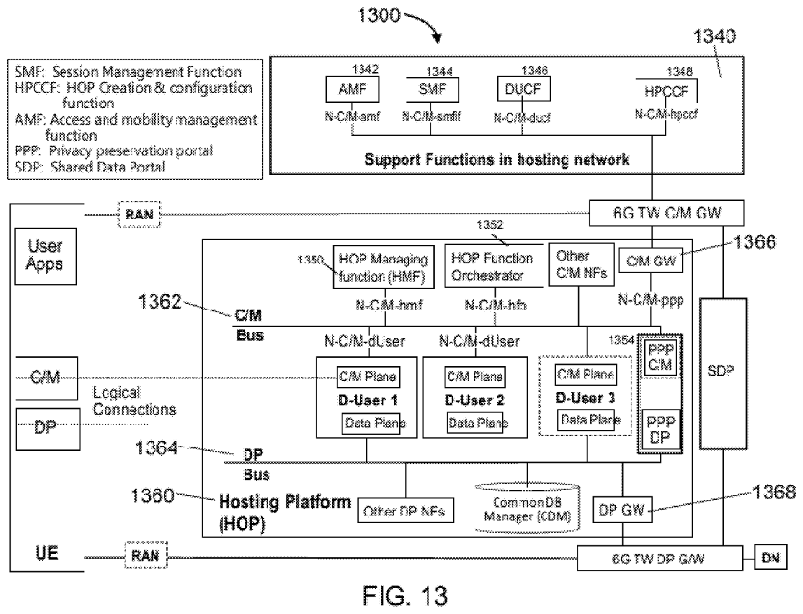

FIG. 13 shows an exemplary functional architecture 1300 of a hosting platform 1360 and the hosting network showing details of the internal bus structure, of the D-User module creation and D-User other support functions. Some of the functions are in the hosting network outside the HOP and they may belong to various other XaaS services (e.g. DUCF (1346), HPCCF (1348), AMF (1342), SMF (1344)). The internal communications inside the HOP are done by a common C/M bus 1362 and DP bus 1364 as per the SBA architecture. The internal C/M and DP buses may be connected to the external buses through the HOP C/M GW 1366 and HOP DP GW 1368 respectively. Support Functions 1340 are provided in the hosting network, including Session Management Function (SMF) 1344, HOP Creation & Configuration Function (HPCCF) 1348, access Mobility Management Function (AMF) 1342. The figure shows a generic platform where multiple D-Users are created inside.

### 6.37. Hosting Network Functions

A description of the hosting network functions is provided below.

### 6.37.2 HPCCF (HOP Creation and Configuration Function):

This function may initiate the creation of a basic HOP by requesting it from container creation function. The container may be an enclave as described before. A Basic HOP may have an internal managing function (HMF) 1350 which is capable of creating other functions and configuring them. For this purpose, HMF 1350 is configured by the HPCCF 1348.

### 6.37.2. DUCF (D-User Creation Function)

This function may perform the D-User creation when requested by a user, a network entity or another D-Rep.

Services provided by the function may include:

Creation of a D-User module inside the HOP by requesting the creation from the HMF 1350. The D-User module type may be provided by the end user.

Preparation and storage of configurations, policies and mission blueprints required for different UCM services in a Database

Establishment of a Sync channel between D-User and UE

Establishment of AAA between D-User and UE

Assessment of UE capability and Processing UE requests for new UCM services and obtain UE capabilities in providing the service (e.g. software availability, computing capability etc.)

Updating UE profile with UCMS subscriptions

Potential service consumer or end user may include:

A user, an authorized hosting network function (e.g., when handover to a visiting network), the hosting network operator or an authorized 3rd party service provider.

### 6.37.3. HOP Functions

The main functionalities required inside HOP may creating, managing (e.g. LCM), allocating resources and coordinating the D-User modules. The HOP management function may also create functions inside the D-User module after creation of a D-User module. Each D-User module may have its own D-User management functions (D-User-M) which can create, manage and coordinate internal functions and operations. Whether these functionalities are performed by the HMF 1350 or the D-User-M depends on how independently a user wants its D-User module to be operated. For different operations, different isolations may be required. For example, once a D-User is provided to a user, the user may want to instantiate its own functions for data management and run its own applications without requiring HOP or the hosting network to authorize them.

Note that when a single D-User is supported by the platform these functions may be considered as part of D-User module because there is no need to separate the D-User operation functions from the D-User management functions.

The control and management (C/M) functions inside the HOP may take full responsibility of:
continuing the actions to complete the creation of the HOP (creation and configuration of the supporting functions needed) after initial creation and configuration as a basic HOP (including an HMF function), and
continue to be involved in the operations of the HOP
creation of the D-User modules and its functions and other LCM functions such as modification, termination.

Establish communications with the hosting network and carry out access control and apply privacy preservation.

Some of these management and coordination functionalities may be separate functions inside the HOP and whether these are handled by the HMF or a separate function is implementation dependent. For example, decision making may be done based on the HOP AI function which may evaluate the actions and provide the recommendations or the evaluation results (e.g. prediction of the performance of an operation carried out by a D-User module). The HMF may need to be configured by HPCCF after it is created in order for the HMF to take these actions. Some examples of the functionalities the HMF may execute are provided below.

The creation of the D-User modules and carrying out LCM for them may be a role function of the HMF. The HMF may receive a request for the creation of the D-User module from the HPCCF 1348 or ISMF. It might use internal function orchestrator (HFO) 1352 to do the creation of the D-User module. If the HOP uses the hosting network infrastructure, the creation of D-User modules may be done by the hosting network's orchestrator based on a request from the HMF. The requests in both cases may include the appropriate blueprints or essential components of the blueprint. The request may be received from the DUCF function in the network or the ISMF function.

For the operation of the D-User modules, several supporting functions may be needed, which may be instantiated when the HMF is created, or the HMF may instantiate them. When the hosting network infrastructure is used, the instantiation of other supporting functions and LCM may be done by the hosting network orchestrator 1352.

For this purpose, the HMF 1350 is provided with full capability to create functions inside HOP and do LCM, configure them, create GWs outside of HOP, access control and privacy preservation functions for the D-User modules and other supporting actions for the applications run in the HOP and D-User modules.

Once created, the supporting functions may be configured to do the necessary actions according to the blueprint. For example, one of the supporting functions inside the HOP may be the HOP Function Orchestrator (HFO), which may be capable of function creation inside the isolated container and do LCM. Such a supporting function may be a privacy preserving portal (PPP) 1354, which may be configured based on the D-User modules and their services the HOP needs to support.

### 6.38. Privacy Preserving Portals (PPP) and Access Control

Since D-User is deployed inside the hosting network, the privacy of the UE could be leaked to the hosting network and also hosting network information may be leaked to the UE. Therefore, it is proposed that several PPP functions be used, each having different objectives as indicated below.

6.38.1. Preserving UE Privacy without Exposing to the Host or to DN

One of the PPP functions may be to preserve the UE data from being exposed to a non-trusted host, where this function is to be provided inside the D-User module. This can also be fully or partly achieved by having a data filter used in the UE, e.g. using FHE techniques. However, this may limit the use of data for the data consumers. Therefore, by having the PPP 1354 inside the D-user module or by having the PPP in a secured location for this purpose, all the user queries, interests and other data may be shared only through this PPP. This PPP 1354 may have the following modules:

### 6.38.1.1. Data Portal

The Data Portal may provide data processing which may include: Data Collecting, Data Distribution, Policy Application.

### 6.38.1.2. Crypto Suite

The Crypto Suite may provide fundamental privacy and security functionalities, which may include:

FHE (Full Homomorphic Encryption) module which helps to achieve the privacy preserving query and other operations.

IDM (Identity Management) which generate and manage the Pseudo-ID which represents the V-UE information. To ensure anonymity to the hosting network, there should be at least K number of D-Users inside HOP as described in the K-anonymous requirement. For example, the K-anonymity model requirements can be used to anonymize user communications to/from DNs (i.e. hosting network cannot know which user inside the HOP communicated with the DN). The K-Anonymity requirement can be summarized as “for every combination of identifying attributes in a dataset, there are at least “K minus 1” other people with the same attributes”. Therefore, the source ID may be changed with a randomized ID and also the return address to the user may be randomized with a randomized location. These locations may change every time a location is used.

### 6.38.1.3. Policy Engine

The Policy Engine may provide the updated access policy from the User and interacts with the Crypto Suite module and Data Portal to reflect the dynamics of the User.

### 6.39. D-User Functions

D-User Manager (D-User-M or D-XX-M): D-User manager may be instantiated with the creation of the D-User module. When the HOP uses an enclave and contains multiple D-XX modules, then in order to do the remote attestation for the D-User owner (D-User service provider which is the user in the case of D-User) the D-User module and the initial functions are instantiated according to the specification of the vendor. If a separate enclave is used for the D-User module, a separate D-User-M may not be necessary and the HOP-M may carry out the functions of the D-User-M including preparation for the remote attestation.

Once the security keys and the user information are received to the D-User-M, methods may be provided for contacting a network function (e.g. DUCF) using HOP-M in the case of multi-D-User enclave or directly in the case of single D-User enclave. Then it may contact the use using DUCF and set up a secure channel (Sync channel) by creating shared keys.

The D-User-M may determine the remote attestation code and may provide the code to the user for attestation. Once attested the D-Use create the other functions needed for the UCM services the user requires according to the D-User blue print. The blueprint may be provided when the D-User is created or it would be obtained from the hosting network or from the user. User may provide software for any service user needs as well.

### 6.40. UE Functions

A function to request the D-User service after receiving the D-User service types may be available. This may be provided to the UE as a user application, according to the following steps:

Install the software for the UCM services when received from the hosting network.

Establish sync channel between the D-User module and the user after authentication the D-user.

Obtain the remote attestation code from the D-User module and attest the D-user module by communicating with the vendor of the D-User enclave, when the D-User is created inside an enclave.

### 6.41. Procedure for UCMS Service Establishment

Pre-condition: a basic D-User module may already be instantiated and a sync channel is already established.

### 6.41.1.1. Case 1: When the D-User is Created Using a TEE.

There may be at least two options to establish a UCMS service. Network aware creation or network unaware (agnostic) creation.

Case 1a: Network aware creation

In possible embodiments, a request for the additional UCM service may need to be permitted by the MNO. A network function (DUCF) may be requested to create the UCMS service (by the UE or by the D-User module) and the DUCF interacts with the D-User-M for establishing the UCMS service.

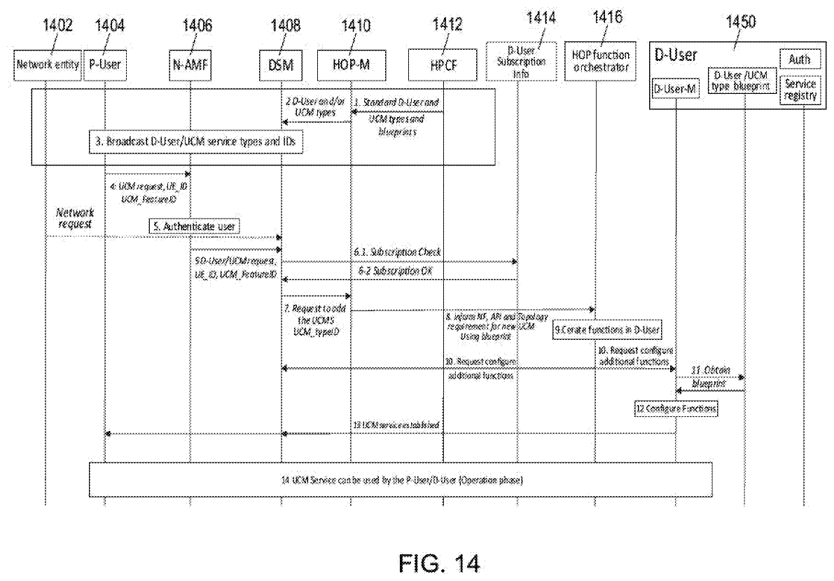

FIG. 14 provides an exemplary detailed flow chart for network aware UCM service establishment. A brief description of the procedure is provided below.

In steps 1 to 3, the Network Entity 1402 may provide the UCM service types/D-User types.

In step 4, the UCM service establishment may request from UE with UE_ID and UCM_ID an indication that it is to be forwarded to DSM 1408.

In step 5, the Network function (N-AMF) 1406 may authenticate the user request (i.e. using UE-ID) and forward request to DSM 1408.

In step 6, the DSF 1414 may check the subscription the subscription availability and if not request to follow the subscription procedure.

In step 7, the DSM 1408 may request HOP-M 1410 to add the UCM service to D-User.

In step 8, the HOP-M 1410 may check the UCM blueprint for the new UCM service and may request the function orchestrator to create new functions.

In step 9, a new internal functions may be created by HOP-M 1410.

In step 10, the HOP-M 1410 may request to configure the new and existing functions required for the UCM service.

In step 11, D-User may use the blueprint of the UCM service to obtain the configuration details.

In step 12, Configuration of the functions may be performed, including configuring the D-User functions by the D-User-M, and configuring the HOP functions by the HOP-M and by functions outside by the MNO OAM.

6.41.1.2. In Step Case 1b: UCMS Service Creation without Awareness of the Network

In possible embodiments, when a UCMS service needs to be added, it may be performed in a manner that is transparent or invisible to the hosting MNO (Mobile Network Operator) 1502, provided that option is allowed. This option could be an additional facility provided for the D-User module 1550. In such cases, the UE (User Equipment) may request the service from the VU-M (Virtualization Unit Manager) with a message indicating the UCMS type, and UCMS would then instantiate and configure the necessary NFs (Network Functions) and interfaces. The D-User may inform the MNO of the necessary protocols for interaction between the MNO's NFs and the D-User NFs, as well as traffic control procedures. Depending on the type of UCMS services permitted in the D-User module, the network may provide sufficient instructions to the D-User module upon its creation.

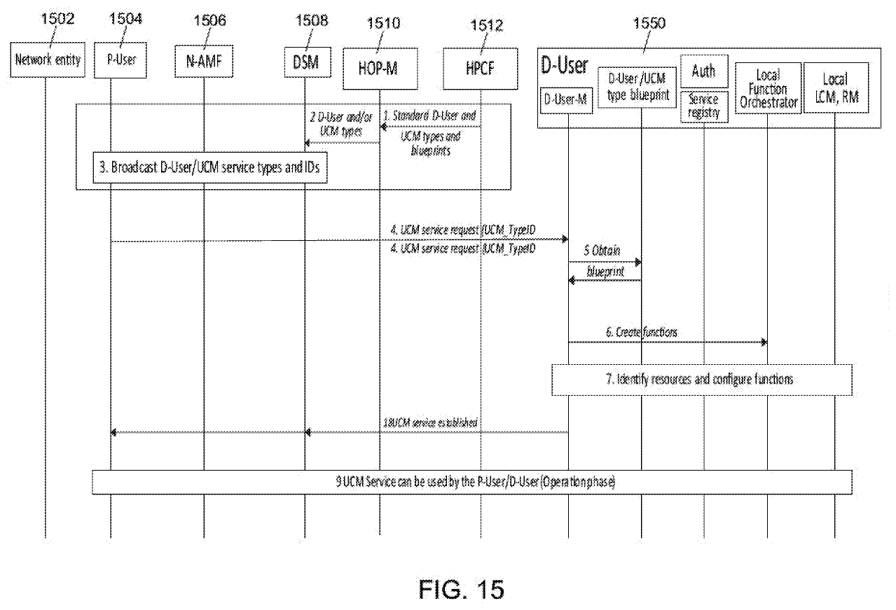

FIG. 15 provides an exemplary detailed flow chart for the network UCM service establishment without awareness of the network, and shows messages exchanges between the Network Entity 1502, the P-User 1504, the N-AMF 1506, the DSM 1508, the HOP-M 1510, the HPCF 1512 and the D-User 1550.

In this case, the P-User 1504 may directly contact D-User 1550 and request the creation of the UCM service and D-User 1550 can create the additional functions and configure network functions. For this purpose, MNO may provide additional authority to D-User for this purpose. For certain services, the MN may carry out added actions (e.g. special exposure) which may make it aware of the establishment of a new UCM service. In step 1, the HPCF 1512 may provide the Standard D-User and the UCM types and UCM blueprints to the HOP-M 1510. In step 2, the HOP-M 1510 can provide the D-User module and/or UCM types to the DSM 1508. In step 3, the D-User module and UCM service types and IDs may be broadcasted up to the P-User or real user 1504. In step 4, the P-User 1504 may request a specific UCM service, using the UCM typeID. In step 5, the UCM blueprint is requested by the D-User-M to the U-User/UCM type blueprint. In step 6, the UCM service is created, and in step 7, the resources needed are identified and the functions associated with the UCM service are configured. In step 8, the UCM service is established, such that the UCM service can be used by the P-User and by the D-User module.

### 6.41.2. Case 2: When the D-User is Created by the MNO OAM

In this embodiment, all the required NFs and interfaces may be established by the MNO, if the UCMS service creation is done with awareness of the MNO. If the UCMS services are allowed to be provided by the D-User-M, the D-User-M is provided with the authority to create the required functions and interfaces. For this purpose, the required AAA process may be established with the D-User prior to establishment of the UCMS service as request for the UCMS service is directly received to D-User-M or D-User-M decide to create the UCMS service by itself.

### 6.41.2.1. Obtaining Payments for Data Sharing Anonymously

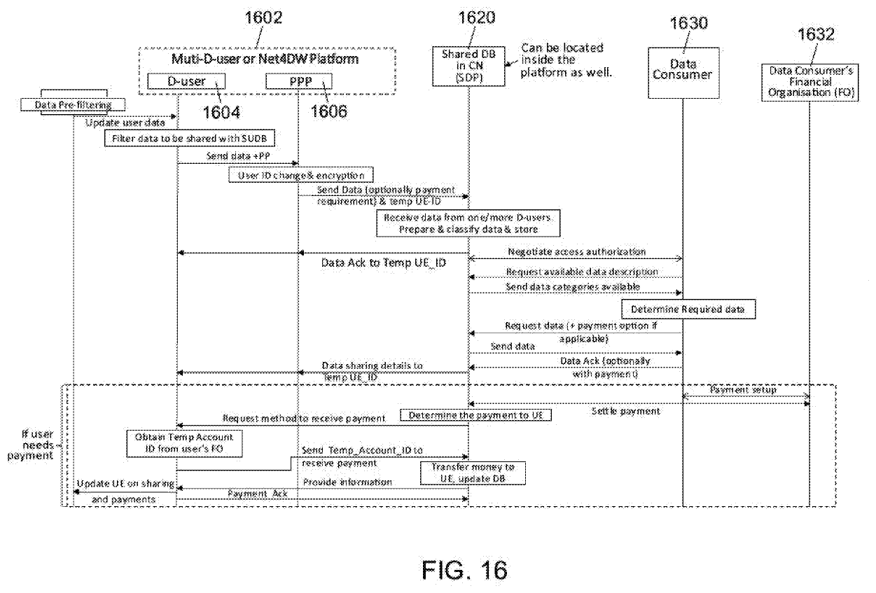

FIG. 16 illustrates an exemplary procedure to obtain a payment for shared data from a Data Consumer, while preserving privacy of the real user providing the data to the Data Consumer. FIG. 16 shows how messages may be exchanges between a Multi D-User platform 1602, a Shared DB 1620, a Data Consumer 1630 and a Financial Organization 1632 of the Data Consumer.

The data at the UE may be filtered (1640) and the user data may be updated to the D-User module 1604. Additional filtering may be performed (1642) before sharing the data in the Shared User Data Base (SUDB). The data can be sent to the Privacy Preserving Portal PPP (1606), which changes the User ID and encrypts the data (1644). The data, and optionally, payment option to access the data, and the temporary UE-ID is sent in the Shared DB 1620. The SDP 1620 can be located inside the HOP or outside. The SDP 1620 receives the data from one or more D-User modules, prepares and classifies the data and stores it (1646). If Data Consumer wants to access the data, access authorization is negotiated. The Data Consumer 1630 may request a description of the available data and the SDP 1620 may send the categories of data available. The Data Consumer 1630 may determine the required data (1648), and request data, and provide payment options if applicable. If data is sent to the Data Consumer 1630, details on the data shared may be provided to the D-User module. If a payment is required to access the data, the payment is first established with the UE (1650), and a temporary account ID is obtained by the D-User module from the user's financial institution (16562). The temporary account ID is sent from the D-User module to the SDP 1620, such that the Data Consumer may transfer money to the user (1654).

As described previously, a data consumer obtains data provided by a specific user, and a payment is to be made to the user. However, the data consumer is not aware of the user's identity. Therefore, the data consumer would first make the payment to the SDP (Service Delivery Platform) or the hosting network's financial organization. This process is not detailed further as there is no privacy preservation requirement for it. The SDP or hosting network would determine the amount to be paid to the user according to the data sharing agreements in place, and then request the D-User through the PPP (Payment Processing Platform) a method for facilitating the payment.

The request may be sent using the Temp ID used in the data sharing step, and the PPP may translate the address to the D-User's address. The D-User may then obtain a temporary account ID from the user's financial organization to deliver the payment. Prior to this, the user may have provided D-User authorization to access the user's financial organization for this purpose. This account ID may be passed to the SDP through the PPP using the same previous Temp ID, and the SDP/hosting network make the payment and confirm payment to the D-User in a similar way via the PPP. The D-User can now check that the payment is received and send an acknowledgment to the SDP via PPP.

### 6.42. Starting a UCMS Session

There may be different types of communications involving a D-User module. Depending on which entity initiate the communications and the purpose of the communications, the message flow and what the D-user module has to do may be different. After the creation of a D-User module but before the establishment of a UCMS service, the following message types may exist:

Messages initiated by UE CPF to D-User CPF

AAA and Synchronization of user context initiated by UE: Once a D-User is created, the MNO may set up a sync channel between the D-User and the UE and the security keys may be passed so that the UE and D-User can establish communication using their own security protocols (e.g. new key and new ID). Then the UE may inform the D-User the type of user context to be transferred to the D-User, the frequency of data transfer etc. and send data to the D-User. The D-User may request separate data channels with specific QoS for that. If the amount of data to be transfer is small, it may be done using the control plane channel.

### UE DPF to D-User UPF

Initiate data sync by the UE: In some cases, data transfer may be needed (updates on the environment etc.). Some of these channels may be temporary and invoked only when there is a need. Some may be permanent or kept as long as the UCMS service remains active.

Messages initiated by the D-User CPF to UE CPF may include:

Initiate initial synchronization by the D-User, AAA

Initiate the data sync by the D-User

Initiate a UCMS service by D-User

Initiate a UCMS service session (the messaging depends on the type of UCMS service.

Synchronization of user context initiated by UE

There may be several types of communications between a UE CPF and the D-User CPFs. Those may include:

Messages initiated by UE messages to initiate a UCMS service session initiated by UE

messages to initiate a UCMS service session initiated by D-User

AAA and Synchronization of user context initiated by UE

UE CPF→D-User CPF and D-User CPF→UE CPF: These may be control messages from UE to D-User or D-User to UE which may include messages to initiate a UCMS service, AAA, synchronization of user context etc. For data synchronization or information sharing the CPF to CPF may also be used, but it may happen in the data plane by UE UPF directly connecting to a D-User UPF under the control of CPF functions.

UE UPF→CN UPF: UE may send a data packet of a PDU session belonging to a UCMS service. Depending on the UCMS service, the packet may have to be processed differently by the network UPF.

UE UPF→CN UPF→DN: Packet may have a D-User specified QoE field the network should try to meet.

UE UPF→CN UPF→D-User UPF: Packet may contain a specific field which indicate that it should be directed to a D-User UPF.

D-User UPF→CN UPF:

One type of data packets may be sent to a DN in the address field.

The packets received in the uplink from a UE (VIA a CN UPF) after sending to the D-User UPF for processing may be sent to the CN UPF to be sent to a DN.

The D-User has processed some data internally (stored data) may be sent to the DN via a CN UPF.

Another type of packets to be sent to the UE.

The packets received in the downlink from a DN after sending to the D-User UPF for processing may be sent to the CN UPF to be sent to the UE.

The D-User has processed some data internally (stored data) may be sent to the UE via a CN UPF.

CN UPF→D-User UPF:

CN UPF may receive a packet from the D-User to be sent to a DN.

D-User→CPF at AF:

The D-User may start a data session with the AF.

D-User CPF→CN UPF

This type of messages may be required when the D-User requires to configure a hosting network function, for example, for controlling traffic or monitoring traffic.

D-User UPF→AS (DN)

This may be needed for the D-User to send/obtain data from the application servers.

### 6.41. Other Considerations

A memory may include any suitable type of non-transitory memory such as static random access memory (SRAM), dynamic random access memory (DRAM), synchronous DRAM (SDRAM), read-only memory (ROM), any combination of such, or the like. The mass storage element 602 may include any suitable type of non-transitory storage device, such as a solid state drive, a hard disk drive, a magnetic disk drive, an optical disk drive, a USB drive, or any computer program product configured to store data and machine executable program code. According to certain embodiments, the memory or the mass storage may have recorded thereon statements and instructions executable by the processor for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Actions associated with the method described herein can be implemented as coded instructions in a computer program product. In other words, the computer program product is a computer-readable medium (a tangible, non-transitory computer readable medium or memory) upon which software code (instructions) is recorded to execute the method when the computer program product is loaded into memory and executed on the microprocessor of a wireless communication device, or a network device, or a user equipment device.

Further, each operation of the method may be executed on any suitable computing device, such as a personal computer, server, personal digital assistant, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. For example, although some embodiments of the disclosure provide for the VUE, instantiated inside the core network, the VUE may be instantiated inside RAN with similar functions in which case control plane and user plane functions used for the core network may be instantiated inside RAN with similar functionalities. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method for sharing data associated with a user via a digital representative of the user hosted in a network, the method comprising:
establishing a communication path between a User Equipment (UE) of the user and the digital representative;
storing user data from the UE in a data storage of the digital representative, the user data comprising a plurality of data subsets, at least one data subset of the plurality of data subsets being associated with a Privacy Preservation Level (PPL);
processing the plurality of data subsets according to the PPL into privacy-preserved data; and
providing an access location storing the privacy-preserved data to internal nodes of the network or external nodes of the network, to allow the internal nodes or the external nodes to access the privacy-preserved data.

2. The method according to claim 1, wherein the digital representative is instantiated in a hosting platform (HOP) of the network, and wherein the network is a Hosting Network (HN).

3. The method according to claim 2, wherein the HN is an untrusted network, and wherein access to the data storage or network functions inside the digital representative by the untrusted network is controlled by either an access control function in the HOP or an access control function inside the digital representative.

4. The method according to claim 1, wherein providing the access location to the internal nodes or the external nodes is controlled by a Network Function of the network.

5. The method according to claim 1, wherein establishing the communication path between the UE of the user and the digital representative comprises:
providing secure keys to authenticate the UE and the digital representative with one another;
enabling secure communications between the UE and the digital representative; and
preventing visibility of the secure communications between the UE and the digital representative by the network.

6. The method according to claim 1, wherein the user continuously updates the user data, via the UE, with the digital representative, the digital representative comprising a Data Synchronization Function to keep track of a validity of the user data and of an age of the user data and to update metadata associated with the user data in the data storage of the digital representative.

7. The method according to claim 6, wherein the Data Synchronization Function informs the UE when user data is shared or discarded from the digital representative.

8. The method according to claim 1, comprising pre-filtering the user data using a UE Function of the UE, prior to sending new user data in the data storage of the digital representative.

9. The method according to claim 2, wherein the digital representative is instantiated in an isolated container.

10. The method according to claim 9, wherein the isolated container is a Trusted Execution Environment (TEE) and communications between the digital representative and the UE are not visible to the HN.

11. The method according to claim 2, wherein the HN comprises a Privacy Preserving Portal (PPP) and wherein communications between the digital representative and the external nodes are performed via the PPP.

12. The method according to claim 3, wherein the HOP comprises a Privacy Preserving Portal (PPP) and wherein communications between the digital representative and the external nodes are performed via the PPP.

13. The method according to claim 12, wherein the PPP is configured to perform at least one of de-privatize or anonymize communications between the digital representative and the external nodes.

14. The method according to claim 13, wherein anonymization of user data is performed by at least one of changing, by the PPP, a User Identifier (User ID), User Equipment Identifier (UE-ID), or D-User identifier (D-User_ID) to a temporary identifier (Temp_ID) or by changing a location of a source address of the communications with the external nodes to a temporary location.

15. The method according to claim 13, wherein the PPP applies an encryption process to the plurality of data subsets associated with a PPL requiring data-encryption, to further decorrelate the user data from the user.

16. The method according to claim 12, wherein the PPL is associated with a Privacy Preservation technique to be applied by a Data Processing Function (DPF) of the digital representative, for the processing of the plurality of data subsets.

17. The method according to claim 2, wherein the privacy-preserved data is stored in a Shared Data Portal (SDP) of the HN, the SDP storing the privacy-preserved data of the user and of additional users.

18. The method according to claim 17, wherein communications between the digital representative and the SDP are performed using a temporary identifier of the digital representative, the SDP being unaware of a User Identifier (User ID) or of a User Equipment Identifier (UE_ID) associated with the digital representative when the digital representative communicates with the SDP.

19. A non-transitory computer readable storage medium having instructions stored thereon which, when executed by an apparatus, cause the apparatus to perform operations comprising:
establishing a communication path between a User Equipment (UE) of a user and a digital representative of the user hosted in a network;
storing user data from the UE in a data storage of the digital representative, the user data comprising a plurality of data subsets, at least one data subset of the plurality of data subsets being associated with a Privacy Preservation Level (PPL);
processing the plurality of data subsets according to the PPL into privacy-preserved data; and
providing an access location storing the privacy-preserved data to internal nodes of the network or external nodes of the network, to allow the internal nodes or the external nodes to access the privacy-preserved data.

20. A network node, the network node being part of a Hosting Network (HN), the network node comprising:
one or more processors and one or more memories, wherein the one or more memories store programming instructions that, when executed by the one or more processors, cause the network node to perform operations comprising:
establishing a communication path between a User Equipment (UE) of a user and a digital representative of the user hosted in a network;
storing user data from the UE in a data storage of the digital representative, the user data comprising a plurality of data subsets, at least one data subset of the plurality of data subsets being associated with a Privacy Preservation Level (PPL);
processing the plurality of data subsets according to the PPL into privacy-preserved data; and
providing an access location storing the privacy-preserved data to internal nodes of the network or external nodes of the network, to allow the internal nodes or the external nodes to access the privacy-preserved data.
